(19) United States
(12) Patent Application Publication
(10) Pub. No.: US 2025/0254462 A1
(43) Pub. Date: Aug. 7, 2025

(54) SOUND APPARATUS AND VEHICULAR APPARATUS INCLUDING THE SAME

(71) Applicant: LG Display Co., Ltd., Seoul (KR)

(72) Inventors: SangWoo JIN, Paju-si (KR); NohJin MYUNG, Paju-si (KR); Eun ROH, Paju-si (KR)

(21) Appl. No.: 19/014,067

(22) Filed: Jan. 8, 2025

(30) Foreign Application Priority Data
Feb. 7, 2024 (KR) 10-2024-0019191

(51) Int. Cl. H04R 1/28; H04R 1/02

(52) U.S. Cl. CPC H04R 1/2811; H04R 1/025; H04R 1/026; H04R 2499/13

(57) ABSTRACT

The present disclosure provides a sound apparatus and a vehicular apparatus including the same. The sound apparatus includes a first sound generating structure, a second sound generating structure spaced apart from the first sound generating structure, a coupling member partially provided between the first sound generating structure and the second sound generating structure, and a connection member disposed along a rear periphery portion of the first sound generating structure.

### CROSS-REFERENCE TO RELATED APPLICATION

This application claims the benefit of and priority to Korean Patent Application No. 10-2024-0019191 filed on Feb. 7, 2024, the entirety of which is hereby incorporated by reference in its entirety for all purposes as if fully set forth herein.

### BACKGROUND

### Technical Field

The present disclosure relates to a sound apparatus and a vehicular apparatus including the same, and more particularly, for example, without limitation, to a sound apparatus and a vehicular apparatus including the same, which may enhance a sound characteristic and/or a sound pressure level characteristic.

### Description of the Related Art

Vehicles include a sound apparatus which outputs a sound based on an audio signal output from a multimedia device such as a car audio device. For example, the sound apparatus applied to vehicles may include a front speaker and a rear speaker, which are configured as a coil type.

However, a sound apparatus in the vehicles may be limited when outputting a realistic sound or stereo sound of a multichannel through the front speaker and the rear speaker due to limitations of the coil type device. Further, in the sound apparatus in vehicles, in a case where the number of speakers are increased, a stereo sound may be output, but due to a limitation of a size of the speakers based on the coil type device and a space in vehicles, there is a limitation in increasing the number of speakers so that a realistic sound or stereo sound cannot be provided using the coil type device.

The description provided in the discussion of the related art section should not be assumed to be prior art merely because it is mentioned in or associated with that section. The discussion of the related art section may include information that describes one or more aspects of the subject technology, and the description in this section does not limit the disclosure.

### BRIEF SUMMARY

The inventors of the present disclosure have recognized the problems and disadvantages of the related art and have performed extensive research and experiments for enhancing a sound characteristic and/or a sound pressure level characteristic of a sound apparatus for vehicles. Based on the extensive research and experiments, the inventors have invented a sound apparatus and a vehicular apparatus including the same, which may enhance a sound characteristic and/or a sound pressure level characteristic.

An aspect of the present disclosure is directed to providing a sound apparatus and a vehicular apparatus including the same, which may enhance a sound characteristic and/or a sound pressure level characteristic.

An aspect of the present disclosure is directed to providing a sound apparatus and a vehicular apparatus including the same, which may enhance a sound characteristic and/or a sound pressure level characteristic in a pitched sound band including a sound of a low-pitched sound band and a middle-high-pitched sound band.

An aspect of the present disclosure is directed to providing a sound apparatus and a vehicular apparatus including the same, which may extend a sound reproduction band.

Purposes according to the present disclosure are not limited to the above-mentioned purposes. Additional features, advantages, and aspects will be set forth in the description that follows, and in part will be apparent from the description, or may be learned by practice of the inventive concepts provided herein. Other features, advantages, and aspects of the present disclosure may be realized and attained by the structure particularly pointed out in the written description, or derivable therefrom, and the claims hereof as well as the appended drawings.

To achieve these and other advantages and aspects of the present disclosure, as embodied and broadly described herein, in one or more aspects, a sound apparatus includes a first sound generating part, a second sound generating part spaced apart from the first sound generating part, a coupling member partially provided between the first sound generating part and the second sound generating part, and a connection member disposed along a rear periphery portion of the first sound generating part.

In one or more aspects, a vehicular apparatus includes an interior material exposed at an interior space, and at least one or more sound generating apparatuses connected to the interior material and configured to output a sound to the interior space. The at least one or more sound generating apparatuses include a first sound generating part, a second sound generating part spaced apart from the first sound generating part, a coupling member partially provided between the first sound generating part and the second sound generating part, and a connection member disposed along a rear periphery portion of the first sound generating part. The interior material is connected to the connection member of the sound apparatus.

Details of other exemplary embodiments will be included in the detailed description of the disclosure and the accompanying drawings.

According to a sound apparatus and a vehicular apparatus including the same according to one or more embodiments of the present disclosure, a sound characteristic and/or a sound pressure level characteristic may be enhanced.

According to a sound apparatus and a vehicular apparatus including the same according to one or more embodiments of the present disclosure, a sound characteristic and/or a sound pressure level characteristic may be enhanced in a pitched sound band including a sound of a low-pitched sound band and a middle-high-pitched sound band.

According to a sound apparatus and a vehicular apparatus including the same according to one or more embodiments of the present disclosure, a sound reproduction band may extend.

According to a sound apparatus and a vehicular apparatus including the same according to one or more embodiments of the present disclosure, a signal supply member and a vibration generating part may be configured as one part (or one component), thereby realizing an effect of uni-materialization.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure, are incorporated in and constitute a part of this disclosure, illustrate aspects and embodiments of the disclosure and together with the description serve to explain principles of the disclosure. In the drawings:

FIG. 1 is a diagram illustrating a sound apparatus according to an exemplary embodiment of the present disclosure.

FIG. 2 is a diagram illustrating a sound apparatus for vehicles according to another exemplary embodiment of the present disclosure.

FIG. 3 is a perspective view illustrating a sound apparatus according to an exemplary embodiment of the present disclosure.

FIG. 4 is an exploded perspective view of a sound apparatus according to an exemplary embodiment of the present disclosure.

FIG. 5 is a cross-sectional view taken along line I-I′ illustrated in FIG. 4 according to an exemplary embodiment of the present disclosure.

FIG. 6 is a cross-sectional view taken along line II-II′ illustrated in FIG. 4 according to an exemplary embodiment of the present disclosure.

FIG. 7 is a perspective view illustrating a sound apparatus according to another exemplary embodiment of the present disclosure.

FIG. 8 is a cross-sectional view taken along line III-III′ illustrated in FIG. 7 according to an exemplary embodiment of the present disclosure.

FIG. 9 is a perspective view illustrating a sound apparatus according to another exemplary embodiment of the present disclosure.

FIG. 10 is an exploded perspective view of a sound apparatus according to another exemplary embodiment of the present disclosure.

FIG. 11 is a cross-sectional view taken along line IV-IV′ illustrated in FIG. 9 according to an exemplary embodiment of the present disclosure.

FIG. 12 is a cross-sectional view taken along line V-V′ illustrated in FIG. 9 according to an exemplary embodiment of the present disclosure.

FIG. 13 is a perspective view illustrating a sound apparatus according to another exemplary embodiment of the present disclosure.

FIG. 14 is an exploded perspective view of a sound apparatus according to another exemplary embodiment of the present disclosure.

FIG. 15 is a perspective view illustrating a sound apparatus according to another exemplary embodiment of the present disclosure.

FIG. 16 is an exploded perspective view of a sound apparatus according to another exemplary embodiment of the present disclosure.

FIG. 17 is a cross-sectional view taken along line VI-VI′ illustrated in FIG. 15 according to an exemplary embodiment of the present disclosure.

FIG. 18 is a cross-sectional view taken along line VII-VII′ illustrated in FIG. 15 according to an exemplary embodiment of the present disclosure.

FIG. 19 is a diagram illustrating a sound apparatus according to another exemplary embodiment of the present disclosure.

FIG. 20 is a cross-sectional view taken along line VIII-VIII′ illustrated in FIG. 19 according to an exemplary embodiment of the present disclosure.

FIG. 21 is another cross-sectional view taken along line VIII-VIII′ illustrated in FIG. 19 according to an exemplary embodiment of the present disclosure.

FIG. 22 is another cross-sectional view taken along line VIII-VIII′ illustrated in FIG. 19 according to an exemplary embodiment of the present disclosure.

FIG. 23 is a cross-sectional view illustrating a sound apparatus according to another exemplary embodiment of the present disclosure.

FIG. 24 is a perspective view illustrating an enclosure illustrated in FIG. 23 according to an exemplary embodiment of the present disclosure.

FIG. 25 is a diagram illustrating a vibration generator of a vibration apparatus according to an exemplary embodiment of the present disclosure.

FIG. 26 is a cross-sectional view taken along line IX-IX′ illustrated in FIG. 25 according to an exemplary embodiment of the present disclosure.

FIG. 27 is a cross-sectional view taken along line X-X′ illustrated in FIG. 25 according to an exemplary embodiment of the present disclosure.

FIG. 28 is a diagram illustrating a vibration part according to another exemplary embodiment of the present disclosure.

FIG. 29 is a diagram illustrating a vibration part according to another exemplary embodiment of the present disclosure.

FIG. 30 is a diagram illustrating a vibration generator of a vibration apparatus according to another exemplary embodiment of the present disclosure.

FIG. 31 is a diagram illustrating a vehicular apparatus according to an exemplary embodiment of the present disclosure.

FIG. 32 is a diagram illustrating a vehicular apparatus according to an exemplary embodiment of the present disclosure.

FIG. 33 is a diagram illustrating a sound generating apparatus disposed at a roof of a vehicular apparatus illustrated in FIGS. 31 and 32.

FIG. 34 is a diagram illustrating a sound generating apparatus disposed at a roof and a seat of a vehicular apparatus illustrated in FIGS. 31 and 32.

FIG. 35 is a diagram illustrating a sound output characteristic of a sound apparatus according to an exemplary embodiment of the present disclosure.

FIG. 36 is a diagram illustrating a sound output characteristic of a sound apparatus according to exemplary embodiments of the present disclosure.

FIG. 37 is a diagram illustrating a sound output characteristic of a sound apparatus according to exemplary embodiments of the present disclosure and an experimental example.

Throughout the drawings and the detailed description, unless otherwise described, the same drawing reference numerals should be understood to refer to the same elements, features, and structures.

### DETAILED DESCRIPTION

Reference will now be made in detail to embodiments of the present disclosure, examples of which may be illustrated in the accompanying drawings. The progression of processing steps and/or operations described is an example; however, the sequence of steps and/or operations is not limited to that set forth herein and may be changed as is known in the art, with the exception of steps and/or operations necessarily occurring in a particular order. Names of the respective elements used in the following explanations may be selected only for convenience of writing the specification and may be thus different from those used in actual products.

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure may be thorough and complete to assist those skilled in the art to understand the inventive concepts without limiting the protected scope of the present disclosure.

The shapes (e.g., sizes, lengths, widths, heights, thicknesses, locations, radii, diameters, and areas) a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted or briefly given.

In a situation where “comprise,” “have,” “include” “contain,” “constitute,” “make up of,” “formed of,” described in the present specification are used, another part can be added unless “only” is used. The terms of a singular form can include plural forms unless referred to the contrary.

The word “exemplary” is used to mean serving as an example or illustration. Aspects are example aspects. “Embodiments,” “examples,” “aspects,” and the like should not be construed as preferred or advantageous over other implementations. An embodiment, an example, an exemplary embodiment, an aspect, or the like may refer to one or more embodiments, one or more examples, one or more example embodiments, one or more aspects, or the like, unless stated otherwise. Further, the term “may” encompasses all the meanings of the term “can.”

In construing an element, the element is construed as including an error range although there is no explicit description.

In describing a position relationship, for example, when a position relation between two parts is described as “on,” “over,” “under,” and “next,” one or more other parts can be disposed between the two parts unless ‘just’ or ‘direct’ is used. For example, where an element or layer is disposed “on” another element or layer, a third layer or element may be interposed therebetween.

The terms, such as “below,” “lower,” “above,” “upper” and the like, may be used herein to describe a relationship between element(s) or item(s) as illustrated in the drawings. It will be understood that the terms are spatially relative and based on the orientation depicted in the drawings.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc., can be used herein to describe various elements, these elements should not be limited by these terms. These terms are only used to distinguish one element from another. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element is “connected,” “coupled,” or “contact,” to another element, the element may not only be directly connected, coupled, or contacted to another element, but also be indirectly connected, coupled, or contacted to another element with one or more intervening elements interposed between the elements, unless otherwise specified.

For the expression that an element is “contacts” or “overlaps” with another element, the element can not only directly contact, overlap, or the like with another element, but also indirectly contact or overlap with another element with one or more intervening elements disposed or interposed between the elements, unless otherwise specified.

The term “at least one” should be understood as including any and all combinations of one or more of the associated listed items. For example, the meaning of “at least one of a first item, a second item and a third item” denotes the combination of all items proposed from two or more of the first item, the second item and the third item as well as the first item, the second item or the third item.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, example embodiments of a sound apparatus according to the present disclosure will be described in detail with reference to the accompanying drawings. For convenience of description, a scale of each of elements illustrated in the accompanying drawings differs from a real scale, and thus, is not limited to a scale illustrated in the drawings.

FIG. 1 is a diagram illustrating a sound apparatus according to an exemplary embodiment of the present disclosure. For example, FIG. 1 is a diagram illustrating a sound apparatus for vehicles according to an exemplary embodiment of the present disclosure.

With reference to FIG. 1, a sound apparatus 30 according to exemplary an embodiment of the present disclosure may be disposed or equipped at an inner portion of a vehicle 10 to output a sound S toward an interior space (or an indoor space) IS of the vehicle (or a vehicular apparatus) 10.

The vehicle 10 may be a vehicular apparatus which includes one or more seats and one or more windows. For example, the vehicle 10 may include a vehicle, a train, a ship, or an aircraft, or the like, but embodiments of the present disclosure are not limited thereto.

The vehicle 10 according to an exemplary embodiment of the present disclosure may include a main structure 110.

The main structure 110 of the vehicle 10 may include a main frame, a sub-frame, a side frame, a door frame, an under-frame, and a seat frame, or the like, but embodiments of the present disclosure are not limited thereto. For example, the main structure 110 may be a vehicle body, a vehicle structure, or a frame structure, or the like, but embodiments of the present disclosure are not limited thereto.

The vehicle 10 according to an exemplary embodiment of the present disclosure may further include an exterior material 120.

The exterior material 120 of the vehicle 10 may be configured to cover the main structure 110. For example, the exterior material 120 of the vehicle 10 may be configured to cover an outer portion of the main structure 110. In the following description, the exterior material 120 may be a vehicle exterior material 120, and may be used interchangeably.

The exterior material 120 of the vehicle 10 may include a hood panel, a front fender panel, a dash panel, a pillar panel, a trunk panel, a roof panel (or ceiling), a floor panel, a door inner panel, and a door outer panel, or the like, but embodiments of the present disclosure are not limited thereto.

The exterior material 120 according to an exemplary embodiment of the present disclosure may include at least one or more of a planar portion (or a flat portion) and a curved portion (or a flexural portion or an uneven portion). For example, the exterior material 120 may have a structure corresponding to a structure of a corresponding main structure 110, or may have a structure which differs from a structure of a corresponding main structure 110.

The vehicle 10 according to an exemplary embodiment of the present disclosure may further include a vehicle interior material 130. In the following description, the vehicle interior material 130 may be an interior material 130, and may be used interchangeably. As one example, the sound apparatus 30 may be disposed on the vehicle interior material 130, and located below the main structure 110. For example, the sound apparatus 30 may be configured in a region between the vehicle interior material 130 and the main structure 110, as shown in FIG. 1.

The vehicle interior material 130 may include all elements (or components) configuring an inner portion of the vehicle 10, or may include all elements disposed at the interior space IS of the vehicle 10. For example, the vehicle interior material 130 may be an interior member or an interior finish material of the vehicle 10, but embodiments of the present disclosure are not limited thereto.

The vehicle interior material 130 according to an exemplary embodiment of the present disclosure may be configured to cover one or more of main structure 110 and the exterior material 120 in the interior space IS of the vehicle 10. For example, the vehicle interior material 130 may cover one or more of main structure 110 and the exterior material 120 in the interior space IS of the vehicle 10 and may be configured to be exposed at the interior space IS of the vehicle 10.

The vehicle interior material 130 according to an exemplary embodiment of the present disclosure may be configured to be exposed at the inner portion and/or the interior space IS of the vehicle 10 in the inner portion and/or the interior space IS of the vehicle 10. For example, the vehicle interior material 130 may be configured to cover one or more surfaces (or an interior surfaces) of at least one or more of a main frame (or a vehicle body), a side frame (or a side body), a door frame (or a door body), a handle frame (or a steering hub), and a seat frame, which are exposed at the interior space IS of the vehicle 10.

The vehicle interior material 130 according to an exemplary embodiment of the present disclosure may include a dashboard, a pillar interior material (or a pillar trim), a floor interior material (or a floor carpet), a roof interior material (or a headliner), a door interior material (or a door trim), a handle interior material (or a steering cover), a seat interior material, a rear package interior material (or a back seat shelf), an overhead console (or an illumination interior material), a rear view mirror, a glove box, and a sun visor, or the like, but embodiments of the present disclosure are not limited thereto.

The vehicle interior material 130 according to an exemplary embodiment of the present disclosure may include one or more of metal, wood, rubber, plastic, glass, fiber, cloth, paper, a mirror, leather, and carbon, but embodiments of the present disclosure are not limited thereto. The vehicle interior material 130 including a plastic material may be an injection material which is implemented by an injection process using a thermoplastic resin or a thermosetting resin, but embodiments of the present disclosure are not limited thereto. The vehicle interior material 130 including a fiber material may include at least one or more of a plastic composite fiber, a carbon fiber (or an aramid fiber), and a natural fiber, but embodiments of the present disclosure are not limited thereto. The vehicle interior material 130 including the fiber material may include a textile sheet, a knit sheet, or a nonwoven fabric, or the like, but embodiments of the present disclosure are not limited thereto. For example, the paper may be cone paper for speakers. For example, the cone paper may be pulp or foamed plastic, or the like, but embodiments of the present disclosure are not limited thereto. The vehicle interior material 130 including a leather material may include natural leather or artificial leather, but embodiments of the present disclosure are not limited thereto.

The vehicle interior material 130 according to an exemplary embodiment of the present disclosure may include at least one or more of a planar portion and a curved portion (or a flexural portion or an uneven portion). For example, the vehicle interior material 130 may have a structure corresponding to a structure (or an inner surface structure) of a corresponding main structure 110, or may have a structure which differs from a structure of a corresponding main structure 110.

According to an exemplary embodiment of the present disclosure, the sound apparatus 30 may be disposed at the vehicle interior material 130. The sound apparatus 30 may vibrate (or directly vibrate) the vehicle interior material 130 to generate a sound S based on a vibration of the vehicle interior material 130. For example, the sound apparatus 30 may be configured to vibrate the vehicle interior material 130 to output the sound S toward the inner portion and/or the interior space IS of the vehicle 10 based on a vibration of the vehicle interior material 130. Thus, the sound apparatus 30 may use the vehicle interior material 130 as a sound vibration plate or a sound diaphragm. As one example, the one or more sound apparatuses 30 may be configured to vibrate the at least one or more regions (or portions) of the vehicle interior material 130 to output the sound S toward the inner portion and/or the interior space IS of the vehicle 10. The vehicle interior material 130 may be a vibration plate, a sound vibration plate, or a sound generating plate for outputting the sound S, but embodiments of the present disclosure are not limited thereto. For example, the vehicle interior material 130 may have a size which is greater than the sound apparatus 30, but embodiments of the present disclosure are not limited thereto.

According to an exemplary embodiment of the present disclosure, the sound apparatus 30 may be disposed in at least one or more of a dashboard, a pillar interior material, a floor interior material, a roof interior material, a door interior material, a handle interior material, and a seat interior material, or may be disposed in or connected to (or coupled to) at least one or more of a rear package interior material, an overhead console, a rear view mirror, a glove box, and a sun visor. For example, the sound apparatus 30 may vibrate (or directly vibrate) at least one or more of the dashboard, the pillar interior material, the floor interior material, the roof interior material, the door interior material, the handle interior material, the seat interior material, the rear package interior material, the overhead console, the rear view mirror, the glove box, and the sun visor to output the sound S toward the inner portion and/or the interior space IS of the vehicle 10.

The vehicle 10 according to an exemplary embodiment of the present disclosure may include one or more sound apparatuses 30 disposed in or connected to at least one or more regions (or portions) of the vehicle interior material 130. The one or more sound apparatuses 30 may vibrate the at least one or more regions (or portions) of the vehicle interior material 130 to output a realistic sound S and/or stereo sound including a multichannel toward the interior space IS of the vehicle 10.

According to an exemplary embodiment of the present disclosure, the sound apparatus 30 may be configured in a region between the vehicle interior material 130 and the main structure 110, or a region between the vehicle interior material 130 and the exterior material 120. The sound apparatus 30 may be disposed in a region between the vehicle interior material 130 and the main structure 110, or a region between the vehicle interior material 130 and the exterior material 120, and may indirectly or directly vibrate one or more of the region between the vehicle interior material 130 and the main structure 110 and the region between the vehicle interior material 130 and the exterior material 120 to output sound S, such as a realistic sound S and/or stereo sound including a multichannel.

According to an exemplary embodiment of the present disclosure, the sound apparatus 30 may be disposed in one or more of a region (or a first region) between the main structure 110 and the exterior material 120, a region (or a second region) between the main structure 110 and the vehicle interior material 130, the exterior material 120, and the vehicle interior material 130. For example, the sound apparatus 30 may be disposed in one or more of the region (or first region) between the main structure 110 and the exterior material 120, the region (or second region) between the main structure 110 and the vehicle interior material 130, the exterior material 120, and the vehicle interior material 130, and may be configured to output a sound. For example, the sound apparatus 30 may be disposed in one or more of the region (or first region) between the main structure 110 and the exterior material 120, the region (or second region) between the main structure 110 and the vehicle interior material 130, the exterior material 120, and the vehicle interior material 130, and may indirectly or directly vibrate one or more of the main structure 110, the exterior material 120, and the vehicle interior material 130 to output sound.

According to an exemplary embodiment of the present disclosure, the sound apparatuses 30 may output a sound in a region between the exterior material 120 and the vehicle interior material 130 of the vehicle 10. For example, the sound apparatus 30 may be disposed in at least one or more of a region (or a third region) between the exterior material 120 and the vehicle interior material 130, the exterior material 120 and the vehicle interior material 130. For example, the sound apparatus 30 may be disposed between the exterior material 120 and the vehicle interior material 130, and may indirectly or directly vibrate one or more of the exterior material 120 and the vehicle interior material 130 to output sound. For example, the sound apparatuses 30 may be connected or coupled to one or more of the exterior material 120 and the vehicle interior material 130 between the exterior material 120 and the vehicle interior material 130, and may indirectly or directly vibrate one or more of the exterior material 120 and the vehicle interior material 130 to output sound. For example, the at least one or more of the exterior material 120 and the vehicle interior material 130 may output a sound S based on driving (or vibration or displacement) of the one or more sound apparatuses 30.

According to an exemplary embodiment of the present disclosure, one or more of the exterior material 120 and the vehicle interior material 130 of the vehicle 10 may be a vibration plate, a sound vibration plate, or a sound generating plate, or the like for outputting the sound S. For example, each of the exterior material 120 and the vehicle interior material 130 for outputting the sound S may have a size (or an area) which is greater than that of the sound apparatus 30, and thus, may perform a function of a large-area vibration plate, a large-area sound vibration plate, or a large-area sound generating plate, thereby enhancing a sound characteristic and/or a sound pressure level characteristic of a pitched sound band including a low-pitched sound band generated by the sound apparatus 30. For example, a frequency of a sound of the low-pitched sound band may be 300 Hz or less, 400 Hz or less, or 500 Hz or less, but embodiments of the present disclosure are not limited thereto.

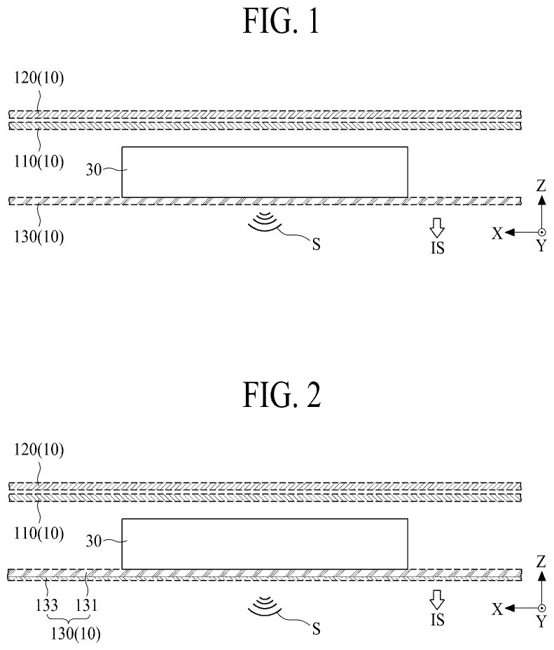

FIG. 2 is a diagram illustrating a sound apparatus for vehicles according to another exemplary embodiment of the present disclosure. For example, FIG. 2 illustrates an embodiment implemented by modifying the vehicle interior material 130 on which the sound apparatus described above with reference to FIG. 1 is disposed. Therefore, in the following description, repeated descriptions of other elements other than the vehicle interior material 130 may be omitted or will be briefly given.

With reference to FIG. 2, the sound apparatus 30 according to another exemplary embodiment of the present disclosure may vibrate a vehicle interior material 130 to output a sound S.

The vehicle interior material 130 according to an exemplary embodiment of the present disclosure may include one or more materials of metal, wood, rubber, plastic, glass, fiber, cloth, paper, a mirror, leather, and carbon, but embodiments of the present disclosure are not limited thereto.

The vehicle interior material 130 according to another exemplary embodiment of the present disclosure may include a base member 131 and a surface member 133. For example, the base member 131 may be an injection material, a first interior material, an inner interior material, or a rear interior material, but embodiments of the present disclosure are not limited thereto. The surface member 133 may be a second interior material, an outer interior material, a front interior material, an outer surface member, a reinforcement member, or a decoration member, but embodiments of the present disclosure are not limited thereto.

The base member 131 may include a plastic material. The base member 131 according to an exemplary embodiment of the present disclosure may include an injection material. For example, the base member 131 may be an injection material which is implemented by an injection process using a thermoplastic resin or a thermosetting resin, but embodiments of the present disclosure are not limited thereto. The vehicle interior material 130 or the base member 131 may be configured to cover an inner portion of a vehicle 10. For example, the vehicle interior material 130 or the base member 131 may be configured to cover one or more of the main structure 110 and the exterior material 120 in an interior space IS of the vehicle 10. For example, the vehicle interior material 130 or the base member 131 may be configured to cover one surface (or an inner surface) of one or more of a main frame, a side frame, a door frame, and a handle frame, which are exposed at the interior space IS of the vehicle 10.

The base member 131 may include at least one or more of a planar portion and a curved portion. For example, the base member 131 may have a structure corresponding to a structure (or a rear structure) of a corresponding main structure 110, or may have a structure which differs from a structure of a corresponding main structure 110.

The surface member 133 may be disposed on the base member 131. For example, the surface member 133 may be disposed to cover the base member 131. The surface member 133 may cover the base member 131 at the inner portion or the interior space IS of the vehicle 10 and may be configured to be exposed at the inner portion or the interior space IS of the vehicle 10. For example, the surface member 133 may be disposed in or coupled to a front surface (or an interior surface) of the base member 131 exposed at the interior space IS of the vehicle 10. For example, the sound apparatus 30 may be disposed on the surface member 133 of the vehicle interior material 130, and located below the main structure 110. For example, the sound apparatus 30 may be configured in a region between the vehicle interior material 130 and the main structure 110, as shown in FIG. 2.

The vehicle interior material 130 or the surface member 133 according to an exemplary embodiment of the present disclosure may include one or more materials of plastic, glass, fiber, leather, cloth, rubber, a mirror, wood, paper, carbon, and metal, but embodiments of the present disclosure are not limited thereto. For example, the surface member 133 may be a fiber material. For example, the surface member 133 including the fiber material may include at least one or more of a synthetic fiber, a carbon fiber (or an aramid fiber), and a natural fiber, but embodiments of the present disclosure are not limited thereto. For example, the surface member 133 including the fiber material may be a textile sheet, a knit sheet, or a nonwoven fabric, but embodiments of the present disclosure are not limited thereto. For example, the surface member 133 including the fiber material may be a fabric member, but embodiments of the present disclosure are not limited thereto.

The synthetic fiber may be a thermoplastic resin and may include a polyolefin-based fiber which is an eco-friendly material which does not relatively release a harmful substance. For example, the polyolefin-based fiber may include a polyethylene fiber, a polypropylene fiber, or a polyethylene terephthalate fiber, but embodiments of the present disclosure are not limited thereto. The polyolefin-based fiber may be a fiber of a single resin or a fiber of a core-shell structure, but embodiments of the present disclosure are not limited thereto. The natural fiber may be a composite fiber of one or two or more of a jute fiber, a kenaf fiber, an abaca fiber, a coconut fiber, and a wood fiber, but embodiments of the present disclosure are not limited thereto.

The sound apparatus 30 may be covered by the vehicle interior material 130. The sound apparatus 30 may be configured to vibrate (or directly vibrate) the vehicle interior material 130 including the base member 131 and the surface member 133 to output a sound S based on a vibration of the vehicle interior material 130. For example, the sound apparatus 30 may be configured to vibrate the vehicle interior material 130 including the base member 131 and the surface member 133 to output the sound S toward the inner portion and/or the interior space IS of the vehicle 10. Thus, the sound apparatus 30 may use the vehicle interior material 130 including the base member 131 and the surface member 133 as a sound vibration plate or a sound diaphragm.

The sound apparatus 30 according to another exemplary embodiment of the present disclosure may output the sound S toward the interior space IS of the vehicle 10 using the vehicle interior material 130 as a vibration plate or a sound vibration plate and may output a realistic sound S and/or stereo sound including a multichannel toward the interior space IS of the vehicle 10.

According to another exemplary embodiment of the present disclosure, the sound apparatus 30 may be configured to be surrounded by an enclosure. A space may be provided between the sound apparatus 30 and the enclosure, and a sound (or a sound pressure level) may be output based on a vibration of the vehicle interior material 130 based on air between the sound apparatus 30 and the enclosure. However, there may be a problem where a sound of the low-pitched sound band is not output, and there may be a problem where the flatness of a sound pressure level is reduced because the number of peaks and dips occurring in a reproduction frequency band of a sound (or a sound pressure level) generated based on a vibration of the vehicle interior material 130 increases and each of a highest sound pressure level and a lowest sound pressure level occurring in a reproduction frequency band of a sound (or a sound pressure level) generated based on a vibration of the vehicle interior material 130 increases. The peak may be a phenomenon where a sound pressure level bounces in a specific frequency, and the dip may be a phenomenon where a low sound pressure level is generated as the occurrence of a sound having a specific frequency is reduced. The flatness of a sound characteristic may be a level of a deviation between a highest sound pressure and a lowest sound pressure in a specific frequency.

The inventors of the present disclosure have performed extensive research and experiments for implementing a sound apparatus and a vehicular apparatus including the same, in which a sound characteristic of a sound including a low-pitched sound band and a middle-high-pitched sound band may be increased (or improved). Based on the extensive research and experiments, the inventors of the present disclosure have invented a sound apparatus and a vehicular apparatus including the same, which may enhance a sound characteristic of a sound including the low-pitched sound band and the middle-high-pitched sound band. This will be described below in detail.

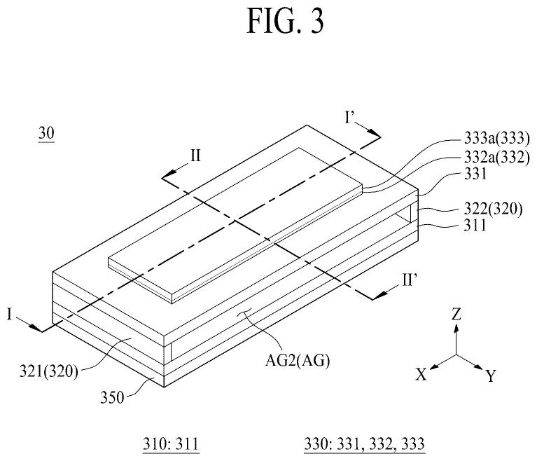

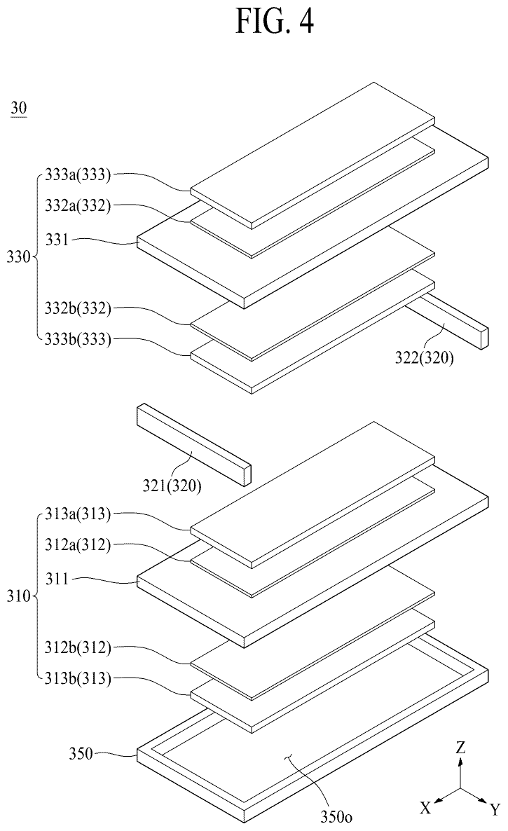

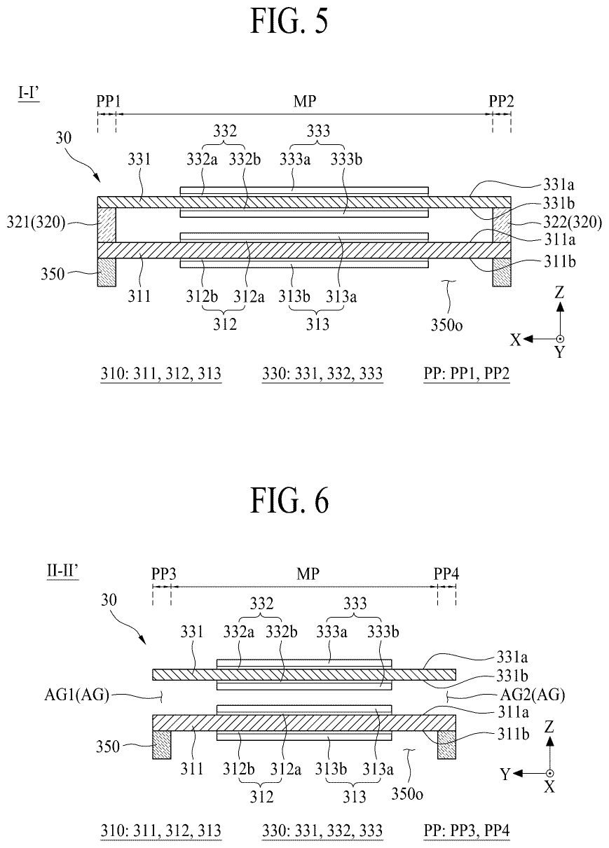

FIG. 3 is a perspective view illustrating a sound apparatus according to an exemplary embodiment of the present disclosure. FIG. 4 is an exploded perspective view of a sound apparatus according to an exemplary embodiment of the present disclosure. FIG. 5 is a cross-sectional view taken along line I-I′ illustrated in FIG. 4 according to an exemplary embodiment of the present disclosure. FIG. 6 is a cross-sectional view taken along line II-II′ illustrated in FIG. 4 according to an exemplary embodiment of the present disclosure.

With reference to FIGS. 3 to 6, the sound apparatus 30 (or a sound apparatus for vehicles) according to an exemplary embodiment of the present disclosure may be configured to vibrate a vibration object or a vehicle structure. For example, the sound apparatus 30 may be a sound generating apparatus, a sound output apparatus, a speaker apparatus, a car audio device, or an audio apparatus, but embodiments of the present disclosure are not limited thereto.

The sound apparatus 30 may be configured to be connected (or coupled) to the vibration object or the vehicle structure. For example, the sound apparatus 30 may be disposed in (or connected to) a portion of any one of the main structure 110, the exterior material 120, and the interior material 130 illustrated in FIG. 1 or 2 to generate (or output) a sound. For example, the sound apparatus 30 may vibrate any one of the main structure 110, the exterior material 120, and the interior material 130 illustrated in FIG. 1 or 2 to generate (or output) a sound.

The sound apparatus 30 according to an exemplary embodiment of the present disclosure may include a first sound generating part 310, a second sound generating part 330, and a coupling member 320.

As one example, the sound apparatus 30 according to an exemplary embodiment of the present disclosure may include a first sound generating structure 310 (also referred to as “a first sound generating part 310”), a second sound generating structure 330 (also referred to as “a second sound generating part 330”) spaced apart from the first sound generating part 310, and a coupling member 320 partially provided between the first sound generating part 310 and the second sound generating part 330, without being limited thereto.

The first sound generating part 310 may be configured to generate or output a sound (or a sound wave) or a vibration. For example, the first sound generating part 310 may include a rectangular shape having a long side and a short side, but embodiments of the present disclosure are not limited thereto. For example, the long side (or a long-side length) of the first sound generating part 310 may be at least two or more times the short side (or a short-side length) of the first sound generating part 310, but embodiments of the present disclosure are not limited thereto. For example, the first sound generating part 310 may be a sound generating apparatus, a sound generating device, a sound generating module, a sound generating unit, a lower sound generating part, a lower sound generating device, a lower sound generating module, or a lower sound generating unit, but embodiments of the present disclosure are not limited thereto.

The first sound generating part 310 according to an exemplary embodiment of the present disclosure may include a first vibration member 311 and a first vibration apparatus 313.

As one example, the sound generating part 310 according to an exemplary embodiment of the present disclosure may include a first vibration member 311 and a first vibration apparatus 313 connected to the first vibration member 311 and configured to vibrate the first vibration member 311.

The first vibration member 311 may generate a vibration or may output a sound (or a sound wave or a sound pressure level) based on the driving (or vibration or displacement) of the first vibration apparatus 313. For example, the first vibration member 311 may be a first vibration plate, a first passive vibration member, a first passive vibration panel, a lower vibration member, a lower vibration plate, a lower passive vibration member, or a lower passive vibration panel, but embodiments of the present disclosure are not limited thereto.

The first vibration member 311 may include a tetragonal shape, but embodiments of the present disclosure are not limited thereto. For example, the first vibration member 311 may have a rectangular shape including a long side and a short side, but embodiments of the present disclosure are not limited thereto. For example, the long side (or a long-side length) of the first vibration member 311 may be at least two or more times the short side (or a short-side length) of the first vibration member 311, but embodiments of the present disclosure are not limited thereto.

According to an exemplary embodiment of the present disclosure, the first vibration member 311 may have a flat plate structure having a long side and a short side, but embodiments of the present disclosure are not limited thereto. For example, the first vibration member 311 may include a first surface 311a and a second surface 311b opposite the first surface 311a. For example, in the first vibration member 311, the first surface 311a may be a front surface or an upper surface, and the second surface 311b may be a rear surface or a lower surface, without being limited thereto.

The first vibration apparatus 313 may be configured to vibrate the first vibration member 311. The first vibration apparatus 313 may be configured to vibrate (or displace or drive) the first vibration member 311 based on a driving signal (or a vibration driving signal or a voice signal) applied thereto. For example, the first vibration apparatus 313 may be a vibration generating apparatus, a vibration generating device, a displacement apparatus, a displacement device, a piezoelectric vibration apparatus, or a piezoelectric vibration device, but embodiments of the present disclosure are not limited thereto.

The first vibration apparatus 313 may have a same shape as that of the first vibration member 311, but embodiments of the present disclosure are not limited thereto. Alternatively, the first vibration apparatus 313 may have a different shape as that of the first vibration member 311. For example, the first vibration apparatus 313 may include a rectangular shape having a long side and a short side, but embodiments of the present disclosure are not limited thereto. For example, the first vibration apparatus 313 may have a smaller size than that of the first vibration member 311, but embodiments of the present disclosure are not limited thereto.

The first vibration apparatus 313 may be disposed in or connected to one or more of the first surface 311a and the second surface 311b of the first vibration member 311. The first vibration apparatus 313 according to an exemplary embodiment of the present disclosure may include one or more (or a plurality of) vibration generators 313a and 313b connected to one or more of the first surface 311a and the second surface 311b of the first vibration member 311.

The first vibration apparatus 313 according to an exemplary embodiment of the present disclosure may include a first vibration generator 313a and a second vibration generator 313b.

The first vibration generator 313a and the second vibration generator 313b may be disposed or configured with the first vibration member 311 therebetween. For example, the first vibration generator 313a and the second vibration generator 313b may overlap each other with the first vibration member 311 therebetween. The first vibration generator 313a may be disposed in or connected to the first surface 311a of the first vibration member 311. The second vibration generator 313b may be disposed in or connected to the second surface 311b of the first vibration member 311. For example, the first vibration generator 313a may be a 1-1^{th} vibration generator or a first upper vibration generator. For example, the second vibration generator 313b may be a 1-2^{th} vibration generator or a first lower vibration generator.

According to an exemplary embodiment of the present disclosure, long sides of each of the first vibration generator 313a and the second vibration generator 313b may be parallel to the long side of the first vibration member 311 and may be spaced apart from the long side of the first vibration member 311. According to an exemplary embodiment of the present disclosure, short sides of each of the first vibration generator 313a and the second vibration generator 313b may be parallel to the short side of the first vibration member 311 and may be spaced apart from the short side of the first vibration member 311. Each of the first vibration generator 313a and the second vibration generator 313b may have a smaller size than that of the first vibration member 311, but embodiments of the present disclosure are not limited thereto.

Each of the first vibration generator 313a and the second vibration generator 313b may be configured to vibrate (or displace or drive) the first vibration member 311 based on a vibration (or displacement or driving) of the piezoelectric material based on an electric signal (or a voice signal or a sound signal) applied to the piezoelectric material. For example, each of the first vibration generator 313a and the second vibration generator 313b may alternately repeat contraction and/or expansion by a piezoelectric effect (or a piezoelectric characteristic) to vibrate (or displace or drive). For example, each of the first vibration generator 313a and the second vibration generator 313b may vibrate (or displace or drive) in a vertical direction (or a thickness direction) Z as contraction and/or expansion are alternately repeated by an inverse piezoelectric effect. For example, in each of the first vibration generator 313a and the second vibration generator 313b, the piezoelectric material including a piezoelectric ceramic may vibrate or mechanically displace (or vibrate or drive) in response to an electrical signal applied from the outside. Accordingly, the first vibration member 311 may generate a vibration or may output a sound (or a sound wave), based on the displacements (or driving) of each of the first vibration generator 313a and the second vibration generator 313b.

According to an exemplary embodiment of the present disclosure, the driving signals (or the vibration driving signals or the voice signals) applied to the first vibration generator 313a and the second vibration generator 313b may be a same or different. For example, the driving signals applied to the first vibration generator 313a and the second vibration generator 313b may have a same phase or different phases. For example, the first vibration generator 313a and the second vibration generator 313b may have a bimorph structure which are disposed with the first vibration member 311 therebetween. Each of the first vibration generator 313a and the second vibration generator 313b may independently vibrate the first vibration member 311, and thus, an influence thereof on a sound characteristic based on a material and a characteristic of the first vibration member 311 may be reduced. Accordingly, a sound characteristic and/or a sound pressure level characteristic of a pitched sound band including a low-pitched sound band of the sound apparatus 30 may be enhanced.

According to another exemplary embodiment of the present disclosure, the first vibration generator 313a and the second vibration generator 313b may be configured at any one of the first surface 311a and the second surface 311b of the first vibration member 311. For example, the first vibration generator 313a may be configured at any one of the first surface 311a and the second surface 311b of the first vibration member 311. For example, the first vibration generator 313a may be connected to or configured at the first surface 311a of the first vibration member 311. For example, the second vibration generator 313b may be connected to or stacked on the first vibration generator 313a.

The sound apparatus 30 or the first sound generating part 310 according to an exemplary embodiment of the present disclosure may further include a first adhesive member 312.

The first adhesive member 312 may be disposed (or interposed) between the first vibration member 311 and the first vibration apparatus 313. For example, the first vibration apparatus 313 may be connected or coupled to the first vibration member 311 by the first adhesive member 312. For example, the first adhesive member 312 may be disposed (or interposed) between the first vibration member 311 and one or more vibration generators 313a and 313b.

The first adhesive member 312 according to an exemplary embodiment of the present disclosure may include a first upper adhesive member (or a 1-1^{th} adhesive member) 312a and a first lower adhesive member (or a 1-2^{th} adhesive member) 312b.

The first upper adhesive member 312a may be disposed (or interposed) between the first vibration member 311 and the first vibration generator 313a. The first vibration generator 313a may be connected or coupled to the first vibration member 311 by the first upper adhesive member 312a. For example, the first vibration generator 313a may be connected or coupled to the first surface 311a of the first vibration member 311 by the first upper adhesive member 312a.

The first lower adhesive member 312b may be disposed (or interposed) between the first vibration member 311 and the second vibration generator 313b. The second vibration generator 313b may be connected or coupled to the first vibration member 311 by the first lower adhesive member 312b. For example, the second vibration generator 313b may be connected or coupled to the second surface 311b of the first vibration member 311 by the first lower adhesive member 312b.

The first adhesive member 312, may include an adhesive layer (or a tacky layer) which is good in adhesive force or attaching force, but embodiments of the present disclosure are not limited thereto. For example, the first upper adhesive member 312a and the first lower adhesive member 312b may include an adhesive layer (or a tacky layer) which is good in adhesive force or attaching force. For example, the first adhesive member 312, or the first upper adhesive member 312a and the first lower adhesive member 312b may include a same or different adhesive layers (or tacky layers). For example, the first adhesive member 312, or the first upper adhesive member 312a and the first lower adhesive member 312b may include an adhesive, a double-sided adhesive, a double-sided tape, a double-sided adhesive tape, a double-sided adhesive foam tape, a double-sided pad, a double-sided foam pad, a double-sided adhesive foam pad, a double-sided cushion tape, or a tacky sheet, but embodiments of the present disclosure are not limited thereto.

The second sound generating part 330 may be configured to generate or output a sound (or a sound wave) or a vibration. For example, the second sound generating part 330 may include a rectangular shape having a long side and a short side, but embodiments of the present disclosure are not limited thereto. For example, the long side (or a long-side length) of the second sound generating part 330 may be at least two or more times the short side (or a short-side length) of the second sound generating part 330, but embodiments of the present disclosure are not limited thereto. For example, the second sound generating part 330 may be configured to have a same shape and size as that of the first sound generating part 310, but embodiments of the present disclosure are not limited thereto. For example, the second sound generating part 330 may be a sound generating apparatus, a sound generating device, a sound generating module, a sound generating unit, an upper sound generating part, an upper sound generating device, an upper sound generating module, or an upper sound generating unit, but embodiments of the present disclosure are not limited thereto.

The second sound generating part 330 according to an exemplary embodiment of the present disclosure may include a second vibration member 331 and a second vibration apparatus 333.

As one example, the second sound generating part 330 according to an exemplary embodiment of the present disclosure may include a second vibration member 331 and a second vibration apparatus 333 connected to the second vibration member 331 and configured to vibrate the second vibration member 331, and the coupling member 320 may be partially provided between the first vibration member 311 and the second vibration member 331.

The second vibration member 331 may generate a vibration or may output a sound (or a sound wave or a sound pressure level) based on the driving (or vibration or displacement) of the second vibration apparatus 333. For example, the second vibration member 331 may be a second vibration plate, a second passive vibration member, a second passive vibration panel, an upper vibration member, an upper vibration plate, an upper passive vibration member, or an upper passive vibration panel, but embodiments of the present disclosure are not limited thereto.

The second vibration member 331 may include a tetragonal shape, but embodiments of the present disclosure are not limited thereto. For example, the second vibration member 331 may have a rectangular shape including a long side and a short side, but embodiments of the present disclosure are not limited thereto. For example, the long side (or a long-side length) of the second vibration member 331 may be at least two or more times the short side (or a short-side length) of the second vibration member 331, but embodiments of the present disclosure are not limited thereto. For example, the second vibration member 331 may have a shape which is a same as or different from that of the first vibration member 311 of the first sound generating part 310, but embodiments of the present disclosure are not limited thereto. For example, the second vibration member 331 may have a size which is smaller than or equal to the first vibration member 311 of the first sound generating part 310, but embodiments of the present disclosure are not limited thereto.

According to an exemplary embodiment of the present disclosure, the second vibration member 331 may have a flat plate structure having a long side and a short side, but embodiments of the present disclosure are not limited thereto. For example, the second vibration member 331 may include a first surface 331a and a second surface 331b opposite the first surface 331a. For example, in the second vibration member 331, the first surface 331a may be a front surface or an upper surface, and the second surface 331b may be a rear surface or a lower surface, but embodiments of the present disclosure are not limited thereto. For example, the second surface 331b of the second vibration member 331 may face the first sound generating part 310.

The second vibration apparatus 333 may be configured to vibrate the second vibration member 331. The second vibration apparatus 333 may be configured to vibrate (or displace or drive) the second vibration member 331 based on a driving signal (or a vibration driving signal or a voice signal) applied thereto. For example, the second vibration apparatus 333 may be a vibration generating apparatus, a vibration generating device, a displacement apparatus, a displacement device, a piezoelectric vibration apparatus, or a piezoelectric vibration device, but embodiments of the present disclosure are not limited thereto.

The second vibration apparatus 333 may have a shape which is a same as or different from that of the second vibration member 331. For example, the second vibration apparatus 333 may include a rectangular shape having a long side and a short side, but embodiments of the present disclosure are not limited thereto. For example, the second vibration apparatus 333 may have a smaller size than that of the second vibration member 331, but embodiments of the present disclosure are not limited thereto.

The second vibration apparatus 333 may be disposed in or connected to one or more of the first surface 331a and the second surface 331b of the second vibration member 331. The second vibration apparatus 333 according to an exemplary embodiment of the present disclosure may include one or more (or a plurality of) vibration generators 333a and 333b connected to one or more of the first surface 331a and the second surface 331b of the second vibration member 331.

The second vibration apparatus 333 according to an exemplary embodiment of the present disclosure may include a third vibration generator 333a and a fourth vibration generator 333b.

The third vibration generator 333a and the fourth vibration generator 333b may be disposed or configured with the second vibration member 331 therebetween. For example, the third vibration generator 333a and the fourth vibration generator 333b may overlap each other with the second vibration member 331 therebetween. The third vibration generator 333a may be disposed in or connected to the first surface 331a of the second vibration member 331. The fourth vibration generator 333b may be disposed in or connected to the second surface 331b of the second vibration member 331. For example, the third vibration generator 333a may be a 2-1^{th} vibration generator or a second upper vibration generator. For example, the fourth vibration generator 333b may be a 2-2^{th} vibration generator or a second lower vibration generator.

According to an exemplary embodiment of the present disclosure, long sides of each of the third vibration generator 333a and the fourth vibration generator 333b may be parallel to the long side of the second vibration member 331 and may be spaced apart from the long side of the second vibration member 331. According to an exemplary embodiment of the present disclosure, short sides of each of the third vibration generator 333a and the fourth vibration generator 333b may be parallel to the short side of the second vibration member 331 and may be spaced apart from the short side of the second vibration member 331. Each of the third vibration generator 333a and the fourth vibration generator 333b may have a smaller size than that of the second vibration member 331, but embodiments of the present disclosure are not limited thereto.

Each of the third vibration generator 333a and the fourth vibration generator 333b may be configured to vibrate (or displace or drive) the second vibration member 331 based on a vibration (or displacement or driving) of the piezoelectric material based on an electric signal (or a voice signal or a sound signal) applied to the piezoelectric material. For example, each of the third vibration generator 333a and the fourth vibration generator 333b may alternately repeat contraction and/or expansion by a piezoelectric effect (or a piezoelectric characteristic) to vibrate (or displace or drive). For example, each of the third vibration generator 333a and the fourth vibration generator 333b may vibrate (or displace or drive) in a vertical direction (or a thickness direction) Z as contraction and/or expansion are alternately repeated by an inverse piezoelectric effect. For example, in each of the third vibration generator 333a and the fourth vibration generator 333b, the piezoelectric material including a piezoelectric ceramic may vibrate or mechanically displace (or vibrate or drive) in response to an electrical signal applied from the outside. Accordingly, the second vibration member 331 may generate a vibration or may output a sound (or a sound wave), based on the displacements (or driving) of each of the third vibration generator 333a and the fourth vibration generator 333b.

According to an exemplary embodiment of the present disclosure, the driving signals (or the vibration driving signals or the voice signals) applied to the third vibration generator 333a and the fourth vibration generator 333b may be a same or different. For example, the driving signals applied to the third vibration generator 333a and the fourth vibration generator 333b may have a same phase or different phases. For example, the third vibration generator 333a and the fourth vibration generator 333b may have a bimorph structure which are disposed with the second vibration member 331 therebetween. Each of the third vibration generator 333a and the fourth vibration generator 333b may independently vibrate the second vibration member 331, and thus, an influence thereof on a sound characteristic based on a material and a characteristic of the second vibration member 331 may be reduced. Accordingly, a sound characteristic and/or a sound pressure level characteristic of a pitched sound band including a low-pitched sound band of the sound apparatus 30 may be enhanced.

According to another exemplary embodiment of the present disclosure, the third vibration generator 333a and the fourth vibration generator 333b may be configured at any one of the first surface 331a and the second surface 331b of the second vibration member 331. For example, the third vibration generator 333a may be configured at any one of the first surface 331a and the second surface 331b of the second vibration member 331. For example, the third vibration generator 333a may be connected to or configured at the first surface 331a of the second vibration member 331. For example, the fourth vibration generator 333b may be connected to or stacked on the third vibration generator 333a.

The sound apparatus 30 or the second sound generating part 330 according to an exemplary embodiment of the present disclosure may further include a second adhesive member 332.

The second adhesive member 332 may be disposed (or interposed) between the second vibration member 331 and the second vibration apparatus 333. For example, the second vibration apparatus 333 may be connected or coupled to the second vibration member 331 by the second adhesive member 332. For example, the second adhesive member 332 may be disposed (or interposed) between the second vibration member 331 and one or more vibration generators 333a and 333b.

The second adhesive member 332 according to an exemplary embodiment of the present disclosure may include a second upper adhesive member (or a 2-1^{th} adhesive member) 332a and a second lower adhesive member (or a 2-2^{th} adhesive member) 332b.

The second upper adhesive member 332a may be disposed (or interposed) between the second vibration member 331 and the third vibration generator 333a. The third vibration generator 333a may be connected or coupled to the second vibration member 331 by the second upper adhesive member 332a. For example, the third vibration generator 333a may be connected or coupled to the first surface 331a of the second vibration member 331 by the second upper adhesive member 332a.

The second lower adhesive member 332b may be disposed (or interposed) between the second vibration member 331 and the fourth vibration generator 333b. The fourth vibration generator 333b may be connected or coupled to the second vibration member 331 by the second lower adhesive member 332b. For example, the fourth vibration generator 333b may be connected or coupled to the second surface 331b of the second vibration member 331 by the second lower adhesive member 332b.

The second adhesive member 332 may include an adhesive layer (or a tacky layer) which is good in adhesive force or attaching force, but embodiments of the present disclosure are not limited thereto. For example, the second upper adhesive member 332a and the second lower adhesive member 332b may include an adhesive layer (or a tacky layer) which is good in adhesive force or attaching force. For example, the second adhesive member 332, or the second upper adhesive member 332a and the second lower adhesive member 332b may include a same or different adhesive layers (or tacky layers). For example, the second adhesive member 332, or the second upper adhesive member 332a and the second lower adhesive member 332b may include an adhesive, a double-sided adhesive, a double-sided tape, a double-sided adhesive tape, a double-sided adhesive foam tape, a double-sided pad, a double-sided foam pad, a double-sided adhesive foam pad, a double-sided cushion tape, or a tacky sheet, but embodiments of the present disclosure are not limited thereto.

According to an exemplary embodiment of the present disclosure, the first vibration member 311 may be configured with a same material as that of the second vibration member 331 or may be configured in a different material from the second vibration member 331. For example, one or more of the first vibration member 311 and the second vibration member 331 may include a single nonmetal material or a composite nonmetal material, but embodiments of the present disclosure are not limited thereto. For example, the single nonmetal material or the composite nonmetal material may include one or more materials of wood, rubber, plastic, carbon, glass, fiber, cloth, paper, mirror, and leather, but embodiments of the present disclosure are not limited thereto. For example, the paper may be cone paper for speakers. For example, the cone paper may be pulp or foamed plastic, or the like, but embodiments of the present disclosure are not limited thereto.

One or more of the first vibration member 311 and the second vibration member 331 according to an exemplary embodiment of the present disclosure may be configured in a plastic material or a plastic material of styrene material, but embodiments of the present disclosure are not limited thereto.

The plastic material of one or more of the first vibration member 311 and the second vibration member 331 may be configured in polyethylene terephthalate, polycarbonate, polyimide, polypropylene, polyarylate, polyethersulfone, polyethylene naphthalate, polysulfone, cyclo-olefin copolymer, or carbon fiber reinforced plastic (CFRP), or the like, but embodiments of the present disclosure are not limited thereto.

The styrene material of one or more of the first vibration member 311 and the second vibration member 331 may be an ABS material. The ABS material may be acrylonitrile, butadiene, and styrene.

One or more of the first vibration member 311 and the second vibration member 331 according to an exemplary embodiment of the present disclosure may include a porous material. For example, one or more of the first vibration member 311 and the second vibration member 331 may include a micro cellular plastic material. For example, one or more of the first vibration member 311 and the second vibration member 331 may be configured in a polyethylene terephthalate material or a polycarbonate material. For example, one or more of the first vibration member 311 and the second vibration member 331 may be configured in a Micro Cellular polyethylene terephthalate (MCPET) material. One or more of the first vibration member 311 and the second vibration member 331 configured in the MCPET may have capability to reproduce a high original sound because having a low density and an excellent elastic force, thereby enhancing the quality of a sound.

The coupling member 320 according to an exemplary embodiment of the present disclosure may be partially between the first sound generating part 310 and the second sound generating part 330. For example, the coupling member 320 may be partially between a periphery portion (or an edge portion) PP of the second sound generating part 330 and the first sound generating part 310. For example, the periphery portion PP of the second sound generating part 330 may be partially connected or coupled to the first sound generating part 310 by the coupling member 320.

For example, the coupling member 320 may be disposed between the first sound generating part 310 and a periphery portion, which is adjacent to a short side, of the second sound generating part 330 and is not disposed between the first sound generating part 310 and a periphery portion, which is adjacent to a long side, of the second sound generating part 330, without being limited thereto.

The sound apparatus 30 according to an exemplary embodiment of the present disclosure may further include an air gap AG which is partially provided between the periphery portion PP of the second sound generating part 330 and the first sound generating part 310. For example, the coupling member 320 may be partially between the periphery portion PP of the second sound generating part 330 and the first sound generating part 310 to include the air gap AG between the periphery portion PP of the second sound generating part 330 and the first sound generating part 310. For example, the air gap AG may be in at least a portion of a region between the first sound generating part 310 and a periphery portion PP, which is adjacent to the long side, of the second sound generating part 330.

The coupling member 320 according to an exemplary embodiment of the present disclosure may be partially configured between the second vibration member 331 of the second sound generating part 330 and the first vibration member 311 of the first sound generating part 310. For example, the coupling member 320 may be partially connected or coupled to a region between the first vibration member 311 and the second vibration member 331. For example, the coupling member 320 may be disposed (or interposed) in a portion of a region between the periphery portion PP of the second vibration member 331 and the first vibration member 311. For example, the coupling member 320 may be partially disposed (or interposed) in a region between the periphery portion PP of the second vibration member 331 and the first vibration member 311.

The sound apparatus 30 according to an exemplary embodiment of the present disclosure may include an air gap AG which is partially provided between the first sound generating part 310 and the second sound generating part 330. For example, the sound apparatus 30 according to an exemplary embodiment of the present disclosure may include an air gap AG which is partially provided between the first vibration member 311 of the first sound generating part 310 and the second vibration member 331 of the second sound generating part 330. For example, the sound apparatus 30 may include the air gap AG which is partially provided between the first vibration member 311 and the second vibration member 331 by the coupling member 320. For example, the coupling member 320 may be partially disposed (or interposed) in a region between the first vibration member 311 and the second vibration member 331 to include (or allow) the air gap AG between the first vibration member 311 and the second vibration member 331. For example, the coupling member 320 may be partially disposed (or interposed) in a region between the periphery portion PP of the second vibration member 331 and the first vibration member 311 to include (or allow) the air gap AG between the periphery portion PP of the second vibration member 331 and the first vibration member 311. For example, the air gap AG may be in at least a portion of a region between the periphery portion PP, which is adjacent to the long side, of the second vibration member 331 and the periphery portion PP of the first vibration member 311.

The coupling member 320 according to an exemplary embodiment of the present disclosure may be configured to enhance a sound characteristic and/or a sound pressure level characteristic of a low-pitched sound band generated in the second sound generating part 330. For example, the coupling member 320 may be configured to enhance a sound characteristic and/or a sound pressure level characteristic of a low-pitched sound band generated based on a vibration of the second sound generating part 330 or the second vibration member 331. For example, the coupling member 320 may be configured to increase or maximize the amount of displacement (or bending force) or amplitude displacement (or vibration width) of the second sound generating part 330 or the second vibration member 331. For example, the coupling member 320 may be configured (or disposed) not to hinder (or restrain) a vibration (or displacement) at a center portion including a center of the second vibration member 331 when the second vibration member 331 is vibrating (or displace) based on a vibration of the second vibration apparatus 333. For example, the coupling member 320 may be configured (or disposed) not to hinder (or restrain) a vibration (or displacement) of the second vibration member 331 in a long-side length direction of the second sound generating part 330 or the second vibration member 331. For example, the low-pitched sound band may be 200 Hz or less, 300 Hz or less, or 400 Hz or less, but embodiments of the present disclosure are not limited thereto.

The coupling member 320 according to an exemplary embodiment of the present disclosure may be disposed (or interposed) between the first sound generating part 310 and a periphery portion (or a short side periphery portion), which is adjacent to a short side, of the second sound generating part 330. For example, the coupling member 320 according to an exemplary embodiment of the present disclosure may be disposed (or interposed) between the first vibration member 311 and a periphery portion (or a short side periphery portion) PP1 and PP2, which is adjacent to a short side, of the second vibration member 331. For example, the coupling member 320 may be disposed (or interposed) in a region between the first vibration member 311 and both periphery portions PP1 and PP2, which are adjacent to the short side, of the second vibration member 331. For example, the coupling member 320 may be disposed (or interposed) in a region between the first vibration member 311 and each of first and second periphery portions PP1 and PP2, which are adjacent to the short side, of the second vibration member 331. For example, the coupling member 320 may be disposed (or interposed) over an entire region (or without an air gap) between the first vibration member 311 and each of the first and second periphery portions PP1 and PP2 of the second vibration member 331. For example, the coupling member 320 may be a both-short-side fixing structure material of the second vibration member 331. For example, the coupling member 320 may be configured to have the both-short-side fixing structure corresponding (or with respect) to the second vibration member 331. For example, the coupling member 320 may be a joint member, an edge coupling member, an edge joint member, a fixing member, or an edge fixing member, but embodiments of the present disclosure are not limited thereto.

The coupling member 320 according to an exemplary embodiment of the present disclosure may not be disposed (or interposed) between the first sound generating part 310 and a periphery portion (or a long side periphery portion) PP3 and PP4, which is adjacent to a long side, of the second sound generating part 330. For example, the coupling member 320 according to an exemplary embodiment of the present disclosure may not be disposed (or interposed) between the first vibration member 311 and a periphery portion (or a long side periphery portion) PP3 and PP4, which is adjacent to a long side, of the second vibration member 331. For example, the coupling member 320 may not be disposed (or interposed) between the first vibration member 311 and both periphery portions PP3 and PP4, which are adjacent to the long side, of the second vibration member 331. For example, the coupling member 320 may not be disposed (or interposed) in a region between the first vibration member 311 and each of third and fourth periphery portions PP3 and PP4, which are adjacent to the long side, of the second vibration member 331.

According to an exemplary embodiment of the present disclosure, an air gap AG may be provided in at least a portion of a region between the first sound generating part 310 and a periphery portion, which is adjacent to a long side, of the second sound generating part 330. For example, the air gap AG may be provided in a region between the first vibration member 311 and each of the third and fourth periphery portions PP3 and PP4 of the second vibration member 331. For example, third and fourth periphery portions PP3 and PP4 of the second vibration member 331 may be freely vibrated (or displaced) without being hindered (or restrained) by the coupling member 320 or the first vibration member 311 due to the air gap AG. Accordingly, the amount of displacement (or bending force) or the amplitude displacement (or vibration width) of the second vibration member 331 in a long-side length direction of the second vibration member 331 may increase or be maximized, and thus, a sound characteristic and/or a sound pressure level characteristic of a low-pitched sound band generated based on a vibration of the second vibration member 331 based on a vibration (or displacement) of the second vibration apparatus 333 may be increased (or enhanced). For example, the second sound generating part 330 or the second vibration member 331 may be configured to generate (or output) a sound (or a sound wave) of the low-pitched sound band (or a first pitched sound band).

According to an exemplary embodiment of the present disclosure, the air gap AG may include a first air gap AG1 between the first vibration member 311 and the third periphery portion PP3 adjacent to a first long side of the second vibration member 331, and a second air gap AG2 between the first vibration member 311 and the fourth periphery portion PP4 adjacent to a second long side of the second vibration member 331. For example, the first air gap AG1 may be between the first vibration member 311 and the other portion, except an arrangement portion of the coupling member 320, of the third periphery portion PP3 of the second vibration member 331. The second air gap AG2 may be between the first vibration member 311 and the other portion, except an arrangement portion of the coupling member 320, of the fourth periphery portion PP4 of the second vibration member 331.

The coupling member 320 according to an exemplary embodiment of the present disclosure may include a first coupling member 321 and a second coupling member 322.

The first coupling member 321 may be configured to couple the first vibration member 311 to a first periphery portion of the second vibration member 331 adjacent to a first short side of the second vibration member 331. For example, the first coupling member 321 may be disposed (or interposed) in a region between a first periphery portion (or a first rear periphery portion) PP1 of the second surface 331b of the second vibration member 331 and the first surface 311a of the first vibration member 311. For example, the first coupling member 321 may be disposed (or interposed) in an entire region between the first rear periphery portion PP1 of the second vibration member 331 and the first surface 311a of the first vibration member 311. For example, the first coupling member 321 may be disposed (or interposed) over the entire region (or without an air gap) between the first rear periphery portion PP1 of the second vibration member 331 and the first surface 311a of the first vibration member 311. Therefore, the entire first rear periphery portion PP1 of the second vibration member 331 may be coupled (or fixed) to the first surface 311a of the first vibration member 311 by the first coupling member 321. For example, the first coupling member 321 may be a first joint member, a first edge coupling member, a first edge joint member, a first fixing member, a first edge fixing member, a left edge coupling member, or a left edge fixing member, but embodiments of the present disclosure are not limited thereto.

The second coupling member 322 may be configured to couple the first vibration member 311 to a second periphery portion of the second vibration member 331 adjacent to a second short side of the second vibration member 331. For example, the second coupling member 322 may be disposed (or interposed) in a region between a second periphery portion (or a second rear periphery portion) PP2 of the second surface 331b of the second vibration member 331 and the first surface 311a of the first vibration member 311. For example, the second coupling member 322 may be disposed (or interposed) in an entire region between the second rear periphery portion PP2 of the second vibration member 331 and the first surface 311a of the first vibration member 311. For example, the second coupling member 322 may be disposed (or interposed) over the entire region (or without an air gap) between the second rear periphery portion PP2 of the second vibration member 331 and the first surface 311a of the first vibration member 311. Therefore, the entire second rear periphery portion PP2 of the second vibration member 331 may be coupled (or fixed) to the first surface 311a of the first vibration member 311 by the second coupling member 322. For example, the second coupling member 322 may be a second joint member, a second edge coupling member, a second edge joint member, a second fixing member, a second edge fixing member, a right edge coupling member, or a right edge fixing member, but embodiments of the present disclosure are not limited thereto.

The sound apparatus according to an exemplary embodiment of the present disclosure may further include a connection member 350. For example, the connection member 350 may be disposed along a rear periphery portion of the first sound generating part 310. Specifically, the connection member 350 may be disposed along a rear periphery portion of the first vibration member 311 of the first sound generating part 310.

The connection member 350 may be configured to enhance a sound characteristic and/or a sound pressure level characteristic of a middle-high pitched sound band generated in the first sound generating part 310. For example, the connection member 350 may be configured to enhance a sound characteristic and/or a sound pressure level characteristic of a middle-high pitched sound band generated based on a vibration of the first sound generating part 310 or the first vibration member 311. For example, the middle-pitched sound band may be a pitched sound band of 300 Hz or more, 400 Hz or more, or 500 Hz or more, and a high-pitched sound band may be a pitched sound band of 1 kHz or more, 2 kHz or more, or 3 kHz or more, but embodiments of the present disclosure are not limited thereto.

According to an embodiment of the preset disclosure, the connection member 350 may be configured to decrease or limit the amount of displacement (or bending force) or an amplitude of displacement (or vibration width) of the first sound generating part 310 (or the first vibration member 311). For example, when the first vibration member 311 vibrates (or displace) based on a vibration (or displacement) of the first vibration apparatus 313, the connection member 350 may be configured (or disposed) to restrain or limit a vibration of a periphery portion PP of the first sound generating part 310 (or the first vibration member 311) except a middle portion MP including a center of the first sound generating part 310 (or the first vibration member 311). For example, the connection member 350 may be configured (or disposed) to restrain or limit a vibration (or displacement) in a short-side length direction and a long-side length direction of the first sound generating part 310 (or the first vibration member 311), and thus, a sound characteristic and/or a sound pressure level characteristic of a middle-high pitched sound band generated based on a vibration of the first vibration member 311 based on a vibration (or displacement) of the first vibration apparatus 313 may be increased (or enhanced). Accordingly, the first sound generating part 310 (or the first vibration member 311) may be configured to generate (or output) a sound (or a sound wave) of a middle-high pitched sound band (or second pitched sound band).

The connection member 350 may be configured to have a size (or area) which is relatively smaller than that of the first sound generating part 310 (or the first vibration member 311), but embodiments of the present disclosure are not limited thereto. For example, a total size (or total area) of the connection member 350 may be configured to have a size (or area) which is relatively smaller than a total size (or total area) of the first sound generating part 310 (or the first vibration member 311), but embodiments of the present disclosure are not limited thereto.

The connection member 350 according to an exemplary embodiment of the present disclosure may be disposed at (or connected to) a portion of the first sound generating part 310 (or the first vibration member 311). For example, the connection member 350 may be disposed (or connected) along a periphery portion PP of the second surface 311b of the first vibration member 311. The connection member 350 may be disposed at (or connected to) the second surface 311b of the first vibration member 311 to overlap the coupling member 320. For example, the connection member 350 may be disposed at (or connected to) the periphery portion PP except the middle portion MP of the first vibration member 311. For example, the connection member 350 may be disposed at (or connected to) the second surface 311b of the first vibration member 311 not to overlap the first vibration apparatus 313 of the first sound generating part 310. For example, the connection member 350 may be configured to include a hollow portion overlapping the first vibration apparatus 313. For example, the connection member 350 may be configured to include a frame shape having a hole (or hollow portion) 3500 overlapping the first vibration apparatus 313, but embodiments of the present disclosure are not limited thereto.

The connection member 350 according to another exemplary embodiment of the present disclosure may include first to fourth connection members (or division connection member or partial connection member) respectively disposed at (or connected to) first to fourth periphery portions PP1 to PP4 in the second surface 311b of the first vibration apparatus 313. For example, in a case where the connection member 350 is configured with first to fourth connection members, the connection member 350 may be easily attached to or equipped in the first vibration member 311. For example, the connection member 350 may be a 4-side fixing structure material of the first vibration member 311. For example, the connection member 350 may be configured to have a 4-side fixing structure corresponding (or with respect) to the first vibration member 311. For example, the connection member 350 may be disposed at four sides of the first vibration member 311.

According to another exemplary embodiment of the present disclosure, the connection member 350 may be configured as a stiff material (or a hard material), but embodiments of the present disclosure are not limited thereto. The connection member 350 may have high elasticity (or a Young's modulus) and may include a material which is high in tensile strength. For example, the connection member 350 may be a rubber, but embodiments of the present disclosure are not limited thereto. For example, the rubber may be ethylene propylene rubber or urethane rubber, but embodiments of the present disclosure are not limited thereto. For example, the ethylene propylene rubber may be ethylene propylene diene monomer (EPDM), but embodiments of the present disclosure are not limited thereto. For example, a hardness of the EPDM may be 40 to 90, but embodiments of the present disclosure are not limited thereto. For example, a tensile strength of the EPDM may be 50 kg/cm² to 200 kg/cm², but embodiments of the present disclosure are not limited thereto.

According to an exemplary embodiment of the present disclosure, the connection member 350 may be protected by a release film (or a protection film). The release film may be attached to an adhesive surface of the connection member 350. In a case where the sound apparatus 30 including the connection member 350 is mounted on the vehicle interior material (or the mount object), the release film may be released (or removed) from the connection member 350.

The sound apparatus 30 according to an exemplary embodiment of the present disclosure may include the coupling member 320 which is partially disposed between the first sound generating part 310 and the second sound generating part 330, and thus, a sound characteristic and/or a sound pressure level characteristic of a low-pitched sound band may be increased (or enhanced). The sound apparatus 30 according to an exemplary embodiment of the present disclosure may further include the connection member 350 which is disposed at a rear periphery portion of the first sound generating part 310, and thus, a sound characteristic and/or a sound pressure level characteristic of a low-pitched sound band and a middle-high pitched sound band may be increased (or enhanced). In addition, the sound apparatus 30 according to an exemplary embodiment of the present disclosure may include the first sound generating part 310 and the second sound generating part 330 having a bimorph structure, and thus, a sound characteristic and/or a sound pressure level characteristic of a sound including the low-pitched sound band may be enhanced. Accordingly, the sound apparatus 30 according to an exemplary embodiment of the present disclosure may have a wide sound reproduction band, based on a stack structure of the first sound generating part 310 and the second sound generating part 330.

The sound apparatus 30 according to another exemplary embodiment of the present disclosure may be configured to output a sound, based on a vibration of one of the first sound generating part 310 and the second sound generating part 330. Depending on whether a sound having a relatively high sound pressure level in a middle-high pitched sound band or a low-pitched sound band is output, the sound apparatus 30 according to another exemplary embodiment of the present disclosure may be configured to output a sound, based on a vibration of one of the first sound generating part 310 and the second sound generating part 330. For example, in a case where an output of a sound having a relatively high sound pressure level in a middle-high pitched sound band is needed, the sound apparatus 30 may be configured to output a sound having an enhanced sound pressure level characteristic of a middle-high pitched sound band, based on a vibration of only the first sound generating part 310 of the first sound generating part 310 and the second sound generating part 330. For example, in a case where an output of a sound having a relatively high sound pressure level in a low-pitched sound band is needed, the sound apparatus 30 may be configured to output a sound having an enhanced sound pressure level characteristic of a low-pitched sound band, based on a vibration of only the second sound generating part 330 of the first sound generating part 310 and the second sound generating part 330.

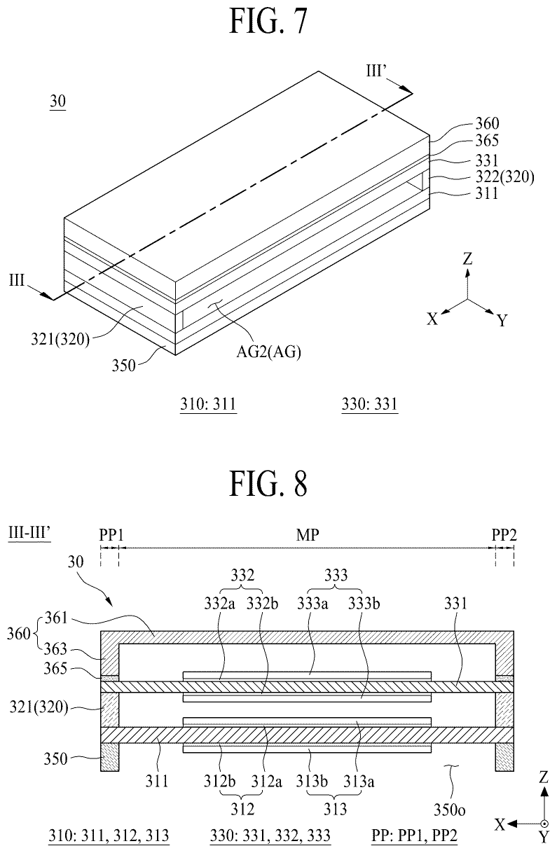

FIG. 7 is a perspective view illustrating a sound apparatus according to another exemplary embodiment of the present disclosure. FIG. 8 is a cross-sectional view taken along line III-III′ illustrated in FIG. 7 according to an exemplary embodiment of the present disclosure. For example, FIGS. 7 and 8 illustrate an embodiment where a cover is additionally configured in the sound apparatus 30 described above with reference to FIGS. 3 to 6. In the following description, therefore, the cover will be described in detail, the other elements may be a same as or substantially the same as that of descriptions described above with reference to FIGS. 3 to 6, and thus, like reference numerals refer to like elements and its repeated descriptions are omitted or will be briefly given below. Therefore, descriptions above with reference to FIGS. 3 to 6 may be included in descriptions of FIGS. 7 and 8.

With reference to FIGS. 7 and 8, the sound apparatus 30 according to another exemplary embodiment of the present disclosure may further include a cover 360.

The cover 360 may be configured to protect the second sound generating part 330. For example, the cover 360 may be configured to cover the second sound generating part 330. For example, the cover 360 may be configured to cover or surround the first surface of the second sound generating part 330. For example, the cover 360 may configure a closed space which covers or surrounds the first surface of the second sound generating part 330. For example, the cover 360 may be a front enclosure, a closed member (or a sealing member), a closed cap, a closed box, or a sound box, but embodiments of the present disclosure are not limited thereto.

The cover 360 may be configured to be connected or coupled to a periphery portion (or an edge portion) PP of the second vibration member 331 of the second sound generating part 330. For example, the cover 360 may be configured to have a same shape and a same size as that of the second vibration member 331, but embodiments of the present disclosure are not limited thereto. For example, the cover 360 may include a rectangular shape having a long side and a short side, but embodiments of the present disclosure are not limited thereto.

The cover 360 according to an exemplary embodiment of the present disclosure may include a cover plate 361 and a cover sidewall portion 363.

The cover plate 361 may be configured (or disposed) to be spaced apart from the second sound generating part 330. For example, the cover plate 361 may be configured (or disposed) to be spaced apart from the second vibration member 331 of the second sound generating part 330. The cover plate 361 may be configured (or disposed) to be spaced apart from the second vibration member 331 and the second vibration apparatus 333. The cover plate 361 may be configured (or disposed) to cover the second vibration member 331 and the second vibration apparatus 333. For example, the cover plate 361 may include a flat plate structure having a long side and a short side, but embodiments of the present disclosure are not limited thereto.

The cover sidewall portion 363 may be configured (or disposed) along a periphery portion (or an edge portion) PP of the cover plate 361. The cover sidewall portion 363 may be vertically connected to the periphery portion PP of the cover plate 361. For example, the cover sidewall portion 363 may be configured (or disposed) to surround a lateral surface of the second vibration apparatus 333.

The cover 360 according to an exemplary embodiment of the present disclosure may constantly maintain an impedance component based on air acting on the second vibration member 331 when the second sound generating part 330 or the second vibration member 331 is vibrating. For example, air around the second vibration member 331 may resist a vibration of the second vibration member 331 and may act as an impedance component having a reactance component and a resistance based on a frequency. Therefore, the cover 360 may configure a closed space which surrounds the third vibration generator 331, in a first surface 331a of the second vibration member 331, and thus, may maintain an impedance component (or an air impedance or an elastic impedance) acting on the second vibration member 331 based on air, thereby enhancing a sound characteristic and/or a sound pressure level characteristic of a low-pitched sound band and enhancing the quality of a sound of a high-pitched sound band.

The sound apparatus 30 according to another exemplary embodiment of the present disclosure may further include an attachment member (or a first attachment member) 365.

The attachment member 365 may be between the cover 360 and the second sound generating part 330. For example, the attachment member 365 may be between the cover sidewall portion 363 of the cover 360 and the second vibration member 331 of the second sound generating part 330, without being limited thereto. The attachment member 365 may be between the cover 360 and the second vibration member 331. For example, the attachment member 365 may be connected or coupled between the periphery portion PP of the cover 360 and a periphery portion (or an edge portion) PP of the first surface 331a of the second vibration member 331. For example, the attachment member 365 may be connected or coupled between the cover sidewall portion 363 of the cover 360 and the periphery portion PP of the first surface 331a of the second vibration member 331. For example, the cover sidewall portion 363 of the cover 360 may be connected or coupled to the periphery portion PP of the first surface 331a of the second vibration member 331 by the attachment member 365.

The attachment member 365 according to an exemplary embodiment of the present disclosure may be configured to minimize or reduce the transfer of a vibration of the second vibration member 331 to the cover 360 (or the cover sidewall portion 363). The attachment member 365 may include a material characteristic suitable for blocking the vibration. For example, the attachment member 365 may include a material having elasticity, but embodiments of the present disclosure are not limited thereto. For example, the attachment member 365 may include a material having elasticity for vibration absorption (or impact absorption), but embodiments of the present disclosure are not limited thereto.

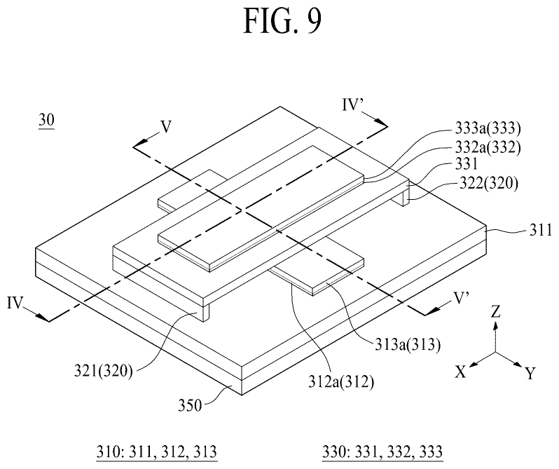

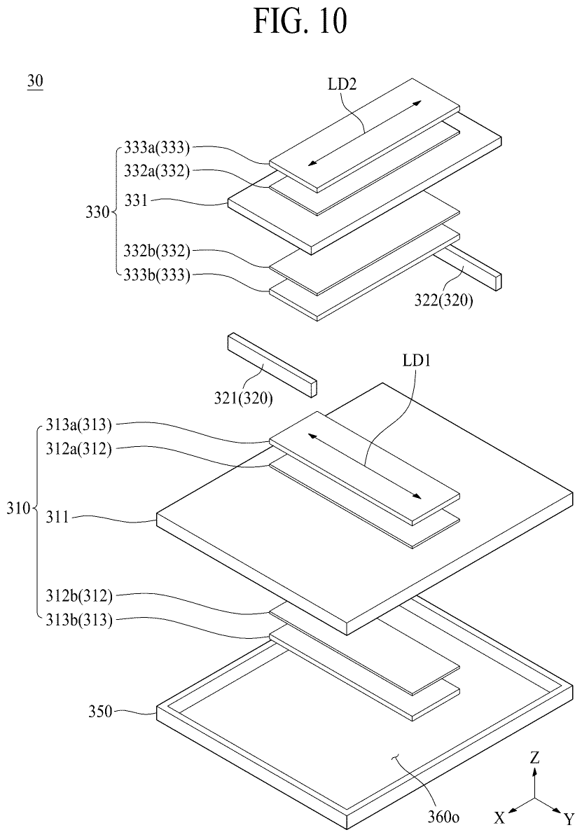

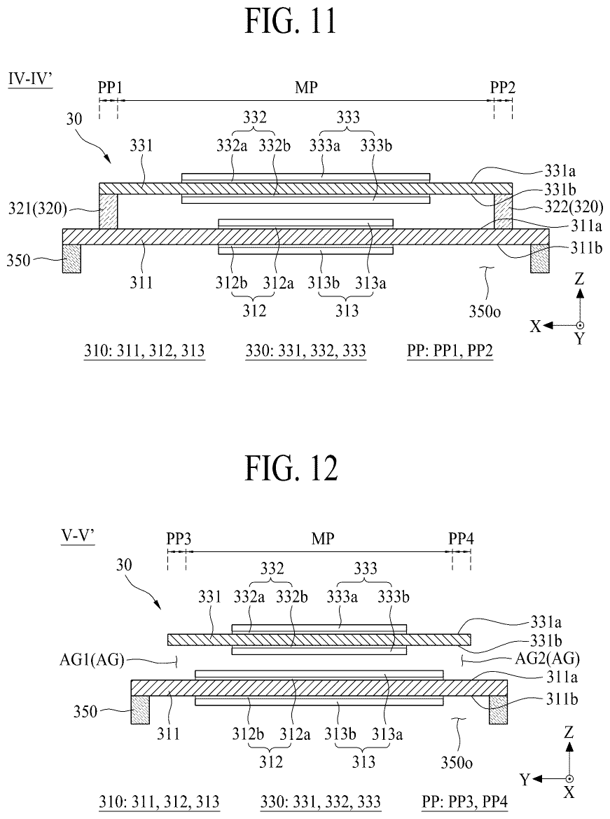

FIG. 9 is a perspective view illustrating a sound apparatus according to another exemplary embodiment of the present disclosure. FIG. 10 is an exploded perspective view of a sound apparatus according to another exemplary embodiment of the present disclosure. FIG. 11 is a cross-sectional view taken along line IV-IV′ illustrated in FIG. 9 according to an exemplary embodiment of the present disclosure. FIG. 12 is a cross-sectional view taken along line V-V′ illustrated in FIG. 9 according to an exemplary embodiment of the present disclosure. For example, FIGS. 9 to 12 illustrate an embodiment implemented by modifying the first sound generating part 310 in the sound apparatus 30 described above with reference to FIGS. 3 to 6. In the following description, therefore, the first sound generating part will be described in detail, the other elements may be a same as or substantially the same as that of descriptions described above with reference to FIGS. 3 to 6, and thus, like reference numerals refer to like elements and its repeated descriptions are omitted or will be briefly given below. Therefore, descriptions above with reference to FIGS. 3 to 6 may be included in descriptions of FIGS. 9 to 12.

With reference to FIGS. 9 to 12, in the sound apparatus 30 according to another exemplary embodiment of the present disclosure, the first sound generating part 310 may have a size which is greater than that of the second sound generating part 330, but embodiments of the present disclosure are not limited thereto. For example, the first sound generating part 310 may have a shape which differs from that of the second sound generating part 330 and may have a size which is greater than that of the second sound generating part 330, but embodiments of the present disclosure are not limited thereto. For example, the first sound generating part 310 may have a square shape which is greater than the second sound generating part 330, or may have a rectangular shape including a long side and a short side which are greater than those of the second sound generating part 330, but embodiments of the present disclosure are not limited thereto.

The first sound generating part 310 according to another exemplary embodiment of the present disclosure may include a first vibration member 311 and a first vibration apparatus 313. For example, the first vibration member 311 may generate a vibration or may output a sound (or a sound wave or a sound pressure level) based on the driving (or vibration or displacement) of the first vibration apparatus 313.

The first vibration member 311 may include a tetragonal shape, but embodiments of the present disclosure are not limited thereto. For example, the first vibration member 311 may include a rectangular shape including a long side and a short side which are greater than those of the second vibration member 331 of the second sound generating part 330, or may have a square shape which is greater than the second vibration member 331, but embodiments of the present disclosure are not limited thereto. For example, except for a shape and a size, the first vibration member 311 may be substantially the same as the first vibration member 311 described above with reference to FIGS. 3 to 6, and thus, its repeated descriptions are omitted.

The first vibration apparatus 313 may be configured to vibrate the first vibration member 311. The first vibration apparatus 313 may be disposed (or configured) in the first vibration member 311 along a direction which differs from the second vibration apparatus 333 of the second sound generating part 330. For example, except for that the first vibration apparatus 313 is disposed (or configured) in the first vibration member 311 along a direction which differs from the second vibration apparatus 333 of the second sound generating part 330, the first vibration apparatus 313 may be a same or substantially a same as that of the first vibration apparatus 313 described above with reference to FIGS. 3 to 6.

The first vibration apparatus 313 according to another exemplary embodiment of the present disclosure may be disposed (or configured) to enhance a sound characteristic and/or a sound pressure level characteristic of a middle-low pitched sound band generated in the sound apparatus 30. For example, a long-side length direction LD1 of the first vibration apparatus 313 may differ from a long-side length direction LD2 of the second vibration apparatus 333. For example, in the same plane, the long-side length direction LD1 of the first vibration apparatus 313 may rotate (or tilt) from the long-side length direction LD2 of the second vibration apparatus 333. For example, in the same plane, the long-side length direction LD1 of the first vibration apparatus 313 may rotate (or tilt) at an acute angle from the long-side length direction LD2 of the second vibration apparatus 333. For example, the long-side length direction LD1 of the first vibration apparatus 313 may intersect with the long-side length direction LD2 of the second vibration apparatus 333.

According to an exemplary embodiment of the present disclosure, an intersection angle between the long-side length direction LD1 of the first vibration apparatus 313 and the long-side length direction LD2 of the second vibration apparatus 333 may be an acute angle, but embodiments of the present disclosure are not limited thereto. For example, in the same plane, the intersection angle between the long-side length direction LD1 of the first vibration apparatus 313 and the long-side length direction LD2 of the second vibration apparatus 333 may be an acute angle, but embodiments of the present disclosure are not limited thereto.

In an embodiment of the present disclosure, the intersection angle between the long-side length direction LD1 of the first vibration apparatus 313 and the long-side length direction LD2 of the second vibration apparatus 333 may be, for example, without limitation, 90 degrees, but embodiments of the present disclosure are not limited thereto. For example, in the same plane, the intersection angle between the long-side length direction LD1 of the first vibration apparatus 313 and the long-side length direction LD2 of the second vibration apparatus 333 may be, for example, without limitation, 90 degrees, but embodiments of the present disclosure are not limited thereto.

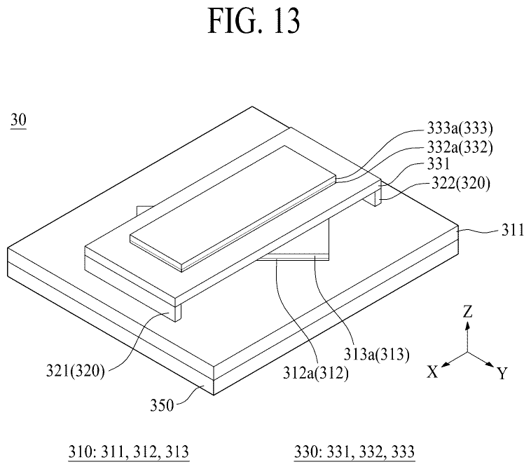

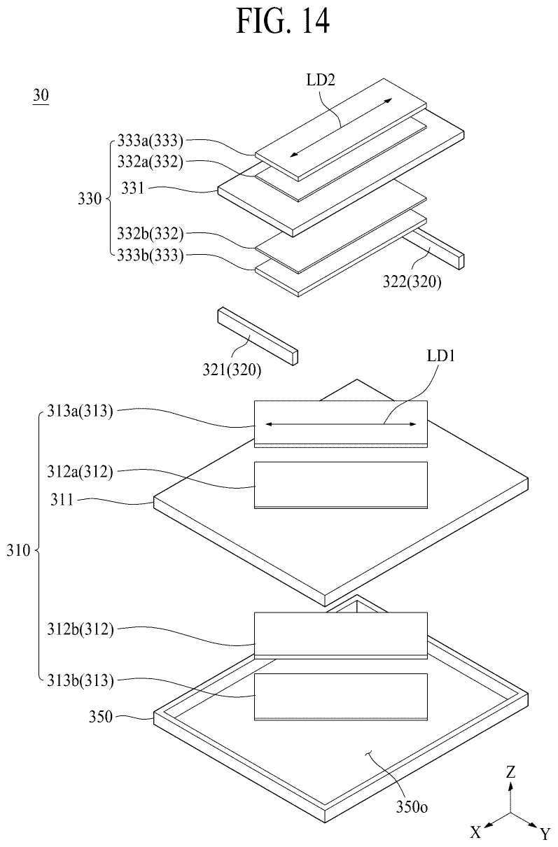

In another exemplary embodiment of the present disclosure, as illustrated in FIGS. 13 and 14, an angle between the long-side length direction LD1 of the first vibration apparatus 313 and the long-side length direction LD2 of the second vibration apparatus 333 may be, for example, without limitation, 45 degrees, but embodiments of the present disclosure are not limited thereto. For example, in the same plane, the angle between the long-side length direction LD1 of the first vibration apparatus 313 and the long-side length direction LD2 of the second vibration apparatus 333 may be, for example, without limitation, 45 degrees, but embodiments of the present disclosure are not limited thereto.

According to another exemplary embodiment of the present disclosure, because the first vibration apparatus 313 and the second vibration apparatus 333 are disposed (or configured) in different directions, a vibration area (or vibration magnitude) may increase compared to the sound apparatus 30 described above with reference to FIGS. 3 to 6, and thus, a sound characteristic and/or a sound pressure level characteristic of a middle-low pitched sound band generated in the sound apparatus 30 may be more enhanced (or increased).

The sound apparatus 30 described above with reference to FIGS. 9 to 14 may further include the cover 360 described above with reference to FIGS. 7 and 8, and thus, its repeated descriptions are omitted or briefly given. Therefore, descriptions of the cover 360 described above with reference to FIGS. 7 and 8 may be included in descriptions of the sound apparatus 30 illustrated in FIGS. 9 to 14.

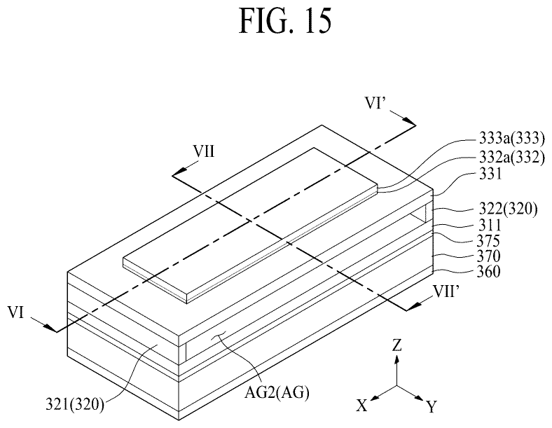

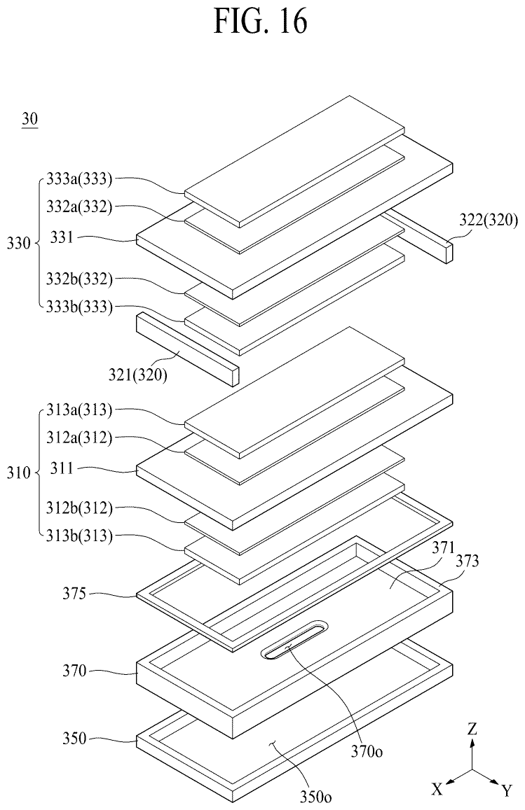

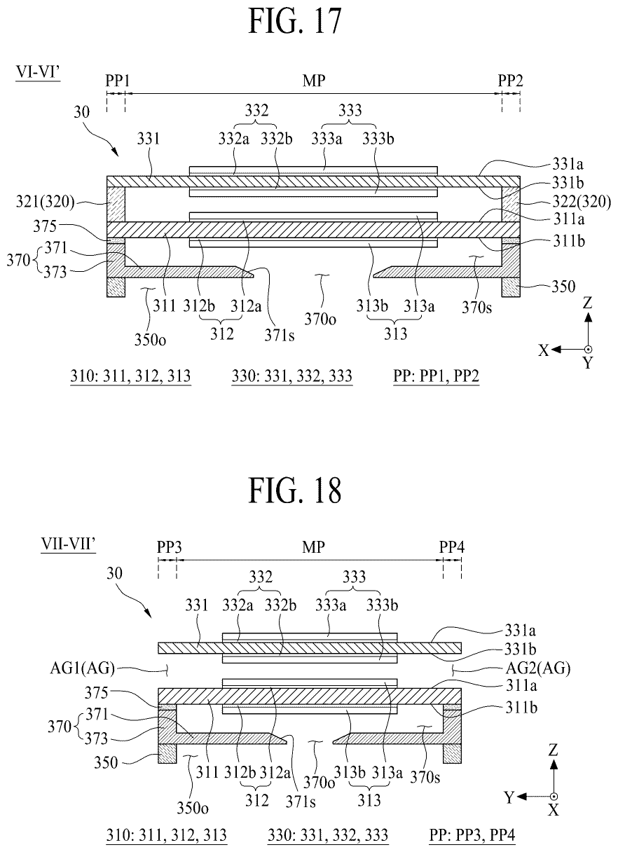

FIG. 15 is a perspective view illustrating a sound apparatus according to another exemplary embodiment of the present disclosure. FIG. 16 is an exploded perspective view of a sound apparatus according to another exemplary embodiment of the present disclosure. FIG. 17 is a cross-sectional view taken along line VI-VI′ illustrated in FIG. 15 according to an exemplary embodiment of the present disclosure. FIG. 18 is a cross-sectional view taken along line VII-VII′ illustrated in FIG. 15 according to an exemplary embodiment of the present disclosure. For example, FIGS. 15 to 18 illustrate an embodiment where an enclosure is additionally configured in the sound apparatus 30 described above with reference to FIGS. 3 to 6. In the following description, therefore, the enclosure will be described in detail, the other elements may be a same as or substantially the same as that of descriptions described above with reference to FIGS. 3 to 6, and thus, like reference numerals refer to like elements and its repeated descriptions are omitted or will be briefly given below. Therefore, descriptions above with reference to FIGS. 3 to 6 may be included in descriptions of FIGS. 15 to 18.

With reference to FIGS. 15 to 18, the sound apparatus 30 according to another exemplary embodiment of the present disclosure may further include an enclosure 370.

The enclosure 370 may be disposed at a periphery of the first sound generating part 310. The enclosure 370 may be configured (or disposed) at the second surface of the first sound generating part 310. The enclosure 370 may be configured to support the second surface of the first sound generating part 310. For example, the enclosure 370 may be configured to cover or surround the second surface of the first sound generating part 310. The enclosure 370 may be configured to cover or surround the periphery portion PP of the second surface of the first sound generating part 310. For example, the enclosure 370 may be configured to support the periphery portion PP of the first sound generating part 310, without being limited thereto. For example, the enclosure 370 may be configured to be connected or coupled to the periphery portion PP of the second surface of the first sound generating part 310.

The enclosure 370 may be configured to be connected or coupled to the first vibration member 311 of the first sound generating part 310. For example, the enclosure 370 may be configured to be connected or coupled to the periphery portion PP of the first vibration member 311. For example, the enclosure 370 may be configured to be connected or coupled to the periphery portion PP of the second surface 311b of the first vibration member 311.

The enclosure 370 may be configured to include an internal space 370s. For example, the internal space 370s of the enclosure 370 may be provided between the second surface of the first sound generating part 310 and the enclosure 370. For example, the internal space 370s of the enclosure 370 may be provided between the second surface 311b of the first vibration member 311 and the enclosure 370. For example, the internal space 370s of the enclosure 370 may be provided to surround the first vibration apparatus 313. For example, the first sound generating part 310 or the first vibration member 311 may be disposed to cover the internal space 370s of the enclosure 370.

The enclosure 370 may include a rectangular shape having a long side and a short side, but embodiments of the present disclosure are not limited thereto. For example, the enclosure 370 may have a same shape and a same size as that of the first sound generating part 310 or the first vibration member 311, but embodiments of the present disclosure are not limited thereto. For example, the enclosure 370 may be a supporting member, a case, a supporting case, a case member, a housing, a housing member, or a rear enclosure, but embodiments of the present disclosure are not limited thereto.

The enclosure 370 according to an exemplary embodiment of the present disclosure may include a plate 371 and a sidewall 373. The sidewall 373 may be connected to the plate 371 to form the internal space.

The plate 371 may be configured (or disposed) to be spaced apart from the first sound generating part 310. For example, the plate 371 may be configured (or disposed) to be spaced apart from the first vibration member 311 of the first sound generating part 310. Also, the may be configured (or disposed) to be spaced apart from the e first vibration apparatus 313 of the first sound generating part 310. The plate 371 may be configured (or disposed) to be spaced apart from the first vibration member 311 and the first vibration apparatus 313. The plate 371 may be configured (or disposed) to cover the first vibration member 311 and the first vibration apparatus 313. For example, the plate 371 may include a flat plate structure having a long side and a short side, but embodiments of the present disclosure are not limited thereto. For example, the plate 371 may be a base plate or a housing plate, but embodiments of the present disclosure are not limited thereto.

The sidewall 373 may be configured (or disposed) along a periphery portion (or an edge portion) PP of the plate 371. For example, the sidewall 373 may be vertically connected to the periphery portion PP of the plate 371. For example, the sidewall 373 may be configured (or disposed) to surround a lateral surface of the first vibration apparatus 313. The sidewall 373 according to an exemplary embodiment of the present disclosure may have a same width as that of the coupling member 320, with respect to a long-side length direction of the first vibration member 311, but embodiments of the present disclosure are not limited thereto. For example, the sidewall 373 may be a frame, a sidewall frame, a housing sidewall, or a housing sidewall frame, but embodiments of the present disclosure are not limited thereto.

The sidewall 373 may be configured (or disposed) to provide the internal space 370s between the first sound generating part 310 and the plate 371. For example, the sidewall 373 may be configured (or disposed) to provide the internal space 370s between the first vibration member 311 of the first sound generating part 310 and the plate 371. For example, the internal space 370s may be an accommodation space, a receiving space, a gap space, an air space, a vibration space, a sound space, a sound box, or a closed space (or a sealing space), or the like, but embodiments of the present disclosure are not limited thereto.

According to another exemplary embodiment of the present disclosure, the first sound generating part 310 may generate a sound (or sound pressure level or sound wave) in the internal space 370s of the enclosure 370. For example, the first vibration member 311 may generate a sound (or sound pressure level or sound wave) in the internal space 370s of the enclosure 370, based on driving (or vibration or displacement) of the first vibration apparatus 313. Accordingly, the enclosure 370 (or the plate 371 of the enclosure 370) may vibrate based on a sound (or sound pressure level or sound wave) generated in the internal space 370s to generate (or output) a sound (or sound pressure level or sound wave), based on a vibration of the first sound generating part 310 (or the first vibration member 311).

The sound apparatus 30 according to another exemplary embodiment of the present disclosure may further include a middle coupling member 375.

The middle coupling member 375 may be between the enclosure 370 and the first sound generating part 310. The middle coupling member 375 may be between the enclosure 370 and the first vibration member 311. For example, the middle coupling member 375 may be between the sidewall of the enclosure 370 and the first vibration member 311. For example, the middle coupling member 375 may be connected or coupled between a periphery portion (or an edge portion) PP of the enclosure 370 and the periphery portion PP of the second surface 311b of the first vibration member 311. For example, the middle coupling member 375 may be connected or coupled between the sidewall 373 of the enclosure 370 and the periphery portion PP of the second surface 311b of the first vibration member 311. For example, the sidewall 373 of the enclosure 370 may be connected or coupled to the periphery portion PP of the second surface 311b of the first vibration member 311 by the middle coupling member 375. For example, the middle coupling member 375 may be a second attachment member, a second connection member, a middle attachment member, or a middle connection member, but embodiments of the present disclosure are not limited thereto.

The middle coupling member 375 according to an exemplary embodiment of the present disclosure may transfer a vibration of the first sound generating part 310 or the first vibration member 311 to the enclosure 370. Therefore, the enclosure 370 may additionally vibrate based on the vibration of the first sound generating part 310 or the first vibration member 311 transferred through the middle coupling member 375 to generate a sound (or sound pressure level or sound wave). For example, the plate 371 of the enclosure 370 may vibrate based on a sound (or sound pressure level or sound wave) generated in the internal space 370s by a vibration of the first vibration member 311 and a vibration transferred through the middle coupling member 375 to generate (or output) a sound (or sound pressure level or sound wave).

The middle coupling member 375 may be configured in a relatively stiff material (or a hard material), but embodiments of the present disclosure are not limited thereto. For example, when the middle coupling member 375 is configured in the relatively stiff material (or the hard material), the vibration of the first sound generating part 310 or the first vibration member 311 may be transmitted to the enclosure 370 more efficiently.

The middle coupling member 375 according to an exemplary embodiment of the present disclosure may have high elasticity (or a Young's modulus) and may include a material which is high in tensile strength, but embodiments of the present disclosure are not limited thereto. For example, the middle coupling member 375 may be rubber, but embodiments of the present disclosure are not limited thereto. For example, the rubber may be ethylene propylene rubber or urethane rubber, but embodiments of the present disclosure are not limited thereto. For example, the ethylene propylene rubber may be ethylene propylene diene monomer (EPDM), but embodiments of the present disclosure are not limited thereto. For example, a hardness of the EPDM may be 40 to 90, but embodiments of the present disclosure are not limited thereto. For example, a tensile strength of the EPDM may be 50 kg/cm² to 200 kg/cm², but embodiments of the present disclosure are not limited thereto.

In the sound apparatus 30 according to another exemplary embodiment of the present disclosure, the connection member 350 may be disposed (or interposed) or configured in the enclosure 370 (or the plate 371 of the enclosure 370). For example, the enclosure 370 may be disposed (or interposed) or configured between the first sound generating part 310 and the connection member 350. For example, the connection member 350 may be disposed (or interposed) or configured along a rear periphery portion (or a rear edge portion) PP of the plate 371. For example, the connection member 350 may be connected or coupled to the rear periphery portion PP of the plate 371. The connection member 350 may be configured to include a frame shape having a hole (or hollow portion) 3500 overlapping the first vibration apparatus 313, but embodiments of the present disclosure are not limited thereto. For example, except for that the connection member 350 is disposed (or interposed) in or connected to the enclosure 370 (or the plate 371 of the enclosure 370), the connection member 350 may be a same as or substantially a same as that of the connection member 350 described above with reference to FIGS. 3 to 7, and thus, its repeated descriptions are omitted.

The sound apparatus 30 or the enclosure 370 according to an exemplary embodiment of the present disclosure may further include an opening part 3700. As one example, the opening part 3700 may be connected to the internal space 370s and overlapping the first vibration apparatus 313.

The opening part 3700 may be configured at the enclosure 370 to overlap the first vibration apparatus 313 of the first sound generating part 310. The opening part 3700 may be configured at the plate 371 of the enclosure 370 to overlap the first vibration apparatus 313 with respect to a thickness direction Z (or a vertical direction) of the sound apparatus 30. The opening part 3700 may be configured to pass through (or vertically pass through) the plate 371 along the thickness direction Z (or vertical direction) of the enclosure 370. For example, the opening part 3700 may face or directly face the first surface of the first sound generating part 310 or the first vibration apparatus 313. In the enclosure 370, the opening part 3700 may be connected to (or communicated with) the internal space 370s.

The opening part 3700 may be configured to decrease an air pressure of the internal space 370s of the enclosure 370. For example, the opening part 3700 may be configured to decrease an air pressure of the internal space 370s provided between the first vibration member 311 and the enclosure 370. Therefore, a band of the low-pitched sound band may be expanded, and thus, a sound characteristic of the low-pitched sound band may be improved. For example, because a pressure (or air pressure) of the internal space 370s of the enclosure 370 is reduced by the opening part 3700, the amount of displacement (or a bending force) of the first vibration member 311 may increase, and thus, a band of the low-pitched sound band may be expanded, thereby enhancing a sound characteristic and/or a sound pressure level characteristic of the low-pitched sound band. Accordingly, a sound (or a sound pressure level) of the low-pitched sound band generated by the vibration (or displacement) of the first vibration member 311 based on the driving (or vibration or displacement) of the first vibration apparatus 313 may be more improved.

According to an exemplary embodiment of the present disclosure, the opening part 3700 may be disposed to correspond to a center portion of the first sound generating part 310. For example, the opening part 3700 may be disposed to correspond to a center portion of the first vibration apparatus 313. For example, the opening part 3700 may include a short axis and a long axis. For example, the opening part 3700 may include a line shape passing through the center portion of the first sound generating part 310 (or the first vibration apparatus 313) or may include a rectangular shape, but embodiments of the present disclosure are not limited thereto. For example, the opening part 3700 may include a line shape passing through the center portion of the first vibration apparatus 313 of the first sound generating part 310, without being limited thereto. For example, the opening part 3700 may include a width (or a short-axis length) parallel to a short-side length direction (or a second direction Y) of the enclosure 370 and a length (or a long-axis length) parallel to a long-side length direction (or a first direction X) of the enclosure 370. For example, the length of the opening part 3700 may be smaller than a length (or a long-side length) of the first vibration apparatus 313, but embodiments of the present disclosure are not limited thereto. For example, the opening part 3700 may be a hole, a slot, or a slit, but embodiments of the present disclosure are not limited thereto. For example, the opening part 3700 may be a sound emission part, a sound emission port, a sound output part, a sound output port, a sound output hole, a duct hole, or a vent hole, but embodiments of the present disclosure are not limited thereto.

The opening part 3700 may be a space where a sound (or a sound wave) generated in the internal space 370s of the enclosure 370 based on a vibration of the first sound generating part 310 is output to an external space of the enclosure 370, for example, the interior space of the vehicle. For example, a vibration or a sound generated by vibration (or displacement) of the first vibration member 311 based on the vibration of the first sound generating part 310 may be output (or emitted) into the interior space of the vehicle through the opening part 3700.

The enclosure 370 may further include a slope surface (or an inclined surface) 371s. The slope surface 371s may be configured to be inclined between the opening part 3700 and an inner lateral surface (or an inner bottom surface) of the enclosure 370 (or the plate 371). The slope surface 371s may be configured to guide the output of a sound generated based on the vibration of the first sound generating part 310. For example, the sound generated based on the vibration of the first sound generating part 310 may be output to the interior space of the vehicle, and thus, a sound characteristic and/or a sound pressure level characteristic of a sound including a low-pitched sound band may be more enhanced. For example, the slope surface 371s may be a guide surface or a sound guide surface, but embodiments of the present disclosure are not limited thereto.

The sound apparatus 30 described above with reference to FIGS. 15 to 18 may further include the cover 360 described above with reference to FIGS. 7 and 8, and thus, its repeated descriptions are omitted or briefly given. Therefore, descriptions of the cover 360 described above with reference to FIGS. 7 and 8 may be included in descriptions of the sound apparatus 30 illustrated in FIGS. 15 to 18.

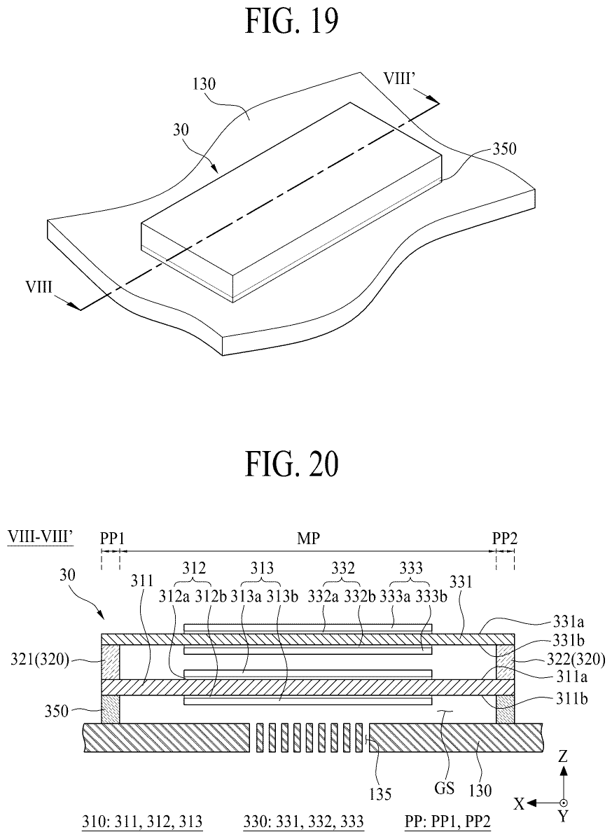

FIG. 19 is a diagram illustrating a sound apparatus according to another exemplary embodiment of the present disclosure. FIG. 20 is a cross-sectional view taken along line VIII-VIII′ illustrated in FIG. 19 according to an exemplary embodiment of the present disclosure.

With reference to FIGS. 19 and 20, the sound apparatus 30 according to another exemplary embodiment of the present disclosure may be connected or coupled to (or mounted on) the vehicle interior material (or mount object) 130 by using a connection member 350.

The sound apparatus 30 may include a first sound generating part 310, a second sound generating part 330, and a coupling member 320. The descriptions of the first sound generating part 310, the second sound generating part 330, and the coupling member 320 may be substantially a same as that of the descriptions described above with reference to FIGS. 3 to 6, and thus, like reference numerals refer to like elements and its repeated descriptions are omitted or will be briefly given below.

The vehicle interior material 130 may be connected or coupled to a connection member 350 in the sound apparatus 30. For example, the vehicle interior material 130 may be connected or coupled to the enclosure 370 by the connection member 350. The connection member 350 may be disposed between the vehicle interior material 130 and the first sound generating part 310. For example, the connection member 350 may be disposed between the first vibration member 311 of the first sound generating part 310 and the vehicle interior material 130.

According to an exemplary embodiment of the present disclosure, the vehicle interior material 130 may further include one or more holes 135. As one example, the one or more holes 135 may be disposed in the vehicle interior material 130, without being limited thereto.

The one or more holes 135 may correspond to (or overlap) the first vibration apparatus 313 of the first sound generating part 310. For example, the one or more holes 135 may be a through hole, an opening part, an opening hole, a slit, a slot, a sound hole, a sound emission hole, or a sound output hole, but embodiments of the present disclosure are not limited thereto.

According to an exemplary embodiment of the present disclosure, a sound based on a vibration of the first sound generating part 310 and the second sound generating part 330 may be output to an interior space of a vehicle through the vehicle interior material 130. For example, a sound based on a vibration of the first sound generating part 310 and the second sound generating part 330 may be output to an interior space of a vehicle through the one or more holes 135 disposed in the vehicle interior material 130.

The connection member 350 may provide a gap space GS between the vehicle interior material 130 and the first sound generating part 310 (or a middle portion MP of the first vibration apparatus 313). The vehicle interior material 130 may be connected or coupled to the connection member 350 and may be spaced apart from the first sound generating part 310 (or the first vibration apparatus 313). For example, the one or more holes 135 in the vehicle interior material 130 may be spaced apart from a rear surface of the first sound generating part 310 (or the first vibration apparatus 313). For example, the rear surface of the first sound generating part 310 (or the first vibration apparatus 313) may face or directly face the vehicle interior material 130 with the gap space GS therebetween.

According to an exemplary embodiment of the present disclosure, the connection member 350 is configured in a relatively stiff material (or a hard material), and thus, may transfer a vibration of the first sound generating part 310 and the second sound generating part 330 to the vehicle interior material 130. For example, a vibration of the second vibration member 331 based on a vibration of the second vibration apparatus 333 of the second sound generating part 330 may be transferred to the vehicle interior 130 through the coupling member 320, the first vibration member 311 of the first sound generating part 310, and the connection member 350, and a vibration of the first vibration member 311 based on a vibration of the first vibration apparatus 313 of the first sound generating part 310 may be transferred to the vehicle interior 130 through the connection member 350. Accordingly, the vehicle interior material 130 may vibrate based on the vibration transferred through the connection member 350 to generate a sound. For example, when the connection member 350 is configured in the relatively stiff material (or the hard material), the vehicle interior material 130 connected to the connection member 350 may be a vibration plate for generating (or outputting) a sound. For example, when the connection member 350 is configured in the relatively stiff material (or the hard material), the vibration of the first vibration member 311 and the vibration of the second vibration member 331 may be transferred to the vehicle interior material 130 more efficiently.

The sound apparatus 30 according to another exemplary embodiment of the present disclosure may output a sound (or sound wave), generated based on a vibration of each of the first sound generating part 310 and the second sound generating part 330 stacked, to the interior space of the vehicle through the one or more holes 135 in a vehicular interior material 130, and simultaneously, a sound generated by a vibration of the vehicular interior material 130 based on the vibration of each of the first sound generating part 310 and the second sound generating part 330 stacked may be output to the interior space of the vehicle. Accordingly, the sound apparatus 30 according to another exemplary embodiment of the present disclosure may have a wide sound reproduction band, based on a stack structure of the first sound generating part 310 and the second sound generating part 330.

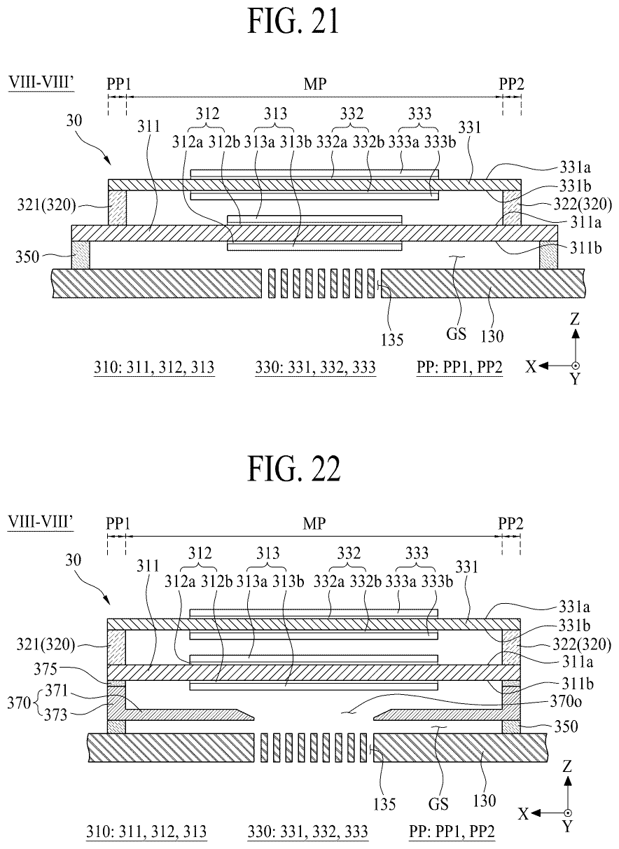

The sound apparatus 30 described above with reference to FIGS. 19 and 20 may be replaced with (or modified into) the sound apparatus 30 described above with reference to FIGS. 9 to 14, as illustrated in FIG. 21, and thus, its repeated descriptions are omitted or briefly given. For example, with reference to FIG. 21, the sound apparatus 30 described above with reference to FIGS. 9 to 14 may be connected or coupled to (or mounted on) the vehicle interior material (or mount object) 130 by using the connection member 350, and thus, its repeated descriptions are omitted.

The sound apparatus 30 described above with reference to FIGS. 19 and 20 may be replaced with (or modified into) the sound apparatus 30 described above with reference to FIGS. 15 to 18, as illustrated in FIG. 22, and thus, its repeated descriptions are omitted or briefly given.

With reference to FIG. 22, the sound apparatus 30 described above with reference to FIGS. 15 to 18 may be connected or coupled to (or mounted on) the vehicle interior material (or mount object) 130 by using the connection member 350, and thus, its repeated descriptions are omitted or briefly given.

The one or more holes 135 in the vehicle interior material 130 may correspond to (or overlap) the opening part 3700 of the enclosure 370. For example, the one or more holes 135 may have a size which is greater than or equal to the opening part 3700, but embodiments of the present disclosure are not limited thereto. For example, the one or more holes 135 may be a through hole, an opening part, an opening hole, a slit, a slot, a sound hole, a sound emission hole, or a sound output hole, but embodiments of the present disclosure are not limited thereto.

The sound apparatus 30 according to another exemplary embodiment of the present disclosure may output a sound (or sound wave), generated in the internal space 370s of the enclosure 370 based on a vibration of each of the first sound generating part 310 and the second sound generating part 330 stacked, to the interior space of the vehicle through the opening portion 3700 of the enclosure 370 and the one or more holes 135 of the vehicular interior material 130, and simultaneously, a sound generated based on a vibration of the vehicular interior material 130 based on a vibration of each of the first sound generating part 310 and the second sound generating part 330 stacked and a vibration of the enclosure 370 may be output to the interior space of the vehicle. Accordingly, the sound apparatus 30 according to another exemplary embodiment of the present disclosure may have a wide sound reproduction band, based on a stack structure of the first sound generating part 310 and the second sound generating part 330.

The sound apparatus 30 described above with reference to FIGS. 19 to 22 may further include the cover 360 described above with reference to FIGS. 7 and 8, and thus, its repeated descriptions are omitted or briefly given. Therefore, descriptions of the cover 360 described above with reference to FIGS. 7 and 8 may be included in descriptions of the sound apparatus 30 illustrated in FIGS. 19 to 22.

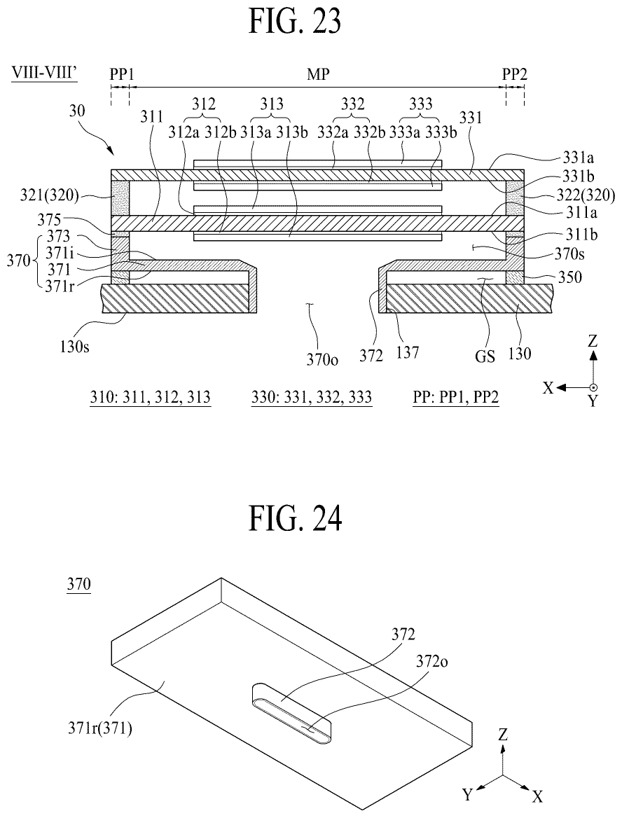

FIG. 23 is a cross-sectional view illustrating a sound apparatus according to another exemplary embodiment of the present disclosure. FIG. 24 is a perspective view illustrating an enclosure illustrated in FIG. 23 according to an exemplary embodiment of the present disclosure. FIGS. 23 and 24 illustrate an embodiment where a protrusion part is additionally configured in the enclosure of the sound apparatus 30 described above with reference to FIG. 22.

With reference to FIGS. 23 and 24, the sound apparatus 30 according to another exemplary embodiment of the present disclosure may include a first sound generating part 310, a second sound generating part 330, a coupling member 320, an enclosure 370, and a connection member 350. The descriptions of the first sound generating part 310, the second sound generating part 330, the coupling member 320, the enclosure 370, and the connection member 350 may be substantially a same as that of the descriptions described above with reference to FIGS. 15 to 18, and thus, like reference numerals refer to like elements and its repeated descriptions are omitted or will be briefly given below.

The sound apparatus 30 or the enclosure 370 may be connected or coupled to the vehicular interior material 130 by the connection member 350. The connection member 350 may provide a gap space GS between a center portion of the sound apparatus 30 (or the enclosure 370) and the vehicular interior material 130. The vehicular interior material 130 may be connected or coupled to the connection member 350 and may be spaced apart from the center portion of the sound apparatus 30 (or the enclosure 370). For example, a rear center portion of the sound apparatus 30 (or the enclosure 370) may face or directly face the vehicular interior material 130 with the gap space GS therebetween.

The vehicle interior material 130 may include a first surface and a second surface different from (or opposite to) the first surface. The first surface may be a surface facing the enclosure 370. The vehicle interior material 130 may further include a hole 137. The vehicle interior material 130 may further include a hole 137 configured at the first surface and the second surface. For example, the hole 137 of the vehicle interior material 130 may be configured to pass through the first surface and the second surface.

The hole 137 passing through the first surface and the second surface may correspond to (or overlap) the opening part 3700 of the enclosure 370. For example, the hole 137 may have a size which is greater than or equal to the opening part 3700, but embodiments of the present disclosure are not limited thereto. For example, the hole 137 may be a through hole, an opening part, an opening hole, a slit, a slot, a sound hole, a sound emission hole, or a sound output hole, but embodiments of the present disclosure are not limited thereto.

According to an exemplary embodiment of the present disclosure, the vehicle interior material 130 may vibrate based on a vibration of the enclosure 370 transferred through the connection member 350 to output a sound toward an interior space of a vehicle. For example, the vehicle interior material 130 may vibrate based on the vibration of the enclosure 370 by a vibration of the first sound generating part 310 and the second sound generating part 330 transferred through the connection member 350 to output a sound toward an interior space of a vehicle.

The sound apparatus 30 may output a sound (or sound wave), generated in the internal space 370s of the enclosure 370 based on a vibration of the first sound generating part 310 and the second sound generating part 330, to the interior space of the vehicle through the opening portion 3700 of the enclosure 370 and the hole 137, without being limited thereto.

The sound apparatus 30 or the enclosure 370 according to another exemplary embodiment of the present disclosure may further include a protrusion part 372. The enclosure 370 may further include a protrusion part 372.

The protrusion part 372 may surround the opening part 3700 of the enclosure 370. For example, the protrusion part 372 may be configured to surround the opening part 3700. The protrusion part 372 may include an opening hole (or a hollow hole) 3720 corresponding (or connected) to the opening part 3700.

The protrusion part 372 may protrude from a rear surface (or an outer surface) 371r of the enclosure 370 to have the opening hole 3720. The protrusion part 372 may protrude from a rear surface (or outer surface) 371r of the plate 371 of the enclosure 370 to surround the opening part 3700. For example, the protrusion part 372 may protrude from the rear surface (or outer surface) 371r of the enclosure 370 (or the plate 371) to have the opening hole 3720.

A portion (or end portion) of the protrusion part 372 may be accommodated or inserted into the hole 137 of the vehicle interior material 130. For example, the hole 137 of the vehicle interior material 130 may accommodate the portion (or end portion) of the protrusion part 372. Accordingly, a sound based on a vibration of the first sound generating part 310 and the second sound generating part 330 may be output to the interior space of the vehicle through the hole 137 of the vehicle interior material 130 and the opening hole 3720 of the protrusion part 372.

The sound apparatus 30 may output a sound (or sound wave), generated in the internal space 370s of the enclosure 370 based on a vibration of the first sound generating part 310 and the second sound generating part 330, to the interior space of the vehicle through the hole 137 of the vehicle interior material 130 and the opening hole 3720 of the protrusion part 372, without being limited thereto.

The sound apparatus 30 according to another exemplary embodiment of the present disclosure may further include a coupling part. The coupling part may be configured to fix the enclosure 370 mounted on the vehicle interior material 130. The vehicle interior material 130 may be disposed (or interposed) between the enclosure 370 (or the sound apparatus 30) and coupling part. For example, the coupling part may be connected (or coupled) or fastened to the protrusion part 372 (or the enclosure 370 or the sound apparatus 30) through the hole 137 of the vehicle interior material 130 at the interior space of the vehicle. For example, the coupling part may be connected (or coupled) or fastened to the protrusion part 372 (or the enclosure 370 or the sound apparatus 30) by a hook coupling scheme.

According to an exemplary embodiment of the present disclosure, the enclosure 370 may include the protrusion part 372, and thus, the coupling part 500 may be easily connected or coupled to the protrusion part 372. Accordingly, a connection process or a coupling process between the vehicle interior material 130 and the sound apparatus 30 may be simplified.

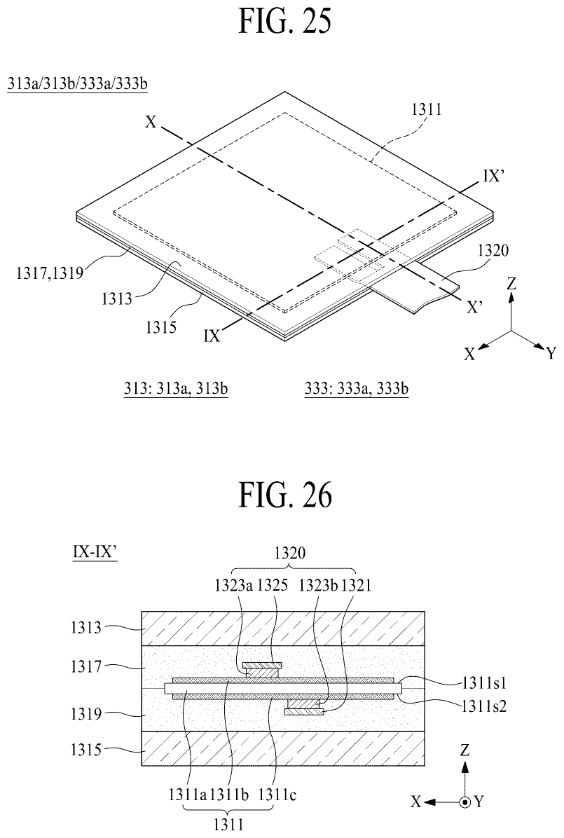

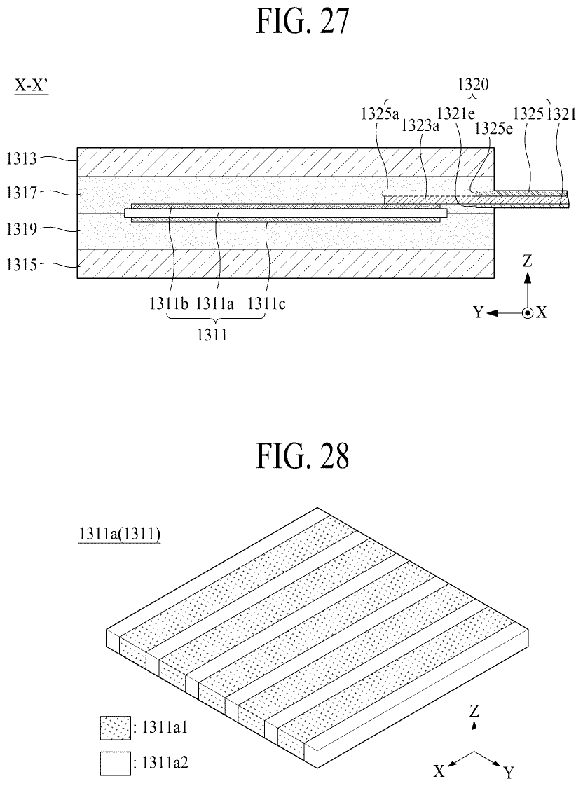

FIG. 25 is a diagram illustrating a vibration generator of a vibration apparatus according to an exemplary embodiment of the present disclosure. FIG. 26 is a cross-sectional view taken along line IX-IX′ illustrated in FIG. 25 according to an exemplary embodiment of the present disclosure. FIG. 27 is a cross-sectional view taken along line X-X′ illustrated in FIG. 25 according to an exemplary embodiment of the present disclosure.

With reference to FIGS. 25 to 27, in a sound apparatus 30 according to an exemplary embodiment of the present disclosure, each of the first and second vibration generators 313a and 313b of the first vibration apparatus 313 and each of the third and fourth vibration generators 333a and 333b of the second vibration apparatus 333 may include a piezoelectric material having piezoelectric characteristics, without being limited thereto.

Each of the first to fourth vibration generators 313a, 313b, 333a, and 333b may be configured as a ceramic-based piezoelectric material capable of implementing a relatively strong vibration, or may be configured as a piezoelectric ceramic having a perovskite-based crystal structure, but embodiments of the present disclosure are not limited thereto. For example, each of the first to fourth vibration generators 313a, 313b, 333a, and 333b may be a vibration generating device, a vibration film, a vibration generating film, an active vibration generator, an actuator, an exciter, a film actuator, a film exciter, an ultrasonic actuator, or an active vibration member, or the like, but embodiments of the present disclosure are not limited thereto.

Each of the first to fourth vibration generators 313a, 313b, 333a, and 333b according to an exemplary embodiment of the present disclosure may include a vibration generating part 1311.

The vibration generating part 1311 may be configured to vibrate by the piezoelectric effect based on a driving signal. For example, the vibration generating part 1311 may include a piezoelectric type vibration part. The vibration generating part 1311 may include at least one or more of a piezoelectric inorganic material and a piezoelectric organic material. For example, the vibration generating part 1311 may be a vibration device, a piezoelectric device, a piezoelectric device part, a piezoelectric device layer, a piezoelectric structure, a piezoelectric vibration part, or a piezoelectric vibration layer, or the like, but embodiments of the present disclosure are not limited thereto.

The vibration generating part 1311 according to an exemplary embodiment of the present disclosure may include a vibration part 1311a, a first electrode part 1311b, and a second electrode part 1311c.

The vibration part 1311a may include a piezoelectric material or an electroactive material which includes a piezoelectric effect. For example, the vibration part 1311a may be a piezoelectric layer, a piezoelectric material layer, an electroactive layer, a piezoelectric composite layer, a piezoelectric composite, or a piezoelectric ceramic composite, or the like, but embodiments of the present disclosure are not limited thereto.

The vibration part 1311a may be configured as a ceramic-based material capable of implementing a relatively strong vibration, or may be configured as a piezoelectric ceramic having a perovskite-based crystalline structure. For example, the vibration part 1311a may include at least one or more of lead titanate (PbTiO₃), lead zirconate (PbZrO₃), lead zirconate titanate (PbZrTiO₃), barium titanate (BaTiO₃), and strontium titanate (SrTiO₃), but embodiments of the present disclosure are not limited thereto.

The piezoelectric ceramic may be configured as a single crystalline ceramic having a crystalline structure, or may be configured as a ceramic material having a polycrystalline structure or polycrystalline ceramic. A piezoelectric material including the single crystalline ceramic may include α-AlPO₄, α-SiO₂, LiNbO₃, Tb₂ (MoO₄)₃, Li₂B₄O₇, or ZnO, but embodiments of the present disclosure are not limited thereto. A piezoelectric material including the polycrystalline ceramic may include a lead zirconate titanate (PZT)-based material, including lead (Pb), zirconium (Zr), and titanium (Ti), or may include a lead zirconate nickel niobate (PZNN)-based material, including lead (Pb), zirconium (Zr), nickel (Ni), and niobium (Nb), but embodiments of the present disclosure are not limited thereto. For example, the vibration part 1311a may include at least one or more of calcium titanate (CaTiO₃), BaTiO₃, and SrTiO₃, without lead (Pb), but embodiments of the present disclosure are not limited thereto.

The first electrode part 1311b may be disposed at a first surface (or an upper surface or a front surface) 1311s1 of the vibration part 1311a. The first electrode part 1311b may have a same size as that of the vibration part 1311a, or may have a size which is smaller than that of the vibration part 1311a, but embodiments of the present disclosure are not limited thereto. For example, the first electrode part 1311b may have a same shape as that of the vibration part 1311a, but embodiments of the present disclosure are not limited thereto.

The second electrode part 1311c may be disposed at a second surface (or a lower surface or a rear surface) 1311s2 which is opposite to or different from the first surface 1311s1 of the vibration part 1311a. The second electrode part 1311c may have a same size as that of the vibration part 1311a, or may have a size which is smaller than that of the vibration part 1311a, but embodiments of the present disclosure are not limited thereto. For example, the second electrode part 1311c may have a same shape as that of the vibration part 1311a, but embodiments of the present disclosure are not limited thereto.

One or more of the first electrode part 1311b and the second electrode part 1311c according to an exemplary embodiment of the present disclosure may be formed of a transparent conductive material, a semitransparent conductive material, or an opaque conductive material. For example, the transparent conductive material or the semitransparent conductive material may include indium tin oxide (ITO) or indium zinc oxide (IZO), but embodiments of the present disclosure are not limited thereto. The opaque conductive material may include gold (Au), silver (Ag), platinum (Pt), palladium (Pd), molybdenum (Mo), magnesium (Mg), carbon, or silver (Ag) including glass frit, or the like, or may be made of an alloy thereof, but embodiments of the present disclosure are not limited thereto. For example, in order to enhance an electrical characteristic and/or a vibration characteristic of the vibration part 1311a, each of the first electrode part 1311b and the second electrode part 1311c may include silver (Ag) having a low resistivity, but embodiments of the present disclosure are not limited thereto. For example, the carbon may include one or more of carbon black, ketjen black, carbon nanotube, and a carbon material including graphite, but embodiments of the present disclosure are not limited thereto.

The vibration part 1311a may be polarized (or poling) by a certain voltage applied to the first electrode part 1311b and the second electrode part 1311c in a certain temperature atmosphere, or a temperature atmosphere that may be changed from a high temperature to a room temperature, but embodiments of the present disclosure are not limited thereto. For example, a polarization direction (or a poling direction) formed in the vibration part 1311a may be formed or aligned (or arranged) from the first electrode part 1311b to the second electrode part 1311c, but embodiments of the present disclosure are not limited thereto. For example, the polarization direction (or the poling direction) formed in the vibration part 1311a may be formed or aligned (or arranged) from the second electrode part 1311c to the first electrode part 1311b.

The vibration part 1311a may alternately and repeatedly contract and/or expand by an inverse piezoelectric effect based on a driving signal applied to the first electrode part 1311b and the second electrode part 1311c from the outside to vibrate. For example, the vibration part 1311a may vibrate in a vertical direction (or thickness direction) and in a planar direction by the signal applied to the first electrode part 1311b and the second electrode part 1311c. The vibration part 1311a may be displaced (or vibrated or driven) by contraction and/or expansion of the planar direction, thereby improving a vibration characteristic including a sound characteristic and/or a sound pressure level characteristic of the vibration generator 1310.

Each of the first to fourth vibration generators 313a, 313b, 333a, and 333b according to an exemplary embodiment of the present disclosure may further include a first cover member 1313 and a second cover member 1315.

The first cover member 1313 may be disposed at a first surface of the vibration generating part 1311. For example, the first cover member 1313 may be configured to cover the first electrode part 1311b of the vibration generating part 1311. For example, the first cover member 1313 may be configured to have a larger size than that of the vibration generating part 1311, and may be configured to have a same size as that of the second cover member 1315, but embodiments of the present disclosure are not limited thereto. The first cover member 1313 may be configured to protect the first surface of the vibration generating part 1311. For example, the first cover member 1313 may be configured to protect the first surface of the first electrode part 1311b of the vibration generating part 1311.

The second cover member 1315 may be disposed at a second surface of the vibration generating part 1311. For example, the second cover member 1315 may be configured to cover the second electrode part 1311c of the vibration generating part 1311. For example, the second cover member 1315 may be configured to have a greater size than that of the vibration generating part 1311 and may be configured to have a same size as that of the first cover member 1313, but embodiments of the present disclosure are not limited thereto. The second cover member 1315 may be configured to protect the second surface of the vibration generating part 1311. For example, the second cover member 1315 may be configured to protect the second surface of the second electrode part 1311c of the vibration generating part 1311.

The first cover member 1313 and the second cover member 1315 according to an exemplary embodiment of the present disclosure may include a same material or a different material. For example, each of the first cover member 1313 and the second cover member 1315 may be a polyimide (PI) film, a polyethylene terephthalate (PET) film, or a polyethylene naphthalate (PEN) film, but embodiments of the present disclosure are not limited thereto.

The first cover member 1313 may be connected or coupled to the first surface of the vibration generating part 1311 or the first electrode part 1311b of the vibration generating part 1311 by using a first adhesive layer 1317. For example, the first cover member 1313 may be connected or coupled to the first surface of the vibration generating part 1311 or the first electrode part 1311b of the vibration generating part 1311 by a film laminating process using the first adhesive layer 1317.

The second cover member 1315 may be connected or coupled to the second surface of the vibration generating part 1311 or the second electrode part 1311c of the vibration generating part 1311 by using a second adhesive layer 1319. For example, the second cover member 1315 may be connected or coupled to the second surface of the vibration generating part 1311 or the second electrode part 1311c of the vibration generating part 1311 by a film laminating process using the second adhesive layer 1319.

Each of the first adhesive layer 1317 and second adhesive layer 1319 according to an exemplary embodiment of the present disclosure may include an electrically insulating material which has adhesiveness and is capable of compression and decompression. For example, each of the first adhesive layer 1317 and the second adhesive layer 1319 may include an epoxy resin, an acrylic resin, a silicone resin, a urethane resin, an acrylic-based polymer, a silicone-based polymer, or a urethane-based polymer, but embodiments of the present disclosure are not limited thereto.

The first adhesive layer 1317 and second adhesive layer 1319 may be configured between the first cover member 1313 and the second cover member 1315 to surround the vibration generating part 1311. For example, one or more of the first adhesive layer 1317 and second adhesive layer 1319 may be configured to partially or completely surround the vibration generating part 1311.

Any one of the first cover member 1313 and the second cover member 1315 may be connected or coupled to a corresponding vibration member 311 and 331 by using a corresponding adhesive member 312 and 332 illustrated in FIGS. 3 to 22.

Any one of the first cover member 1313 and the second cover member 1315 may be omitted or briefly given. For example, any one of the first cover member 1313 and the second cover member 1315 may be configured to cover or protect at least one or more of the first surface and the second surface of the vibration generating part 1311.

Each of the first to fourth vibration generators 313a, 313b, 333a, and 333b according to an exemplary embodiment of the present disclosure may further include a signal supply member 1320.

The signal supply member 1320 may be configured to supply the driving signal supplied from a driving circuit part to the vibration generating part 1311. The signal supply member 1320 may be configured to be electrically connected to the vibration part 1311a of the vibration generating part 1311. The signal supply member 1320 may be configured to be electrically connected to the first electrode part 1311b and the second electrode part 1311c of the vibration generating part 1311.

A portion of the signal supply member 1320 may be accommodated (or inserted) between the first cover member 1313 and the second cover member 1315. An end portion (or a distal end portion or one side) of the signal supply member 1320 may be disposed or inserted (or accommodated) between one edge portion of the first cover member 1313 and one edge portion of the second cover member 1315. The one edge portion of the first cover member 1313 and the one edge portion of the second cover member 1315 may accommodate or vertically (or up and down) cover the end portion (or the distal end portion or the one side) of the signal supply member 1320.

Accordingly, the signal supply member 1320 may be integrated as one body with the vibration generating part 1311, but embodiments of the present disclosure are not limited thereto. Therefore, the vibration apparatus 313 and 333 (or first to fourth vibration generators 313a, 313b, 333a, and 333b) may be implemented in a film type integrated with the signal supply member 1320. For example, the signal supply member 1320 may be configured as one component with the vibration generating part 1311, thereby realizing an effect of uni-materialization. For example, the signal supply member 1320 may be configured as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but embodiments of the present disclosure are not limited thereto.

The signal supply member 1320 according to an exemplary embodiment of the present disclosure may include a base member 1321 and a plurality of signal lines 1323a and 1323b. For example, the signal supply member 1320 may include a base member 1321, a first signal line 1323a, and a second signal line 1323b.

The base member 1321 may include a transparent or opaque plastic material, but embodiments of the present disclosure are not limited thereto. The base member 1321 may have a certain width along a first direction X and may be extended long along a second direction Y intersecting with the first direction X.

The first signal line 1323a and the second signal line 1323b may be disposed at the first surface of the base member 1321 in parallel with the second direction Y and may be spaced apart from each other or electrically separated from each other along the first direction X. The first signal line 1323a and the second signal line 1323b may be disposed in parallel to each other at the first surface of the base member 1321. The first signal line 1323a and the second signal line 1323b may be implemented in a line shape at the first surface of the base member 1321. For example, the first signal line 1323a and the second signal line 1323b may be implemented in a line shape by patterning of a metal layer (or a conductive layer) formed or deposited at the first surface of the base member 1321, but embodiments of the present disclosure are not limited thereto.

End portions (or distal end portions or one sides) of the first signal line 1323a and the second signal line 1323b may be separated from each other, and thus, may be individually curved or bent.

The end portion (or the distal end portion or the one side) of the first signal line 1323a may be electrically connected to the first electrode part 1311b of the vibration generating part 1311. For example, the end portion of the first signal line 1323a may be electrically connected to at least a portion of the first electrode part 1311b of the vibration generating part 1311 in the one edge portion of the first cover member 1313. For example, the end portion (or the distal end portion or the one side) of the first signal line 1323a may be electrically and directly connected to at least a portion of the first electrode part 1311b of the vibration generating part 1311. For example, the end portion (or the distal end portion or the one side) of the first signal line 1323a may be electrically connected to or directly contact the first electrode part 1311b of the vibration generating part 1311. For example, the end portion of the first signal line 1323a may be electrically connected to the first electrode part 1311b by a conductive double-sided tape. Accordingly, the first signal line 1323a may supply a first driving signal, supplied from a driving circuit part, to the vibration generating part 1311. For example, the first signal line 1323a may supply a first driving signal, supplied from a driving circuit part, to the first electrode part 1311b of the vibration generating part 1311, but embodiments of the present disclosure are not limited thereto.

The end portion (or the distal end portion or the one side) of the second signal line 1323b may be electrically connected to the second electrode part 1311c of the vibration generating part 1311. For example, the end portion of the second signal line 1323b may be electrically connected to at least a portion of the second electrode part 1311c of the vibration generating part 1311 in the one edge portion of the second cover member 1315. For example, the end portion of the second signal line 1323b may be electrically and directly connected to at least a portion of the second electrode part 1311c of the vibration generating part 1311. For example, the end portion of the second signal line 1323b may be electrically connected to or directly contact the second electrode part 1311c of the vibration generating part 1311. For example, the end portion of the second signal line 1323b may be electrically connected to the second electrode part 1311c by a conductive double-sided tape. Accordingly, the second signal line 1323b may supply a second driving signal, supplied from the driving circuit part, to the vibration generating part 1311. For example, the second signal line 1323b may supply a second driving signal, supplied from the driving circuit part, to the second electrode part 1311c of the vibration generating part 1311, but embodiments of the present disclosure are not limited thereto.

The signal supply member 1320 according to an exemplary embodiment of the present disclosure may further include an insulation layer 1325.

The insulation layer 1325 may be disposed at the first surface of the base member 1321 to cover each of the first signal line 1323a and the second signal line 1323b other than the end portion (or one side) of the signal supply member 1320.

An end portion (or one side) of the signal supply member 1320 including an end portion (or one side) of the base member 1321 and an end portion (or one side) 1325a of the insulation layer 1325 may be inserted (or accommodated) between the first cover member 1313 and the second cover member 1315 and may be fixed between the first cover member 1313 and the second cover member 1315 by a first adhesive layer 1317 and the second adhesive layer 1319. Accordingly, the end portion (or one side) of the first signal line 1323a may be maintained with being electrically connected to the first electrode part 1311b of the vibration generating part 1311, and the end portion (or one side) of the second signal line 1323b may be maintained with being electrically connected to the second electrode part 1311c of the vibration generating part 1311. In addition, the end portion (or one side) of the signal supply member 1320 may be inserted (or accommodated) and fixed between the vibration generating part 1311 and the first cover member 1313, and thus, a contact defect between the vibration generator 1310 and the signal supply member 1320 caused by the movement of the signal supply member 1320 may be prevented.

In the signal supply member 1320 according to an exemplary embodiment of the present disclosure, each of the end portion (or one side) of the base member 1321 and the end portion (or one side) 1325a of the insulation layer 1325 may be removed. For example, each of the end portion of the first signal line 1323a and the end portion of the second signal line 1323b may be exposed at the outside without being supported or covered by each of the end portion (or one side) of the base member 1321 and the end portion (or one side) 1325a of the insulation layer 1325, respectively. For example, the end portion (or one side) of each of the first signal line 1323a and the second signal line 1323b may protrude (or extend) to have a certain length from an end 1321e of the base member 1321 or an end 1325e of the insulation layer 1325. Accordingly, each of the end portion (or the distal end portion or the one side) of each of the first signal line 1323a and the second signal line 1323b may be individually or independently bent.

The end portion (or one side) of the first signal line 1323a, which is not supported by the end portion (or one side) of the base member 1321 and the end portion 1325a of the insulation layer 1325 and the end portion (or one side) of the second signal line 1323b, which is not supported by the end portion (or one side) of the base member 1321 and the end portion 1325a of the insulation layer 1325, may be directly connected to or directly contact the vibration generating part 1311.

The end portion (or one side) of the first signal line 1323a, which is not supported by the end portion (or one side) of the base member 1321 and the end portion 1325a of the insulation layer 1325, may be directly connected to or directly contact the first electrode part 1311b of the vibration generating part 1311. The end portion (or one side) of the second signal line 1323b, which is not supported by the end portion (or one side) of the base member 1321 and the end portion 1325a of the insulation layer 1325, may be directly connected to or directly contact the second electrode part 1311c of the vibration generating part 1311.

According to an exemplary embodiment of the present disclosure, a portion of the signal supply member 1320 or a portion of the base member 1321 may be disposed or inserted (or accommodated) between the first cover member 1313 and the second cover member 1315, and thus, the signal supply member 1320 may be integrated as one body with the vibration generating part 1311. Accordingly, the vibration generating part 1311 and the signal supply member 1320 may be configured as one component, and thus, an effect of uni-materialization may be obtained.

According to an exemplary embodiment of the present disclosure, the first signal line 1323a and the second signal line 1323b of the signal supply member 1320 may be integrated as one body with the vibration generator 1310, and thus, a soldering process for an electrical connection between the vibration generator 1310 and the signal supply member 1320 may not be needed. Accordingly, a manufacturing process and a structure of the vibration apparatus 313 and 333 (or first to fourth vibration generators 313a, 313b, 333a, and 333b) may be simplified, and hazards associated with the soldering process may be reduced.

FIG. 28 is a diagram illustrating a vibration part according to another exemplary embodiment of the present disclosure. For example, FIG. 28 illustrates another exemplary embodiment of the vibration part described above with reference to FIGS. 25 to 27.

With reference to FIGS. 26 and 28, the vibration part 1311a according to another exemplary embodiment of the present disclosure may include a plurality of first portions 1311a1 and a plurality of second portions 1311a2. For example, the plurality of first portions 1311a1 and the plurality of second portions 1311a2 may be alternately and repeatedly disposed along a second direction Y, as shown in FIG. 28, but embodiments of the present disclosure are not limited thereto. alternatively, the plurality of first portions 1311a1 and the plurality of second portions 1311a2 may be alternately and repeatedly disposed along a first direction X.

Each of the plurality of first portions 1311a1 may include an inorganic material portion having a piezoelectric effect (or a piezoelectric characteristic). For example, each of the plurality of first portions 1311a1 may include at least one or more of a piezoelectric inorganic material and a piezoelectric organic material. For example, each of the plurality of first portions 1311a1 may be an inorganic portion, an inorganic material portion, a piezoelectric portion, a piezoelectric material portion, or an electroactive portion, but embodiments of the present disclosure are not limited thereto.

According to an exemplary embodiment of the present disclosure, each of the plurality of first portions 1311a1 may have a width parallel to the second direction Y (or the first direction X) and may be extended along the first direction X (or the second direction Y). Each of the plurality of first portions 1311a1 may be substantially a same as the vibration part 1311a described above with reference to FIGS. 25 to 27, and thus, its repeated descriptions are omitted or will be briefly given below.

Each of the plurality of second portions 1311a2 may be disposed between the plurality of first portions 1311a1. For example, each of the plurality of first portions 1311a1 may be disposed between two adjacent second portions 1311a2 of the plurality of second portions 1311a2. Each of the plurality of second portions 1311a2 may have a width parallel to the second direction Y (or the first direction X) and may be extended along the first direction X (or the second direction Y). The width of the first portion 1311a1 may be a same as or different from the width of the second portions 1311a2. For example, the width of the first portion 1311a1 may be greater than that of the width of the second portions 1311a2. For example, the first portion 1311a1 and the second portion 1311a2 may include a line shape or a stripe shape which has a same size or different sizes, but embodiments of the present disclosure are not limited thereto.

Each of the plurality of second portions 1311a2 may be configured to fill a gap between two adjacent first portions of the plurality of first portions 1311a1. Each of the plurality of second portions 1311a2 may be configured to fill a gap between two adjacent first portions of the plurality of first portions 1311a1, and thus, may be connected to or attached on lateral surfaces of the first portion 1311a1 adjacent thereto. According to an exemplary embodiment of the present disclosure, each of the plurality of first portions 1311a1 and the plurality of second portions 1311a2 may be disposed (or arranged) at a same plane (or a same layer) in parallel with each other. Therefore, the vibration part 1311a may be expanded to a desired size or length by a lateral coupling (or connection) of the first portions 1311a1 and the second portions 1311a2.

According to an exemplary embodiment of the present disclosure, each of the plurality of second portions 1311a2 may absorb an impact applied to the first portions 1311a1, and thus, may enhance the durability of the first portions 1311a1 and provide flexibility to the vibration part 1311a. Each of the plurality of second portions 1311a2 may include an organic material having a ductile characteristic. For example, each of the plurality of second portions 1311a2 may include one or more of an epoxy-based polymer, an acrylic-based polymer, and a silicone-based polymer, but embodiments of the present disclosure are not limited thereto. For example, each of the plurality of second portions 1311a2 may be an organic portion, an organic material portion, an adhesive portion, a stretch portion, a bending portion, a damping portion, or a ductile portion, but embodiments of the present disclosure are not limited thereto.

A first surface of each of the plurality of first portions 1311a1 and the plurality of second portions 1311a2 may be connected to the first electrode part 1311b in common. A second surface of each of the plurality of first portions 1311a1 and the plurality of second portions 1311a2 may be connected to the second electrode part 1311c in common. For example, one or both of the first electrode part 1311b and the second electrode part 1311c may be formed as pattern-shaped electrodes to correspond only to the plurality of first portions 1311a1.

The plurality of first portions 1311a1 of vibration part 1311a may be polarized (or poling) by a certain voltage applied to the first electrode part 1311b and the second electrode part 1311c in a certain temperature atmosphere, or a temperature atmosphere that may be changed from a high temperature to a room temperature, but embodiments of the present disclosure are not limited thereto.

The plurality of first portions 1311a1 and the plurality of second portion 1311a2 may be disposed on (or connected to) the same plane, and thus, the vibration part 1311a according to another exemplary embodiment of the present disclosure may have a single thin film-type. Accordingly, the vibration generating part 1311 or the vibration generator 1310 including the vibration part 1311a according to another exemplary embodiment of the present disclosure may vibrate by the first portion 1311a1 having a vibration characteristic and may be bent in a curved shape by the second portion 1311a2 having flexibility, but embodiments of the present disclosure are not limited thereto.

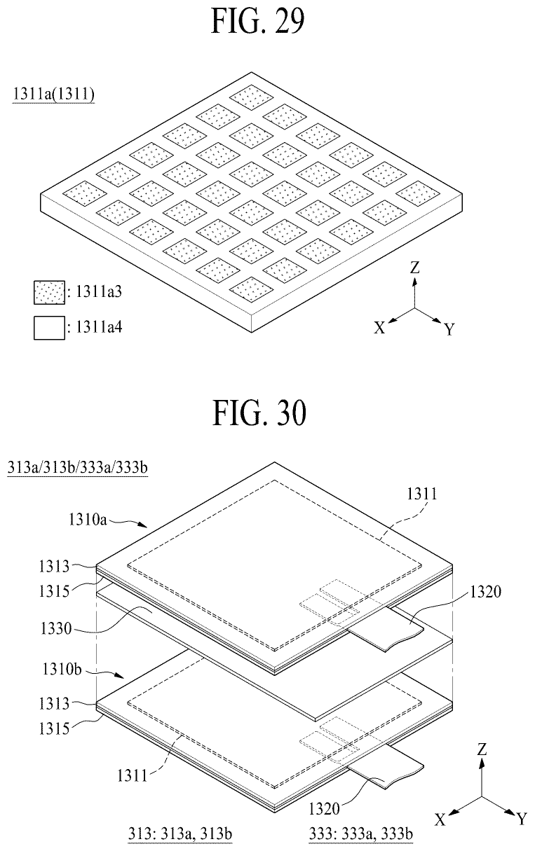

FIG. 29 is a diagram illustrating a vibration part according to another exemplary embodiment of the present disclosure. For example, FIG. 29 illustrates another exemplary embodiment of the vibration part described above with reference to FIGS. 25 to 27.

With reference to FIGS. 26 and 29, the vibration part 1311a according to another exemplary embodiment of the present disclosure may include a plurality of first portions 1311a3 and a second portion 1311a4 disposed between the plurality of first portions 1311a3.

Each of the plurality of first portions 1311a3 may be disposed to be spaced apart from one another along each of the first direction X and the second direction Y. For example, each of the plurality of first portions 1311a3 may have a hexahedral shape having a same size and may be disposed in a lattice shape, but embodiments of the present disclosure are not limited thereto. For example, each of the plurality of first portions 1311a3 may have a circular shape plate, an oval shape plate, or a polygonal shape plate, which has a same size as each other, but embodiments of the present disclosure are not limited thereto.

Each of the plurality of first portions 1311a3 may be substantially a same as the first portion 1311a1 described above with reference to FIG. 28, and thus, its repeated descriptions are omitted or will be briefly given below.

The second portion 1311a4 may be disposed between the plurality of first portions 1311a3 along each of the first direction X and the second direction Y. The second portion 1311a4 may be configured to fill a gap between two adjacent first portions 1311a3, or to be adjacent to each of the plurality of first portions 1311a3 or to surround each of the plurality of first portions 1311a3, and thus, the second portion 1311a4 may be connected to or attached on the first portion 1311a3 adjacent thereto. The second portion 1311a4 may be substantially a same as the second portion 1311a2 described above with reference to FIG. 28, and thus, its repeated descriptions are omitted or will be briefly given below.

A first surface of each of the plurality of first portions 1311a3 and the second portions 1311a4 may be connected to the first electrode part 1311b in common. A second surface of each of the plurality of first portions 1311a3 and the second portions 1311a4 may be connected to the second electrode part 1311c in common. For example, one or both of the first electrode part 1311b and the second electrode part 1311c may be formed as pattern-shaped electrodes to correspond only to the plurality of first portions 1311a3.

The plurality of first portions 1311a3 of vibration part 1311a may be polarized (or poling) by a certain voltage applied to the first electrode part 1311b and the second electrode part 1311c in a certain temperature atmosphere, or a temperature atmosphere that may be changed from a high temperature to a room temperature, but embodiments of the present disclosure are not limited thereto.

The plurality of first portions 1311a3 and the second portion 1311a4 may be disposed on (or connected to) the same plane, and thus, the vibration part 1311a according to another exemplary embodiment of the present disclosure may have a single thin film-type. Accordingly, the vibration generating part 1311 or the vibration generator 1310 including the vibration part 1311a according to another exemplary embodiment of the present disclosure may vibrate by the first portion 1311a3 having a vibration characteristic and may be bent in a curved shape by the second portion 1311a4 having flexibility, but embodiments of the present disclosure are not limited thereto.

FIG. 30 is a diagram illustrating a vibration generator of a vibration apparatus according to another exemplary embodiment of the present disclosure.

With reference to FIG. 30, in the sound apparatus 30 according to another exemplary embodiment of the present disclosure, each of the first and second vibration generators 313a and 313b of the first vibration apparatus 313 and each of the third and fourth vibration generators 333a and 333b of the second vibration apparatus 333 may include a piezoelectric material having piezoelectric characteristics.

Each of the first to fourth vibration generators 313a, 313b, 333a, and 333b may include a plurality of vibrators 1310a and 1310b. For example, each of the first to fourth vibration generators 313a, 313b, 333a, and 333b may include a first vibrator 1310a and a second vibrator 1310b.

The first vibrator 1310a and the second vibrator 1310b may overlap or be stacked with each other to be displaced (or driven or vibrated) in a same direction to maximize or increase an amplitude displacement of the vibration generators 313a, 313b, 333a, and 333b and/or an amplitude displacement of the second vibration member 331. For example, the first vibrator 1310a and the second vibrator 1310b may have substantially a same size, but embodiments of the present disclosure are not limited thereto. Therefore, the first vibrator 1310a and the second vibrator 1310b may maximize or increase the amplitude displacement of the vibration generators 313a, 313b, 333a, and 333b and/or the amplitude displacement of the second vibration member 331.

According to an exemplary embodiment of the present disclosure, any one of the first vibrator 1310a and the second vibrator 1310b may be connected or coupled to a corresponding vibration member 311 and 331 by using a corresponding adhesive member 312 and 332 illustrated in FIGS. 3 to 29. For example, the first vibrator 1310a may be connected or coupled to the corresponding vibration member 311 and 331 by using the corresponding adhesive member 312 and 332.

Each of the first vibrator 1310a and the second vibrator 1310b may be a same as or substantially a same as that of the vibration generators 313a, 313b, 333a, and 333b described above with reference to FIGS. 25 to 29, and thus, like reference numeral refer to like element and its repeated descriptions are omitted or will be briefly given below.

Each of the first to fourth vibration generators 313a, 313b, 333a, and 333b according to another exemplary embodiment of the present disclosure may further include an intermediate member 1330.

The intermediate member 1330 may be disposed or connected between the first vibrator 1310a and the second vibrator 1310b. For example, the intermediate member 1330 may be disposed or connected between the second cover member 1315 of the first vibrator 1310a and the first cover member 1313 of the second vibrator 1310b. For example, the intermediate member 1330 may be an adhesive member or a connection member, but embodiments of the present disclosure are not limited thereto.

The intermediate member 1330 according to an exemplary embodiment of the present disclosure may be configured in a material including an adhesive layer which is good in adhesive force or attaching force with respect to each of the first vibrator 1310a and the second vibrator 1310b. For example, the intermediate member 1330 may include a foam pad, a double-sided tape, a double-sided foam tape, a double-sided pad, a double-sided foam pad, or an adhesive, or the like, but embodiments of the present disclosure are not limited thereto. For example, an adhesive layer of the intermediate member 1330 may include epoxy, acrylic, silicone, or urethane, but embodiments of the present disclosure are not limited thereto. For example, the adhesive layer of the intermediate member 1330 may include a urethane-based material (or substance) having relatively ductile characteristic. Accordingly, the vibration loss caused by displacement interference between the first vibrator 1310a and the second vibrator 1310b may be reduced or minimized, or each of the first vibrator 1310a and the second vibrator 1310b may be freely displaced (or vibrated or driven).

Each of the first to fourth vibration generators 313a, 313b, 333a, and 333b according to another exemplary embodiment of the present disclosure may include the first vibrator 1310a and the second vibrator 1310b which are stacked (or piled or overlap) to vibrate (or displace or drive) in the same direction, and thus, the amount of displacement or an amplitude of displacement may be maximized or increased. Accordingly, the amount of displacement (or a bending force or a driving force) or an amplitude of displacement of the corresponding vibration member 311 and 331 may be maximized or increased.

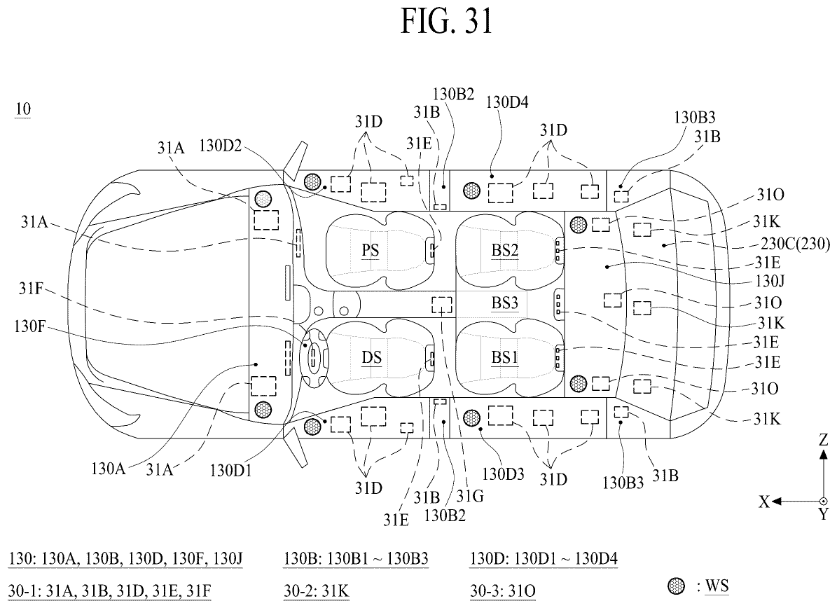

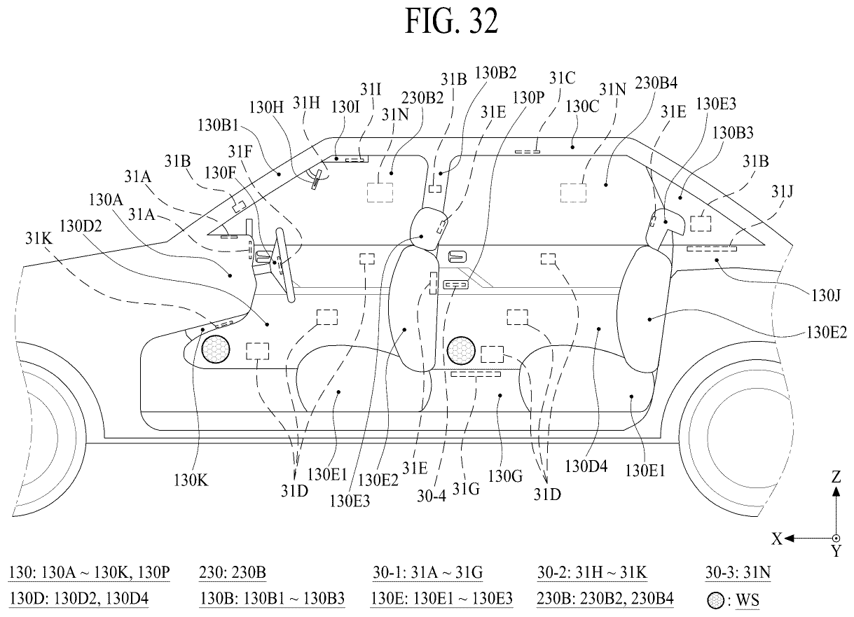

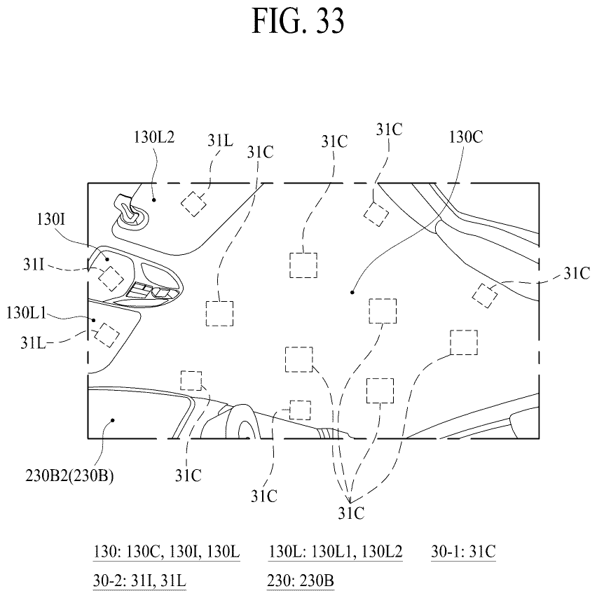

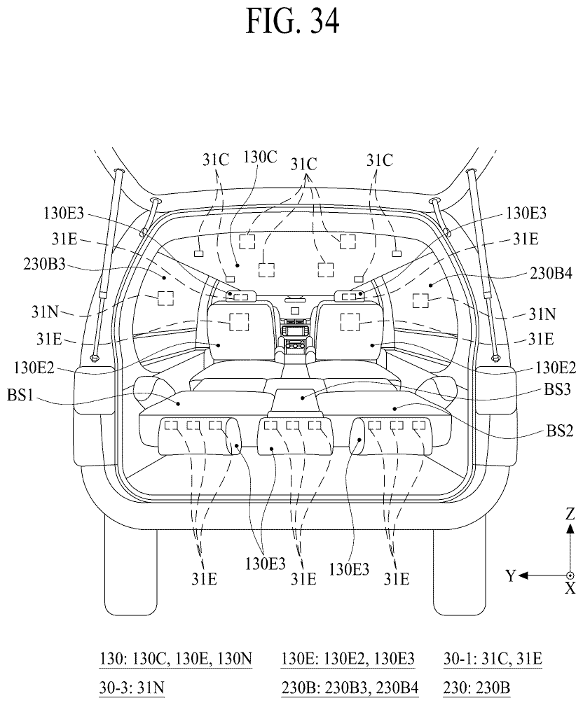

FIG. 31 is a diagram illustrating a vehicular apparatus according to an exemplary embodiment of the present disclosure. FIG. 32 is a diagram illustrating a vehicular apparatus according to an exemplary embodiment of the present disclosure. FIG. 33 is a diagram illustrating a sound generating apparatus disposed at a roof of a vehicular apparatus illustrated in FIGS. 31 and 32. FIG. 34 is a diagram illustrating a sound generating apparatus disposed at a roof and a seat of a vehicular apparatus illustrated in FIGS. 31 and 32.

With reference to FIGS. 31 to 34, a vehicular apparatus 10 according to an exemplary embodiment of the present disclosure may include a vehicle interior material 130 and one or more first sound generating apparatuses 30-1. For example, the vehicle interior material 130 may output a sound based on a vibration of the one or more first sound generating apparatuses 30-1. For example, the vehicle interior material 130 may be exposed at an interior space of the vehicle. For example, one or more first sound generating apparatuses 30-1 may be configured to output a sound to the interior space.

The first sound generating apparatus 30-1 may include at least one or more sound generators 31A to 31G which are disposed in at least one or more of the dashboard 130A, the pillar interior material 130B, the roof interior material 130C, the door interior material 130D, the seat interior material 130E, the handle interior material 130F, and the floor interior material 130G. For example, the first sound generating apparatus 30-1 may include at least one or more of the first to seventh sound generators 31A to 31G, and thus, may output sounds of one or more channels. For example, at least one or more of the first to seventh sound generators 31A to 31G of one or more first sound generating apparatuses 30-1 may be configured to output sounds of one or more channels to the interior space.

The first sound generating generator 31A according to an exemplary embodiment of the present disclosure may be disposed between the dashboard 130A and a dash panel and may be configured to indirectly or directly vibrate the dashboard 130A to output a sound based on a vibration of the dashboard 130A. According to an exemplary embodiment of the present disclosure, the first sound generator 31A may include the sound apparatus 30 described above with reference to FIGS. 3 to 30, and thus, its repeated descriptions are omitted or briefly given. For example, the first sound generator 31A may be a dashboard speaker, without being limited thereto.

According to an exemplary embodiment of the present disclosure, at least one or more of the dash panel and the dashboard 130A may include a plurality of regions, such as a first region corresponding to a driver seat DS, a second region corresponding to a passenger seat PS, and a third region (or a middle region) between the first region and the second region. At least one or more of the dash panel and the dashboard 130A may include a fourth region which is inclined to face the passenger seat PS. The first sound generator 31A may be disposed to vibrate at least one or more of the plurality of regions of the dashboard 130A. According to an exemplary embodiment of the present disclosure, the first sound generator 31A may be disposed to vibrate at least one or more of the first to fourth regions of the dashboard 130A. For example, the first sound generator 31A may be configured to output a sound of about 150 Hz to about 20 kHz. For example, the first sound generator 31A configured to vibrate at least one or more of the first to fourth regions of the dashboard 130A may have a same sound output characteristic or different sound output characteristics.

The second sound generator 31B according to an exemplary embodiment of the present disclosure may be disposed between the pillar interior material 130B and a pillar panel and may be configured to indirectly or directly vibrate the pillar interior material 130B to output a sound based on a vibration of the pillar interior material 130B. For example, the second sound generator 31B may be configured to indirectly or directly vibrate the pillar interior material 130B to output a sound to the interior space. According to an exemplary embodiment of the present disclosure, the second sound generator 31B may include the sound apparatus 30 described above with reference to FIGS. 3 to 30, and thus, its repeated descriptions are omitted or briefly given. For example, the second sound generator 31B may be a pillar speaker or a tweeter speaker.

According to an exemplary embodiment of the present disclosure, the pillar panel may include a first pillar (or an A pillar) disposed at both sides of a front window, a second pillar (or a B pillar) disposed at both sides of a center of a vehicle body, and a third pillar (or a C pillar) disposed at both sides of a rear portion of the vehicle body. The pillar interior material 130B may include a first pillar interior material 130B1 covering the first pillar, a second pillar interior material 130B2 covering the second pillar, and a third pillar interior material 130B3 covering the third pillar. According to an exemplary embodiment of the present disclosure, the second sound generator 31B may be disposed in at least one or more of a region between the first pillar and the first pillar interior material 130B1, a region between the second pillar and the second pillar interior material 130B2, and a region between the third pillar and the third pillar interior material 130B3, and thus, may vibrate at least one or more of the first to third pillar interior materials 130B1, 130B2, and 130B3. For example, the second sound generator 31B may be configured to output a sound at about 2 kHz to about 20 kHz or may be configured to output a sound at about 150 Hz to about 20 kHz, without being limited thereto. For example, the second sound generator 31B configured to vibrate at least one or more of the first to third pillar interior materials 130B1, 130B2, and 130B3 may have a same sound output characteristic or different sound output characteristics.

With reference to FIGS. 32 to 34, the third sound generator 31C according to an exemplary embodiment of the present disclosure may be disposed between the roof interior material 130C and a roof frame (or a roof panel) and may vibrate the roof interior material 130C to output a sound based on a vibration of the roof interior material 130C. For example, the third sound generator 31C may indirectly or directly vibrate the roof interior material 130C to output a sound based on a vibration of the roof interior material 130C. For example, the third sound generator 31C may indirectly or directly vibrate the roof interior material 130C to output a sound to the interior space. According to an exemplary embodiment of the present disclosure, the third sound generator 31C may include the sound apparatus 30 described above with reference to FIGS. 3 to 30, and thus, its repeated descriptions are omitted or briefly given. For example, the third sound generator 31C may be a roof speaker, without being limited thereto.

With reference to FIG. 33, the roof interior material 130C may include a plurality of regions, such as the first region corresponding to the driver seat DS, the second region corresponding to the passenger seat PS, a third region corresponding to a region between the driver seat DS and the passenger seat PS, a fourth region corresponding to a first rear seat BS1 behind the driver seat DS, a fifth region corresponding to a second rear seat BS2 behind the passenger seat PS, a sixth region corresponding to a region between the first rear seat BS1 and the second rear seat BS2, and a seventh region between the third region and the sixth region, without being limited thereto. Alternatively, more or less regions can be included. For example, the third sound generator 31C may be disposed to vibrate at least one or more of the first to seventh regions of the roof interior material 130C. For example, the third sound generator 31C may be configured to output a sound of about 150 Hz to about 20 kHz. For example, the third sound generator 31C configured to vibrate at least one or more of the first to seventh regions of the roof interior material 130C may have a same sound output characteristic or different sound output characteristics. For example, at least one or more third sound generators 31C configured to vibrate at least one or more of the first to seventh regions of the roof interior material 130C may be configured to output a sound of about 2 kHz to about 20 kHz, and the other third sound generators 31C may be configured to output a sound of about 150 Hz to about 20 kHz, without being limited thereto.

With reference to FIGS. 31 and 32, the fourth sound generator 31D according to an exemplary embodiment of the present disclosure may be disposed between the door frame and the door interior material 130D and may be configured to indirectly or directly vibrate the door interior material 130D to output a sound based on a vibration of the door interior material 130D. For example, the fourth sound generator 31D according to an exemplary embodiment of the present disclosure may be configured to indirectly or directly vibrate the door interior material 130D to output a sound to the interior space. According to an exemplary embodiment of the present disclosure, the fourth sound generator 31D may include the sound apparatus 30 described above with reference to FIGS. 3 to 30, and thus, its repeated descriptions are omitted or briefly given. For example, the fourth sound generator 31D may be a door speaker.

According to an exemplary embodiment of the present disclosure, at least one or more of the door frame and the door interior material 130D may include an upper region, a middle region, and a lower region with respect to a height direction Z of the vehicular apparatus 10. For example, the fourth sound generator 31D may be disposed in at least one or more of the upper region, the middle region, and the lower region between the door frame and the door interior material 130D, and thus, may vibrate at least one or more of the upper region, the middle region, and the lower region of the door interior material 130D.

According to an exemplary embodiment of the present disclosure, the upper region of the door interior material 130D may have a relatively small curvature radius. The fourth sound generator 31D for vibrating the upper region of the door interior material 130D may include the sound apparatus 30 having a flexible characteristic described above with reference to FIGS. 28 and 29.

According to an exemplary embodiment of the present disclosure, the door frame may include a first door frame (or a left front door frame), a second door frame (or a right front door frame), a third door frame (or a left rear door frame), and a fourth door frame (or a right rear door frame). According to an exemplary embodiment of the present disclosure, the door interior material 130D may include a first door interior material (or a left front door interior material) 130D1 covering the first door frame, a second door interior material (or a right front door interior material) 130D2 covering the second door frame, a third door interior material (or a left rear door interior material) 130D3 covering the third door frame, and a fourth door interior material (or a right rear door interior material) 130D4 covering the fourth door frame. For example, the fourth sound generator 31D may be disposed in at least one or more of an upper region, a middle region, and a lower region between the first to fourth door frames and the first to fourth door interior materials 130D1, 130D2, 130D3, and 130D4 and may vibrate at least one or more of the upper region, the middle region, and the lower region of each of the first to fourth door interior materials 130D1, 130D2, 130D3, and 130D4.

According to an exemplary embodiment of the present disclosure, the fourth sound generator 31D configured to vibrate the upper region of each of the first to fourth door interior materials 130D1, 130D2, 130D3, and 130D4 may be configured to output a sound of about 2 kHz to about 20 kHz, or may be configured to output a sound of about 150 Hz to about 20 kHz.

For example, the fourth sound generator 31D according to an exemplary embodiment of the present disclosure may be configured to indirectly or directly vibrate at least one of the first to fourth door interior materials 130D1, 130D2, 130D3, and 130D4 of the door interior material 130D to output a sound to the interior space.

According to an exemplary embodiment of the present disclosure, the fourth sound generator 31D configured to vibrate the middle regions and the lower regions of at least one or more of the first to fourth door interior materials 130D1, 130D2, 130D3, and 130D4 may be configured to output a sound of about 150 Hz to about 20 kHz. The fourth sound generator 31D configured to vibrate the middle region and the lower region of each of the first to fourth door interior materials 130D1, 130D2, 130D3, and 130D4 may be configured to output a sound of about 150 Hz to about 20 kHz. For example, the fourth sound generator 31D configured to vibrate the middle regions and the lower regions of at least one or more of the first to fourth door interior materials 130D1, 130D2, 130D3, and 130D4 may be any one or more of a woofer, a mid-woofer, and a sub-woofer. For example, the fourth sound generator 31D configured to vibrate the middle region and the lower region of each of the first to fourth door interior materials 130D1, 130D2, 130D3, and 130D4 may be one or more of a woofer, a mid-woofer, and a sub-woofer.

Sounds, which are respectively output from the fourth sound generator 31D disposed at the first door interior material 130D1 and the fourth sound generator 31D disposed at the second door interior material 130D2, may be combined and output. For example, sounds, which are respectively output from at least one or more of the fourth sound generators 31D disposed at the first door interior material 130D1 and the fourth sound generator 31D disposed at the second door interior material 130D2, may be combined and output. In addition, sounds, which are respectively output from the fourth sound generator 31D disposed at the third door interior material 130D3 and the fourth sound generator 31D disposed at the fourth door interior material 130D4 may be combined and output.

According to an exemplary embodiment of the present disclosure, the upper region of each of the first to fourth door interior materials 130D1, 130D2, 130D3, and 130D4 may include a first upper region adjacent to the dashboard 130A, a second upper region adjacent to the first to third rear seats BS1, BS2, and BS3, and a third upper region between the first upper region and the second upper region. For example, the fourth sound generator 31D may be disposed at one or more of the first to third upper regions of at least one or more of the first to fourth door interior materials 130D1, 130D2, 130D3, and 130D4. For example, the fourth sound generator 31D configured to vibrate the first upper regions of one or more of the first and second door interior materials 130D1 and 130D2 may be configured to output a sound of about 2 kHz to about 20 kHz, and the fourth sound generator 31D configured to vibrate one or more of the second and third upper regions of each of the first and second door interior materials 130D1 and 130D2 may be configured to output a sound of about 2 kHz to about 20 kHz, or may be configured to output a sound of about 150 Hz to about 20 kHz. For example, the fourth sound generator 31D configured to vibrate one or more of the second and third upper regions of at least one or more of the first and second door interior materials 130D1 and 130D2 may be configured to output a sound of about 2 kHz to about 20 kHz, or may be configured to output a sound of about 150 Hz to about 20 KHz.

With reference to FIGS. 31, 32, and 34, the fifth sound generator 31E according to an exemplary embodiment of the present disclosure may be disposed between a seat frame and the seat interior material 130E and may be configured to indirectly or directly vibrate the seat interior material 130E to output a sound based on a vibration of the seat interior material 130E. According to an exemplary embodiment of the present disclosure, the fifth sound generator 31E may include the sound apparatus 30 described above with reference to FIGS. 3 to 30, and thus, its repeated descriptions are omitted or briefly given. For example, the fifth sound generator 31E may be a sheet speaker or a headrest speaker.

According to an exemplary embodiment of the present disclosure, the seat frame may include a plurality of seat frames, such as a first seat frame (or a driver seat frame), a second seat frame (or a passenger seat frame), a third seat frame (or a first rear seat frame), a fourth seat frame (or a second rear seat frame), and a fifth seat frame (or a third rear seat frame), and so on. According to an exemplary embodiment of the present disclosure, the seat interior material 130E may include a plurality of seat interior materials, such as the first seat interior material surrounding the first seat frame, the second seat interior material surrounding the second seat frame, the third seat interior material surrounding the third seat frame, the fourth seat interior material surrounding the fourth seat frame, and the fifth seat interior material surrounding the fifth seat frame, and so on.

According to an exemplary embodiment of the present disclosure, at least one or more of the first to fifth seat frames may include a seat bottom frame, a seat back frame, and a headrest frame. The seat interior material 130E may include a seat bottom interior material 130E1 surrounding the seat bottom frame, a seat back interior material 130E2 surrounding the seat back frame, and a headrest interior material 130E3 surrounding the headrest frame. At least one or more of the seat bottom interior material 130E1, the seat back interior material 130E2, and the headrest interior material 130E3 may include an inner interior material and an outer interior material. For example, the inner interior material may include a foam layer. For example, the outer interior material may include a surface member including a fiber or leather. For example, the outer interior material may further include a base member including a plastic material which supports the surface member.

According to an exemplary embodiment of the present disclosure, the fifth sound generator 31E may be disposed in at least one or more of a region between the seat back frame and the seat back interior material 130E2 and a region between the headrest frame and the headrest interior material 130E3, and thus, may vibrate at least one or more of the outer interior material of the seat back interior material 130E2 and the outer interior material of the headrest interior material 130E3.

For example, the fifth sound generator 31E according to an exemplary embodiment of the present disclosure may be configured to indirectly or directly vibrate at least one or more of the outer interior material of the seat back interior material 130E2 and the outer interior material of the headrest interior material 130E3 to output a sound to the interior space.

According to an exemplary embodiment of the present disclosure, the fifth sound generator 31E disposed in at least one or more of the driver seat DS and the passenger seat PS may be disposed in at least one or more of the region between the seat back frame and the seat back interior material 130E2 and the region between the headrest frame and the headrest interior material 130E3.

According to an exemplary embodiment of the present disclosure, the fifth sound generator 31E disposed in at least one or more of the first to third rear seats BS1, BS2, and BS3 may be disposed between the headrest frame and the headrest interior material 130E3. For example, at least one or more of the first to third rear seats BS1, BS2, and BS3 may include at least one or more fifth sound generators 31E disposed between the headrest frame and the headrest interior material 130E3.

According to an exemplary embodiment of the present disclosure, the fifth sound generator 31E vibrating the seat back interior materials 130E2 of at least one or more of the driver seat DS and the passenger seat PS may be configured to output a sound of about 150 Hz to about 20 kHz. According to an exemplary embodiment of the present disclosure, the fifth sound generator 31E vibrating the headrest interior materials 130E3 of at least one or more of the driver seat DS, the passenger seat PS, and the first to third rear seats BS1, BS2, and BS3 may be configured to output a sound of about 2 kHz to about 20 kHz, or may be configured to output a sound of about 150 Hz to about 20 kHz, without being limited thereto.

With reference to FIGS. 31 and 32, the sixth sound generator 31F according to an exemplary embodiment of the present disclosure may be disposed between a handle frame and the handle interior material 130F and may be configured to indirectly or directly vibrate the handle interior material 130F to output a sound based on a vibration of the handle interior material 130F. For example, the sixth sound generator 31F according to an exemplary embodiment of the present disclosure may be configured to indirectly or directly vibrate the handle interior material 130F to output a sound to the interior space. According to an exemplary embodiment of the present disclosure, the sixth sound generator 31F may include the sound apparatus 30 described above with reference to FIGS. 3 to 30, and thus, its repeated descriptions are omitted or briefly given. For example, the sixth sound generator 31F may be a handle speaker or a steering speaker.

According to an exemplary embodiment of the present disclosure, the sixth sound generator 31F may be configured to indirectly or directly vibrate the handle interior material 130F to provide a driver with a sound based on a vibration of the handle interior material 130F. A sound output by the sixth sound generator 31F may be a sound which is the same as or different from sounds output from at least one or more of the first to fifth sound generators 31A to 31E. As an embodiment of the present disclosure, the sixth sound generator 31F may output a sound which is to be provided to only the driver. As another exemplary embodiment of the present disclosure, the sound output by the sixth sound generator 31F and a sound output by at least one or more of the first to fifth sound generators 31A to 31E may be combined and output.

With reference to FIGS. 31 and 32, the seventh sound generator 31G may be disposed between the floor panel and the floor interior material 130G and may be configured to indirectly or directly vibrate the floor interior material 130G to output a sound based on a vibration of the floor interior material 130G.

The seventh sound generator 31G may be disposed between the floor panel and the floor interior material 130G disposed between the driver seat DS and the passenger seat PS and the third rear seat BS3. For example, the seventh sound generator 31G may include the sound apparatus 30 described above with reference to FIGS. 3 to 30, and thus, its repeated descriptions are omitted or briefly given. For example, the seventh sound generator 31G may be configured to output a sound of about 150 Hz to about 20 kHz, without being limited thereto. For example, the seventh sound generator 31G may be a floor speaker, a bottom speaker, or an under speaker.

With reference to FIGS. 31 to 33, the vehicular apparatus or the vehicle 10 according to an exemplary embodiment of the present disclosure may further include a second sound generating apparatus 30-2 which is disposed at the vehicle interior material 130 exposed at an interior space. For example, the vehicular apparatus or the vehicle 10 according to an exemplary embodiment of the present disclosure may include only the second sound generating apparatus 30-2 instead of the first sound generating apparatus 30-1, or may include all of the first sound generating apparatus 30-1 and the second sound generating apparatus 30-2.

According to an exemplary embodiment of the present disclosure, the vehicle interior material 130 may further include a rear view mirror 130H, an overhead console 130I, a rear package interior material 130J, a glove box 130K, and a sun visor 130L, or the like.

The second sound generating apparatus 30-2 may include at least one or more sound generators 31H to 31L which are disposed in at least one of the rear view mirror 130H, the overhead console 130I, the rear package interior material 130J, the glove box 130K, and the sun visor 130L. For example, the second sound generating apparatus 30-2 may include at least one or more of eighth to twelfth sound generators 31H to 31L, and thus, may output sounds of one or more channels.

With reference to FIGS. 31 to 33, the eighth sound generator 31H may be disposed at the rear view mirror 130H and may be configured to indirectly or directly vibrate the rear view mirror 130H to output a sound based on a vibration of the rear view mirror 130H.

The eighth sound generator 31H may be disposed between a mirror housing connected to a vehicle body structure and the rear view mirror 130H supported by the mirror housing. According to an exemplary embodiment of the present disclosure, the eighth sound generator 31H may include the sound apparatus 30 described above with reference to FIGS. 3 to 30, and thus, its repeated descriptions are omitted or briefly given. For example, the eighth sound generator 31H may be configured to output a sound of about 150 Hz to about 20 kHz. For example, the eighth sound generator 31H may be a mirror speaker.

With reference to FIGS. 33 and 34, the ninth sound generator 31I may be disposed at the overhead console 130I and may be configured to indirectly or directly vibrate a console cover of the overhead console 130I to output a sound based on a vibration of an interior material of the overhead console 130I.

According to an exemplary embodiment of the present disclosure, the overhead console 130I may include a console box embedded into the roof panel or the roof frame, a lighting device disposed at the console box, and the console cover covering the lighting device and the console box.

The ninth sound generator 31I may be disposed between the console cover and the console box of the overhead console 130I and may indirectly or directly vibrate the console cover. The ninth sound generator 31I may indirectly or directly vibrate the console cover to output a sound based on a vibration of the console cover. According to an exemplary embodiment of the present disclosure, the ninth sound generator 31I may include the sound apparatus 30 described above with reference to FIGS. 3 to 30, and thus, its repeated descriptions are omitted or briefly given. For example, the ninth sound generator 31I may be configured to output a sound of about 150 Hz to about 20 kHz. For example, the ninth sound generator 31I may be a console speaker or a lighting speaker.

According to an exemplary embodiment of the present disclosure, the vehicular apparatus or the vehicle 10 may further include a center lighting box disposed at a center region of the roof interior material 130C, a center lighting device disposed at the center lighting box, and a center lighting cover covering the center lighting device. In this case, the ninth sound generator 31I may be additionally disposed between the center lighting cover and the center lighting box of the center lighting device and may additionally vibrate the center lighting cover.

With reference to FIGS. 31 and 32, the tenth sound generator 31J may be disposed at the rear package interior material 130J and may be configured to indirectly or directly vibrate the rear package interior material 130J to output a sound based on a vibration of the rear package interior material 130J.

The rear package interior material 130J may be disposed behind the first to third rear seats BS1, BS2, and BS3. For example, a portion of the rear package interior material 130J may be disposed under a rear window 230C.

The tenth sound generator 31J may be disposed at a rear surface of the rear package interior material 130J and may indirectly or directly vibrate the rear package interior material 130J. The tenth sound generator 31J may indirectly or directly vibrate the rear package interior material 130Jr to output a sound based on a vibration of the rear package interior material 130Jr. According to an exemplary embodiment of the present disclosure, the tenth sound generator 31J may include the sound apparatus 30 described above with reference to FIGS. 3 to 30, and thus, its repeated descriptions are omitted or briefly given. For example, the tenth sound generator 31J may be a rear speaker.

According to an exemplary embodiment of the present disclosure, the rear package interior material 130J may include a plurality of regions, such as a first region corresponding to a rear portion of the first rear seat BS1, a second region corresponding to a rear portion of the second rear seat BS2, and a third region corresponding to a rear portion of the third rear seat BS3. According to an exemplary embodiment of the present disclosure, the tenth sound generator 31J may be disposed in at least one or more of the first to third regions of the rear package interior material 130J to vibrate at least one or more of the first to third regions of the rear package interior material 130J. For example, the tenth sound generator 31J may be configured to output a sound of about 150 Hz to about 20 kHz, without being limited thereto. For example, the tenth sound generator 31J configured to vibrate at least one or more of the first to third regions of the rear package interior material 130J may have a same sound output characteristic or different sound output characteristics.

With reference to FIGS. 31 and 32, the eleventh sound generator 31K may be disposed at a glove box 130K and may be configured to indirectly or directly vibrate the glove box 130K to output a sound based on a vibration of the glove box 130K.

The glove box 130K may be disposed at a dashboard 130A corresponding to a front portion of the passenger seat PS.

The eleventh sound generator 31K may be disposed at an inner surface of the glove box 130K and may indirectly or directly vibrate the glove box 130K to output a sound based on a vibration of the glove box 130K. According to an exemplary embodiment of the present disclosure, the eleventh sound generator 31K may include the sound apparatus 30 described above with reference to FIGS. 3 to 30, and thus, its repeated descriptions are omitted or briefly given. For example, the eleventh sound generator 31K may be configured to output a sound of about 150 Hz to about 20 kHz, or may be one or more of a woofer, a mid-woofer, and a sub-woofer, without being limited thereto. For example, the eleventh sound generator 31K may be a glove box speaker.

With reference to FIG. 33, the twelfth sound generator 31L may be disposed at the sun visor 130L and may be configured to indirectly or directly vibrate the sun visor 130L to output a sound based on a vibration of the sun visor 130L.

The sun visor 130L may include a first sun visor 130L1 corresponding to the driver seat DS and a second sun visor 130L2 corresponding to the passenger seat PS.

The twelfth sound generator 31L may be disposed in at least one or more of the first sun visor 130L1 and the second sun visor 130L2 and may indirectly or directly vibrate at least one or more of the first sun visor 130L1 and the second sun visor 130L2 to output a sound based on a vibration of at least one or more of the first sun visor 130L1 and the second sun visor 130L2. According to an exemplary embodiment of the present disclosure, the twelfth sound generator 31L may include the sound apparatus 30 described above with reference to FIGS. 3 to 30, and thus, its repeated descriptions are omitted or briefly given. For example, the twelfth sound generator 31L may be configured to output a sound of about 150 Hz to about 20 kHz. For example, the twelfth sound generator 31L may be a sun visor speaker.

According to an exemplary embodiment of the present disclosure, at least one or more of the first sun visor 130L1 and the second sun visor 130L2 may further include a sun visor mirror. In this case, the twelfth sound generator 31L may be configured to indirectly or directly vibrate the sun visor mirror of at least one or more of the first sun visor 130L1 and the second sun visor 130L2. The twelfth sound generator 31L vibrating the sun visor mirror may include the sound apparatus 30 described above with reference to FIGS. 3 to 30, and thus, its repeated descriptions are omitted.

With reference to FIGS. 31 to 33, the vehicular apparatus or the vehicle 10 according to an exemplary embodiment of the present disclosure may further include a third sound generating apparatus 30-3 disposed at a vehicle window 230. For example, the vehicular apparatus or the vehicle 10 may include the third sound generating apparatus 30-3 instead of at least one or more of the first sound generating apparatus 30-1 and the second sound generating apparatus 30-2, or may include all of the first to third sound generating apparatuses 30-1, 30-2, and 30-3.

The third sound generating apparatus 30-3 may include at least one or more sound generators 31N and 310 disposed at the vehicle window 230. For example, the third sound generating apparatus 30-3 may include at least one or more of thirteenth and fourteenth sound generators 31N and 310, and thus, may output sounds of one or more channels. For example, the third sound generating apparatus 30-3 may be a transparent sound generating apparatus.

The vehicle window 230 of the vehicular apparatus or the vehicle 10 may include at least one or more of a front window and a side glass window. The vehicle window 230 may further include at least one or more of a rear window and a roof window.

The vehicle window 230 according to an exemplary embodiment of the present disclosure may be configured to be entirely transparent. The vehicle window 230 according to another exemplary embodiment of the present disclosure may include a transparent portion and a semitransparent portion surrounding the transparent portion. The vehicle window 230 according to another exemplary embodiment of the present disclosure may include a transparent portion and an opaque portion surrounding the transparent portion.

The sound apparatus 30 described above with reference to FIGS. 3 to 30 may be configured to be transparent or semitransparent. For example, when the vehicle window 230 is wholly transparent, the sound apparatus 30 may be configured to be transparent and may be disposed at a middle region or a peripheral region of the vehicle window 230. When the vehicle window 230 includes the semitransparent portion or the opaque portion, the sound apparatus 30 may be configured to be semitransparent or opaque and may be disposed at the semitransparent portion or the opaque portion of the vehicle window 230. For example, the sound apparatus 30 may be a transparent sound apparatus.

The at least one or more of the thirteenth and fourteenth sound generators 31N and 310 according to an exemplary embodiment of the present disclosure may include the transparent or semitransparent sound apparatus 30. For example, when the at least one or more of the thirteenth and fourteenth sound generators 31N and 310 includes the sound apparatus 30, the at least one or more of the thirteenth and fourteenth sound generators 31N and 310 may be configured to indirectly or directly vibrate the vehicle window 230 to output a sound based on a vibration of the vehicle window 230.

According to an exemplary embodiment of the present disclosure, the vehicle window 230 may include the front window, the side window 230B, and the rear window. According to an exemplary embodiment of the present disclosure, the vehicle window 230 may further include the roof window 230D. For example, when the vehicular apparatus or the vehicle 10 includes the roof window 230D, a portion of a region of the roof frame and the roof interior material 130C may be replaced with the roof window 230D. For example, when the vehicular apparatus or the vehicle 10 includes the roof window 230D, the third sound generator 31C may be configured to vibrate an edge portion of the roof interior material 130C surrounding the roof window 230D.

With reference to FIGS. 32 to 34, the thirteenth sound generator 31N according to an exemplary embodiment of the present disclosure may be disposed at the side window 230B and may be configured to output a sound by vibrating itself, or may be configured to indirectly or directly vibrate the side window 230B to output a sound based on a vibration of the side window 230B.

According to an exemplary embodiment of the present disclosure, the side window 230B may include a first glass window (or a right front window) 230B2, a second side window (or a left rear window) 230B3, a third side window (or a right rear window) 230B4, and a fourth side window (or a left front window).

According to an exemplary embodiment of the present disclosure, the thirteenth sound generator 31N may be disposed in at least one or more of the first to third side windows 230B2, 230B3, and 230B4. For example, at least one or more of the first to third side windows 230B2, 230B3, and 230B4 may include at least one or more thirteenth sound generators 31N.

The thirteenth sound generator 31N may be disposed in at least one or more of the first to third side windows 230B2, 230B3, and 230B4 and may output a sound by vibrating itself, or may be configured to indirectly or directly vibrate a corresponding side windows 230B2, 230B3, and 230B4 to output a sound. For example, the thirteenth sound generator 31N may be configured to output the sound of 150 Hz to 20 kHz, without being limited thereto. For example, the thirteenth sound generator 31N disposed in at least one or more of the first to third side windows 230B2, 230B3, and 230B4 may have a same sound output characteristic or different sound output characteristics. For example, the thirteenth sound generator 31N disposed in at least one or more of the first to third side windows 230B2, 230B3, and 230B4 may be configured to output the sound of 150 Hz to 20 kHz. For example, the thirteenth sound generator 31N may be a side window speaker.

With reference to FIG. 31, the fourteenth sound generator 31O according to an exemplary embodiment of the present disclosure may be disposed at the rear window 230C and may output a sound by vibrating itself, or may be configured to indirectly or directly vibrate the rear window 230C to output the sound based on the vibration of the rear window 230C.

According to an exemplary embodiment of the present disclosure, the rear window 230C may include a plurality of regions, such as a first region corresponding to a rear portion of the first rear seat BS1, a second region corresponding to a rear portion of the second rear seat BS2, and a third region corresponding to a rear portion of the third rear seat BS3. According to an exemplary embodiment of the present disclosure, the fourteenth sound generator 31O may be disposed in at least one or more of the first to third regions of the rear window 230C and may vibrate at least one or more of the first to third regions of the rear window 230C to output a sound. For example, the fourteenth sound generator 31O may vibrate at least one or more of the first to third regions of the rear window 230C to output a sound based on the vibration of at least one or more of the first to third regions of the rear window 230C. For example, the fourteenth sound generator 31O disposed in at least one or more of the first to third regions of the rear window 230C may have a same sound output characteristic or different sound output characteristics. For example, the fourteenth sound generator 31O disposed in at least one or more of the first to third regions of the rear window 230C may be configured to output a sound of about 150 Hz to about 20 kHz, or may be one or more of a woofer, a mid-woofer, and a sub-woofer. For example, the fourteenth sound generator 31O may be a rear window speaker.

With reference to FIGS. 31 and 32, the vehicular apparatus or the vehicle 10 according to an exemplary embodiment of the present disclosure may further include a woofer speaker WS which is disposed in at least one or more of the dashboard 130A, the door frame, and the rear package interior material 130J.

The woofer speaker WS according to an exemplary embodiment of the present disclosure may include one or more of a woofer, a mid-woofer, and a sub-woofer. For example, the woofer speaker WS may be a speaker which outputs a sound of about 60 Hz to about 150 Hz. Therefore, the woofer speaker WS may output a sound of about 60 Hz to about 150 Hz, and thus, may enhance a low-pitched sound band characteristic of a sound which is output to an interior space.

According to an exemplary embodiment of the present disclosure, the woofer speaker WS may be disposed in at least one or more of first and second regions of the dashboard 130A. According to an exemplary embodiment of the present disclosure, the woofer speaker WS may be disposed at each of first to fourth door frames of the door frame and may be exposed at a lower region of each of the first to fourth door interior materials 130D1 to 130D4 of the door interior material 130D. For example, the woofer speaker WS may be disposed in at least one or more of the first to fourth door frames of the door frame and may be exposed at the lower regions of at least one or more of the first to fourth door interior materials 130D1 to 130D4 of the door interior material 130D. For example, the fourth sound generator 31D disposed at the lower region of at least one or more of the first to fourth door interior materials 130D1 to 130D4 may be replaced by the woofer speaker WS.

With reference to FIG. 32, the vehicular apparatus 10 according to an exemplary embodiment of the present disclosure may further include a garnish member 130P which covers a portion of the vehicle interior material 130 exposed at the interior space, and a fourth sound generating apparatus 30-4. For example, the fourth sound generating apparatus 30-4 may be disposed at the garnish member 130P and the vehicle interior material 130 to output a sound. For example, at least one or more of the garnish member 130P and the vehicle interior material 130 may output a sound based on a vibration of the fourth sound generating apparatus 30-4.

The garnish member 130P may be configured to cover a portion of the door interior material 130D exposed at the interior space, but embodiments of the present disclosure are not limited thereto. For example, the garnish member 130P may be configured to cover a portion of one or more of the dashboard 130A, the pillar interior material 130B, and the roof interior material 130C, which are exposed at the interior space.

The garnish member 130P according to an exemplary embodiment of the present disclosure may include a metal material or a nonmetal material (or a composite nonmetal material) having a material characteristic suitable for generating a sound based on a vibration. For example, a metal material of the garnish member 130P may include any one or more materials of stainless steel, aluminum (Al), an Al alloy, a magnesium (Mg), a Mg alloy, and a magnesium-lithium (Mg—Li) alloy, but embodiments of the present disclosure are not limited thereto. The nonmetal material (or the composite nonmetal material) of the garnish member 130P may include one or more of wood, plastic, glass, cloth, fiber, rubber, paper, carbon, and leather, but embodiments of the present disclosure are not limited thereto. For example, the garnish member 130P may include a metal material having a material characteristic suitable for generating a sound of a high-pitched sound band, but embodiments of the present disclosure are not limited thereto. For example, the high-pitched sound band may have a frequency of 1 kHz or more or 3 kHz or more, but embodiments of the present disclosure are not limited thereto.

The fourth sound generating apparatus 30-4 may be disposed between the garnish member 130P and the vehicle interior material 130. For example, the fourth sound generating apparatus 30-4 may be a garnish speaker or the like, but embodiments of the present disclosure are not limited thereto.

The fourth sound generating apparatus 30-4 according to an exemplary embodiment of the present disclosure may include one or more of the sound apparatus 30 described above with reference to FIGS. 3 to 30. The fourth sound generating apparatus 30-4 may be disposed at a main interior material or the vehicle interior material 130 and the garnish member 130P and may be connected or coupled to the garnish member 130P.

The fourth sound generating apparatus 30-4 according to an exemplary embodiment of the present disclosure may be configured to indirectly or directly vibrate the garnish member 130P to output a sound toward the interior space. The fourth sound generating apparatus 30-4 according to an exemplary embodiment of the present disclosure may be configured to indirectly or directly vibrate the garnish member 130P to output a sound toward the interior space based on the vibration of the garnish member 130P. For example, the fourth sound generating apparatus 30-4 may be configured to output a sound of a high-pitched sound band, but embodiments of the present disclosure are not limited thereto.

The vehicular apparatus or the vehicle 10 according to an exemplary embodiment of the present disclosure may output a sound to the interior space IS through at least one or more of the first sound generating apparatus 30-1 disposed at the vehicle interior material 130, the second sound generating apparatus 30-2 disposed at the vehicle interior material 130 exposed at the interior space, the third sound generating apparatus 30-3 disposed at the vehicle window 230, and the fourth sound generating apparatus 30-4 disposed at the garnish member 130P, and thus, may output the sound by a vehicle interior material 130 as a sound vibration plate, thereby outputting a multichannel surround stereo sound.

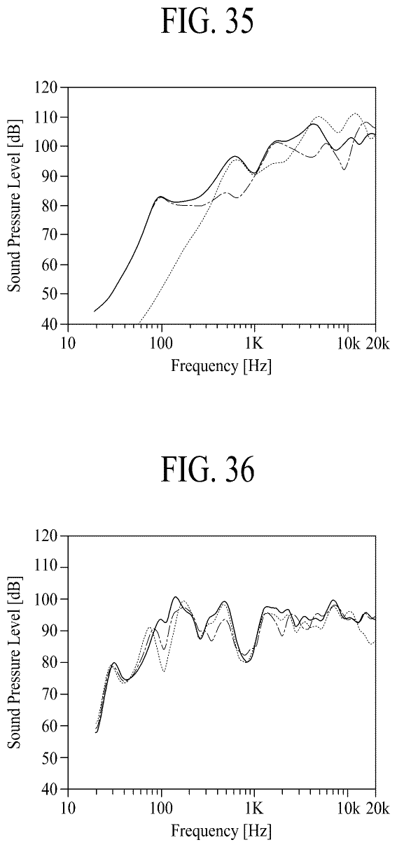

FIG. 35 is a diagram illustrating a sound output characteristic of a sound apparatus according to an exemplary embodiment of the present disclosure.

In FIG. 35, the abscissa axis represents a frequency in hertz (Hz), and the ordinate axis represents a sound pressure level (SPL) in decibels (dB). In FIG. 35, a thick solid line represents a sound output characteristic based on a vibration of each of first and second sound generating parts in the sound apparatus illustrated in FIGS. 3 to 6 according to an exemplary embodiment of the present disclosure. A dotted line represents a sound output characteristic based on a vibration of only the second sound generating part in the sound apparatus illustrated in FIGS. 3 to 6 according to an exemplary embodiment of the present disclosure. A dash-single dotted line represents a sound output characteristic based on a vibration of only the first sound generating part in the sound apparatus illustrated in FIGS. 3 to 6 according to an exemplary embodiment of the present disclosure.

The sound output characteristic may be measured by sound analysis equipment. The sound analysis equipment may include a control PC, a sound card for transmitting and receiving sound, an amplifier for amplifying and transmitting the sound generated from the sound card to the sound apparatus, and a microphone for collecting the sound generated in the apparatus based on driving of the vibration apparatus. The sound collected by the microphone is input to the control PC through the sound card, and the sound is checked in a control program to analyze the sound of the apparatus.

The sound output characteristic has been measured in an anechoic chamber, which is closed in all directions. When measuring, an applied frequency signal is applied as a sine sweep within a range of 10 Hz to 20 kHz, and ⅙ octave smoothing has been performed on a measurement result. A separation distance between the apparatus and the microphone is adjusted to be 30 cm. However, a measurement method of the sound output characteristic may be not limited thereto.

With reference to FIG. 35, comparing with the dash-single dotted line, it may be seen that the dotted line has a relatively high sound pressure level in a frequency (or pitched sound band) of about 350 Hz to about 1 kHz and about 2.8 kHz or more and has a relatively low sound pressure level in a frequency (or pitched sound band) of about 350 Hz or less and about 1 kHz to about 2.8 kHz. Comparing with the dotted line, it may be seen that the thick solid line has a relatively high sound pressure level in a frequency (or pitched sound band) of about 4 kHz or less and has a relatively low sound pressure level in a frequency (or pitched sound band) of about 4 kHz or more. Comparing with the dash-single dotted line, it may be seen that the thick solid line has a similar sound pressure level in a frequency (or pitched sound band) of about 100 Hz or less and has a relatively high sound pressure level in a frequency (or pitched sound band) of about 100 Hz to about 10 KHz.

The sound apparatus according to an exemplary embodiment of the present disclosure may output (or generate) a sound based on a vibration of the first sound generating part or a vibration of the second sound generating part. For example, the sound apparatus according to an exemplary embodiment of the present disclosure may output (or generate) a sound having an enhanced sound pressure level characteristic of a middle-high pitched sound band (for example, a pitched sound band of about 2.8 kHz or more), based on a vibration of only the first sound generating part, and may output (or generate) a sound having an enhanced sound pressure level characteristic of a low-pitched sound band (for example, a pitched sound band of about 350 Hz or less), based on a vibration of only the second sound generating part. In particular, the sound apparatus according to an exemplary embodiment of the present disclosure may output (or generate) a sound having an enhanced sound pressure level characteristic of a low-pitched sound band and a middle-high pitched sound band, based on vibrations of all of the first sound generating part and the second sound generating part.

Therefore, in the sound apparatus according to an exemplary embodiment of the present disclosure, a sound pressure level characteristic and/or a sound characteristic of a high-pitched sound band may be enhanced (or increased) by the first sound generating part having a 4-side fixing structure, and a sound pressure level characteristic and/or a sound characteristic of each of a low-pitched sound band and a middle-high pitched sound band may be enhanced (or increased) by the second sound generating part having a both-short-side fixing structure, thereby implementing a wide sound reproduction band. Furthermore, the sound apparatus according to an exemplary embodiment of the present disclosure may output a sound through vibrations of one or more of the first sound generating part and the second sound generating part, based on a frequency (or pitched sound band) to realize, and thus, a sound pressure level characteristic and/or a sound characteristic in a desired pitched sound band (or frequency) may be enhanced.

FIG. 36 is a diagram illustrating a sound output characteristic of a sound apparatus according to exemplary embodiments of the present disclosure.

In FIG. 36, the abscissa axis represents a frequency in hertz (Hz), and the ordinate axis represents a sound pressure level (SPL) in decibels (dB). In FIG. 36, a dotted line represents a sound output characteristic of the sound apparatus according to an embodiment (or a first embodiment) of the present disclosure illustrated in FIGS. 3 to 6. A thick solid line represents a sound output characteristic of the sound apparatus according to another exemplary embodiment (or a second embodiment) of the present disclosure illustrated in FIGS. 9 to 11. A dash-single dotted line represents a sound output characteristic of the sound apparatus according to another exemplary embodiment (or a third embodiment) of the present disclosure illustrated in FIGS. 13 and 14. A measurement method of a sound output characteristic may be substantially a same as the above description of FIG. 35, and thus, its repeated descriptions are omitted.

With reference to FIG. 36, comparing with the dotted line, in each of the dash-single dotted line and the thick solid line, it may be seen that a sound pressure level increases in a frequency (or pitched sound band) of about 200 Hz or less. For example, it may be seen that a sound pressure level increases in a frequency (or pitched sound band) of about 200 Hz or less as a rotation angle (or tilt angle) between the first sound generating part and the second sound generating part increases progressively within a range of an acute angle, and thus, dip is improved.

Therefore, in the sound apparatus according to other embodiments of the present disclosure, a sound pressure level characteristic and/or a sound characteristic may be enhanced in a frequency (or pitched sound band) of about 200 Hz or less, based on the rotation arrangement of the first sound generating part and the second sound generating part, and thus, dip may be improved.

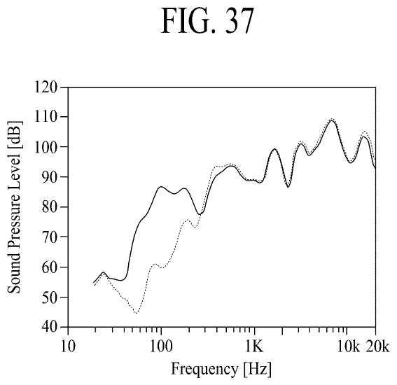

FIG. 37 is a diagram illustrating a sound output characteristic of a sound apparatus according to exemplary embodiments of the present disclosure and an experimental example.

In FIG. 37, the abscissa axis represents a frequency in hertz (Hz), and the ordinate axis represents a sound pressure level (SPL) in decibels (dB). In FIG. 37, a thick solid line represents a sound output characteristic of the sound apparatus according to another exemplary embodiment of the present disclosure illustrated in FIG. 22. A dotted line represents a sound output characteristic of a sound apparatus according to an experimental example which includes the first sound generating part and the enclosure and where the second sound generating part has been removed in the sound apparatus according to another exemplary embodiment of the present disclosure illustrated in FIG. 22. A measurement method of a sound output characteristic may be substantially a same as the above description of FIG. 35, and thus, its repeated descriptions are omitted.

With reference to FIG. 37, comparing with the dotted line, it may be seen that the thick solid line has a relatively high sound pressure level in a frequency (or pitched sound band) of about 300 Hz or less and has a similar sound pressure level in a frequency (or pitched sound band) of about 300 Hz or more.

Therefore, the sound apparatus according to another exemplary embodiment of the present disclosure may include the first sound generating part having a 4-side fixing structure and the second sound generating part having a both-short-side fixing structure, and thus, a sound pressure level characteristic and/or a sound characteristic of each of a low-pitched sound band and a middle-high pitched sound band may be enhanced (or increased), thereby implementing a wide sound reproduction band.

A sound apparatus and a vehicular apparatus including the same according to one or more embodiments of the present disclosure are described below.

The sound apparatus according to one or more embodiments of the present disclosure may comprise a first sound generating part, a second sound generating part spaced apart from the first sound generating part, a coupling member partially provided between the first sound generating part and the second sound generating part, and a connection member disposed along a rear periphery portion of the first sound generating part.

According to one or more embodiments of the present disclosure, the sound apparatus may further comprise an air gap which is partially provided between the first sound generating part and a periphery portion of the second sound generating part.

According to one or more embodiments of the present disclosure, the air gap may be in at least a portion of a region between the first sound generating part and a periphery portion, which is adjacent to a long side, of the second sound generating part.

According to one or more embodiments of the present disclosure, the coupling member may be disposed between the first sound generating part and a periphery portion, which is adjacent to a short side, of the second sound generating part and may not be disposed between the first sound generating part and a periphery portion, which is adjacent to a long side, of the second sound generating part.

According to one or more embodiments of the present disclosure, the first sound generating part may comprise a first vibration member, and a first vibration apparatus connected to the first vibration member and configured to vibrate the first vibration member. The second sound generating part may comprise a second vibration member, and a second vibration apparatus connected to the second vibration member and configured to vibrate the second vibration member. The coupling member may be partially provided between the first vibration member and the second vibration member.

According to one or more embodiments of the present disclosure, the coupling member may be disposed between the first vibration member and a periphery portion, which is adjacent to a short side, of the second vibration member and may not be disposed between the first vibration member and a periphery portion, which is adjacent to a long side, of the second vibration member.

According to one or more embodiments of the present disclosure, the coupling member may comprise a first coupling member between the first vibration member and a periphery portion, which is adjacent to a first short side, of the second vibration member; and a second coupling member between the first vibration member and a periphery portion, which is adjacent to a second short side, of the second vibration member.

According to one or more embodiments of the present disclosure, the sound apparatus may further comprise a first air gap between the first vibration member and a periphery portion, which is adjacent to a first long side, of the second vibration member; and a second air gap between the first vibration member and a periphery portion, which is adjacent to a second long side, of the second vibration member.

According to one or more embodiments of the present disclosure, the first vibration member may have a size which is greater than that of a size of the second vibration member. A long-side length direction of the first vibration apparatus may intersect with a long-side length direction of the second vibration apparatus.

According to one or more embodiments of the present disclosure, each of the first vibration member and the second vibration member may comprise a first surface and a second surface opposite to the first surface. The first vibration apparatus may comprise one or more vibration generators connected to one or more of the first surface and the second surface of the first vibration member. The second vibration apparatus may comprise one or more vibration generators connected to one or more of the first surface and the second surface of the second vibration member.

According to one or more embodiments of the present disclosure, the one or more vibration generators of each of the first vibration apparatus and the second vibration apparatus may comprise a vibration part including a piezoelectric material, a first electrode part at a first surface of the vibration part, and a second electrode part at a second surface different from the first surface of the vibration part.

According to one or more embodiments of the present disclosure, the vibration part may comprise a plurality of inorganic material portions including the piezoelectric material, and an organic material portion between the plurality of inorganic material portions.

According to one or more embodiments of the present disclosure, the one or more vibration generators of each of the first vibration apparatus and the second vibration apparatus may further comprise a first cover member at the first electrode part, and a second cover member at the second electrode part.

According to one or more embodiments of the present disclosure, the one or more vibration generators of each of the first vibration apparatus and the second vibration apparatus further may comprise an intermediate member between the first cover member and the second cover member, and the intermediate member is an adhesive member or a connection member.

According to one or more embodiments of the present disclosure, the one or more vibration generators of each of the first vibration apparatus and the second vibration apparatus may further comprise a signal supply member electrically connected to the first electrode part and the second electrode part. A portion of the signal supply member may be accommodated between the first cover member and the second cover member.

According to one or more embodiments of the present disclosure, each of the first vibration member and the second vibration member may comprise a first surface and a second surface opposite to the first surface. The first vibration apparatus may comprise a plurality of vibrators stacked and connected to one or more of the first surface and the second surface of the first vibration member. The second vibration apparatus may comprise a plurality of vibrators stacked and connected to one or more of the first surface and the second surface of the second vibration member.

According to one or more embodiments of the present disclosure, the first vibration apparatus may comprise a first vibration generator and a second vibration generator overlapping each other with the first vibration member therebetween. The second vibration apparatus may comprise a third vibration generator and a fourth vibration generator overlapping each other with the second vibration member therebetween.

According to one or more embodiments of the present disclosure, the first vibration member may have a size which may be greater than that of a size of the second vibration member. A long-side length direction of each of the first vibration generator and the second vibration generator may intersect with a long-side length direction of each of the third vibration generator and the fourth vibration generator.

According to one or more embodiments of the present disclosure, one or more of the first vibration member and the second vibration member may comprise a metal material, or may comprise one or more materials of wood, rubber, plastic, carbon, glass, fiber, cloth, paper, mirror, and leather.

According to one or more embodiments of the present disclosure, the connection member may not overlap with the first vibration apparatus.

According to one or more embodiments of the present disclosure, the connection member may be connected to a rear periphery portion of the first vibration member.

According to one or more embodiments of the present disclosure, the sound apparatus may further comprise an enclosure between the first vibration member and the connection member and having an internal space, and a middle coupling member between the first vibration member and the enclosure. The first vibration member may be configured to cover the internal space of the enclosure. The connection member may be connected to a rear periphery portion of the enclosure.

According to one or more embodiments of the present disclosure, the enclosure may comprise a plate spaced apart from the first vibration apparatus, and a sidewall connected to the plate to form the internal space. The middle coupling member may be between the first vibration member and the sidewall of the enclosure.

According to one or more embodiments of the present disclosure, the enclosure may further comprise an opening part connected to the internal space and overlapping the first vibration apparatus.

According to one or more embodiments of the present disclosure, the enclosure may further comprise an inclined surface configured to be inclined between the opening part and an inner lateral surface of the enclosure

A vehicular apparatus according to one or more embodiments of the present disclosure may comprise an interior material exposed at an interior space, and at least one or more sound generating apparatuses connected to the interior material and configured to output a sound to the interior space. The at least one or more sound generating apparatuses may comprise a sound apparatus. The sound apparatus may comprise a first sound generating part, a second sound generating part spaced apart from the first sound generating part, a coupling member partially provided between the first sound generating part and the second sound generating part, and a connection member disposed along a rear periphery portion of the first sound generating part. The interior material may be connected to the connection member of the sound apparatus.

According to one or more embodiments of the present disclosure, the vehicular apparatus may further comprise a gap space provided between the interior material and the first sound generating part by the connection member of the sound apparatus.

According to one or more embodiments of the present disclosure, the interior material may comprise one or more holes connected to the gap space.

According to one or more embodiments of the present disclosure, the sound apparatus may comprise an enclosure between the first sound generating part and the connection member and having an internal space, and a middle coupling member between the first sound generating part and the enclosure. The connection member may be between the interior material and a rear periphery portion of the enclosure.

According to one or more embodiments of the present disclosure, the enclosure may comprise a plate spaced apart from the first sound generating part, and a sidewall connected to the plate to form the internal space. The middle coupling member may be between a periphery portion of the first sound generating part and the sidewall of the enclosure.

According to one or more embodiments of the present disclosure, the enclosure may further comprise an opening part which is at the plate and connected to the internal space.

According to one or more embodiments of the present disclosure, the interior material may comprise one or more opening holes overlapping the opening part of the enclosure.

According to one or more embodiments of the present disclosure, the interior material may comprise an opening hole connected to the opening part of the enclosure. The enclosure may further comprise a protrusion part protruding from the enclosure to surround the opening part and configured to be accommodated into the opening hole.

According to one or more embodiments of the present disclosure, the interior material may comprise one or more materials of metal, wood, rubber, plastic, carbon, glass, fiber, cloth, paper, a mirror, and leather.

According to one or more embodiments of the present disclosure, the interior material may comprise at least one or more of a dashboard, a pillar interior material, a roof interior material, a door interior material, a seat interior material, a handle interior material, a floor interior material, a rear package interior material, an overhead console, a rear view mirror, a glove box, a garnish member, and a sun visor. The at least one or more sound generating apparatuses may be configured to vibrate at least one or more of the dashboard, the pillar interior material, the roof interior material, the door interior material, the seat interior material, the handle interior material, the floor interior material, the rear package interior material, the overhead console, the rear view mirror, the glove box, the garnish member, and the sun visor, to generate a sound.

The sound apparatus according to one or more embodiments of the present disclosure may comprise a first sound generating part, a second sound generating part spaced apart from the first sound generating part, a coupling member partially provided between the first sound generating part and the second sound generating part, and a connection member disposed along a rear periphery portion of the first sound generating part. The sound apparatus may be configured to output a sound of first pitched sound band based on a vibration of one of the first sound generating part and the second sound generating part and to output a sound of second pitched sound band based on a vibration of the other of the first sound generating part and the second sound generating part.

The above-described feature, structure, and effect of the present disclosure are included in at least one embodiment of the present disclosure, but are not limited to only one embodiment. Furthermore, the feature, structure, and effect described in at least one embodiment of the present disclosure may be implemented through combination or modification of other embodiments by those skilled in the art. Therefore, content associated with the combination and modification should be construed as being within the scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A sound apparatus, comprising:
a first sound generating structure;
a second sound generating structure spaced apart from the first sound generating structure;
a coupling member partially provided between the first sound generating structure and the second sound generating structure; and
a connection member disposed along a rear periphery portion of the first sound generating structure.

2. The sound apparatus of claim 1, wherein the coupling member is disposed between the first sound generating structure and a periphery portion, which is adjacent to a short side, of the second sound generating structure and is not disposed between the first sound generating structure and a periphery portion, which is adjacent to a long side, of the second sound generating structure.

3. The sound apparatus of claim 1, wherein the first sound generating structure comprises:
a first vibration member; and
a first vibration apparatus coupled to the first vibration member and configured to vibrate the first vibration member,
wherein the second sound generating structure comprises:
a second vibration member; and
a second vibration apparatus coupled to the second vibration member and configured to vibrate the second vibration member, and
wherein the coupling member is partially provided between the first vibration member and the second vibration member.

4. The sound apparatus of claim 3, wherein the coupling member is disposed between the first vibration member and a periphery portion, which is adjacent to a short side, of the second vibration member and is not disposed between the first vibration member and a periphery portion, which is adjacent to a long side, of the second vibration member.

5. The sound apparatus of claim 3, further comprising:
a first air gap between the first vibration member and a periphery portion, which is adjacent to a first long side, of the second vibration member; and
a second air gap between the first vibration member and a periphery portion, which is adjacent to a second long side, of the second vibration member.

6. The sound apparatus of claim 3, wherein the first vibration member has a size which is greater than that of a size of the second vibration member, and
wherein a long-side length direction of the first vibration apparatus intersects with a long-side length direction of the second vibration apparatus.

7. The sound apparatus of claim 3, wherein each of the first vibration member and the second vibration member comprises a first surface and a second surface opposite to the first surface,
wherein the first vibration apparatus comprises one or more vibration generators coupled to one or more of the first surface and the second surface of the first vibration member, and
wherein the second vibration apparatus comprises one or more vibration generators coupled to one or more of the first surface and the second surface of the second vibration member.

8. The sound apparatus of claim 7, wherein the one or more vibration generators of each of the first vibration apparatus and the second vibration apparatus comprises:
a vibration part including a piezoelectric material;
a first electrode part at a first surface of the vibration part; and
a second electrode part at a second surface different from the first surface of the vibration part.

9. The sound apparatus of claim 3, wherein the first vibration apparatus comprises a first vibration generator and a second vibration generator overlapping each other with the first vibration member therebetween, and
wherein the second vibration apparatus comprises a third vibration generator and a fourth vibration generator overlapping each other with the second vibration member therebetween.

10. The sound apparatus of claim 9, wherein the first vibration member has a size which is greater than that of a size of the second vibration member, and
wherein a long-side length direction of each of the first vibration generator and the second vibration generator intersects with a long-side length direction of each of the third vibration generator and the fourth vibration generator.

11. The sound apparatus of claim 3, further comprises:
an enclosure between the first vibration member and the connection member and having an internal space; and
a middle coupling member between the first vibration member and the enclosure,
wherein the first vibration member is configured to cover the internal space of the enclosure, and
wherein the connection member is coupled to a rear periphery portion of the enclosure.

12. The sound apparatus of claim 11, wherein the enclosure comprises:
a plate spaced apart from the first vibration apparatus; and
a sidewall coupled to the plate to form the internal space, and
wherein the middle coupling member is between the first vibration member and the sidewall of the enclosure.

13. The sound apparatus of claim 11, wherein the enclosure further comprises an opening part coupled to the internal space and overlapping the first vibration apparatus.

14. A vehicular apparatus, comprising:
an interior material exposed at an interior space; and
at least one or more sound generating apparatuses coupled to the interior material and configured to output a sound to the interior space,
wherein the at least one or more sound generating apparatuses comprise a sound apparatus including:
a first sound generating structure;
a second sound generating structure spaced apart from the first sound generating structure;
a coupling member partially provided between the first sound generating structure and the second sound generating structure; and
a connection member disposed along a rear periphery portion of the first sound generating structure, and
wherein the interior material is coupled to the connection member of the sound apparatus.

15. The vehicular apparatus of claim 14, further comprising a gap space provided between the interior material and the first sound generating structure by the connection member of the sound apparatus.

16. The vehicular apparatus of claim 14, wherein the sound apparatus comprises:
an enclosure between the first sound generating structure and the connection member and having an internal space; and
a middle coupling member between the first sound generating structure and the enclosure, and
wherein the connection member is between the interior material and a rear periphery portion of the enclosure.

17. The vehicular apparatus of claim 16, wherein the enclosure comprises:
a plate spaced apart from the first sound generating structure; and
a sidewall coupled to the plate to form the internal space, and
wherein the middle coupling member is between a periphery portion of the first sound generating structure and the sidewall of the enclosure.

18. The vehicular apparatus of claim 17, wherein the enclosure further comprises an opening part which is at the plate and coupled to the internal space.

19. The vehicular apparatus of claim 17, wherein the interior material comprises an opening hole coupled to the opening part of the enclosure, and
wherein the enclosure further comprises a protrusion part protruding from the enclosure to surround the opening part and configured to be accommodated into the opening hole.

20. The vehicular apparatus of claim 14, wherein the interior material comprises one or more materials of metal, wood, rubber, plastic, carbon, glass, fiber, cloth, paper, a mirror, and leather.
